(19) United States
(12) Patent Application Publication
(10) Pub. No.: US 2009/0162476 A1
(43) Pub. Date: Jun. 25, 2009

(54) Parallel Gum Component Mixing Systems And Methods

(75) Inventors: James A. Duggan, Machesney Park, IL (US); Jose Angel Amarista, Morristown, NJ (US); George Albert Barrera, Caledonia, IL (US); Joseph M. Bunkers, Caledonia, IL (US); Arthur W. Upmann, Rockford, IL (US); Miles van Niekerk, Madison, NJ (US); Glenn Thompson Visscher, Morris Plains, NJ (US)

Correspondence Address: REINHART BOERNER VAN DEUREN P.C., 2215 PERRYGREEN WAY, ROCKFORD, IL, 61107, US

(73) Assignee: CADBURY ADAMS USA LLC, Parsippany, NJ (US)

(21) Appl. No.: 12/338,682

(22) Filed: Dec. 18, 2008

Related U.S. Application Data
(60) Provisional application No. 61/016,016, filed on Dec. 21, 2007.
(60) Provisional application No. 61/036,626, filed on Mar. 14, 2008.
(60) Provisional application No. 61/045,764, filed on Apr. 17, 2008.

(51) Int. Cl. A23G 4/02; B01F 13/10; A23G 4/00

(52) U.S. Cl. 426/3; 366/91; 366/79

(57) ABSTRACT

A system and method for mixing and forming gum structures is provided. The system may include combinations of continuous and batch mixers arranged generally in parallel and/or series for mixing gum base ingredients with subsequent gum ingredients. In one embodiment, the system and method first forms a gum structure that is not a gum base and then adds a subsequent gum ingredient such that the gum structure is less than a gum base in combination with a subsequent gum ingredient. In other embodiments, the system and method includes forming a gum base in addition to some subsequent gum ingredients that are not quite finished gum. Further, in other embodiments, the system and method may perform some of the mixing of the ingredients at a first location while mixing of further ingredients is performed at a remote location.

### CROSS-REFERENCE TO RELATED PATENT APPLICATIONS

This patent application claims the benefit of U.S. Provisional Patent Application Nos. 61/016,016, filed Dec. 21, 2007; 61/036,626, filed Mar. 14, 2008; and 61/045,764 filed Apr. 17, 2008, the entire teachings and disclosure of which are incorporated herein by reference thereto.

### FIELD OF THE INVENTION

This invention generally relates to methods and systems for mixing and forming gum structures, and more particularly methods and systems that use continuous mixing, batch mixing, or combinations thereof to add subsequent gum ingredients to gum base ingredients prior to forming a gum base.

### BACKGROUND OF THE INVENTION

Traditional gum making has conventionally employed a two-step process including, a first step of mixing a gum base and then in a second subsequent step, mixing the gum base with subsequent gum ingredients. During the first mixing step, the gum base is made by mixing various gum base ingredients. The gum base is generally the water insoluble portion of the overall gum that is retained in the mouth throughout the chewing process. The insoluble gum base generally includes elastomers, elastomer plasticizers, resins, fats, oils, waxes, softeners, and filler components. Examples of several mixers arranged in a series for making gum bases are shown in U.S. Pat. No. 3,995,064 entitled METHOD AND SYSTEM FOR FORMING CHEWING GUM BASE AND PRODUCT to Ehrgott et al.; and U.S. Pat. No. 4,459,311 entitled PROCESS FOR PREPARING GUM BASE to DeTora et al. Such mixers may be employed in the present invention. As such, the Applicant hereby incorporates the teachings and disclosures of these patents by reference in their entireties to the extent not inconsistent with the present disclosure.

The next traditional step in the gum making process is using the finished gum base as an ingredient in a separate downstream mixer. The finished gum base forms one ingredient, which is mixed with water soluble subsequent gum ingredients. For example, such a system is disclosed in U.S. Pat. No. 5,045,325 entitled CONTINUOUS PRODUCTION OF CHEWING GUM USING COROTATING TWIN SCREW EXTRUDER to Lesko et al. The gum composition ingredients generally include the water soluble bulk portion of the gum, which dissolves and dissipates in the mouth over a given time period during chewing. Thus, the gum base is differentiated from finished gum composition ingredients, usually, based upon being the water insoluble portion of the finished gum rather than the water soluble. Typically, subsequent gum ingredients, which are added after the formation of a finished gum base, include for example, softeners, bulk sweeteners, high intensity sweeteners, flavoring agents, syrups, sensates, acids, potentiators, colorants and functional ingredients.

More recently, an attempt has been made for automatically and continuously producing a finished gum in a single continuous mixer, e.g. an extruder, which does not employ the separate manufacture of a gum base. Specifically, such an attempt is disclosed in U.S. Pat. No. 5,827,549 entitled PROCESS CONTROL SYSTEM FOR AUTOMATED CONTINUOUS PRODUCTION OF CHEWING GUM to Rancich et al. While certain efficiencies may theoretically be gained through the use of only one mixer to make a finished gum product, the present Inventors have identified several drawbacks of such a system to which the present invention is directed.

### BRIEF SUMMARY OF THE INVENTION

In accordance with the present invention, multiple mixers are employed as opposed to a single mixer in order to produce a gum structure. The gum structure is a broad term that is meant to include at a minimum compounded elastomer material up to and including a finished chewing gum product. Some of the problems with attempting to use a single mixer for making the gum base and the finished gum product identified by the inventors are that a single mixer is inherently limited by sizes constraints and in the case of an extruder a given rotational speed of the extruder screw for all different mixing steps. Further, such a proposal of a single mixer would appear to pose significant temperature management difficulties. Accordingly, by employing multiple mixers, several advantages can be achieved as well as several different unique systems as disclosed herein.

One aspect of the present invention is directed toward a nontraditional mixing system for making a gum structure, including a first mixer, a second mixer, and a third mixer wherein the second and the third mixers are arranged in parallel with each other and in series with the first mixer.

Another aspect of the present invention is a mixing system for making a gum structure, including a first mixer, a second mixer, and a third mixer wherein the second and the third mixers are arranged in parallel with each other and in series with the first mixer. The mixing system also includes a plurality of ingredient feeders, wherein at least one of the ingredient feeders is arranged to input a subsequent gum ingredient to one of the mixers prior to generating a finished gum base.

Yet another aspect of the present invention is a mixing system for making a gum structure, including a first mixer, a second mixer, and a third mixer wherein the second and the third mixers are arranged in parallel with each other and in series with the first mixer. One of the mixers is configured to form a finished gum base and to mix at least some subsequent gum ingredients to form a gum structure more than the finished gum base.

One of the aspects of the present invention is a mixing system for making a gum structure, including a first mixer, a second mixer, and a third mixer wherein the second and the third mixers are arranged in parallel with each other and in series with the first mixer. The third mixer adapted to receive at least part of a first gum structure from the first mixer and at least part of a second gum structure from the second mixer, producing a third gum structure.

Another aspect of the present invention is a mixing system for making a gum structure, including a first mixer arranged in series with a second mixer and a third mixer, wherein the second mixer and the third mixer are arranged in parallel with each other. Each of the second mixer and the third mixer outputs a different gum structure, wherein at least one of the second and third mixers outputs a gum structure less than a finished gum.

One aspect of the present invention is directed toward a nontraditional method for making a chewing gum structure that comprises mixing a first set of ingredients in parallel with mixing a second set of ingredients, and mixing a third set of ingredients in series with mixing of the first and second sets of ingredients to form gum structures. At least one of the gum structures produced by the series mixing of the first and second sets of ingredients with the third set of ingredients is a gum structure less than a finished gum.

Yet another aspect of the present invention is a method for making a gum structure that comprises mixing a first set of ingredients in parallel with mixing a second set of ingredients to form a first and second gum structure. And mixing a third set of ingredients in series with mixing of the first and second sets of ingredients to form a third gum structure, and mixing a fourth set of ingredients in series with mixing of the first and second sets of ingredients to form a fourth gum structure.

Other embodiments of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a simplified schematic of a first embodiment of a gum structure mixing system including three continuous mixers in series;

FIG. 2 is a simplified schematic of a second embodiment of a gum structure mixing system including a first continuous mixer, a second continuous mixer, and a batch mixer aligned generally in series;

FIG. 3 is a simplified schematic of a third embodiment of a gum structure mixing system including a first continuous mixer, a batch mixer, and a second continuous mixer aligned generally in series;

FIG. 4 is a simplified schematic of a fourth embodiment of a gum structure mixing system including a continuous mixer, a first batch mixer, and a second batch mixer aligned generally in series;

FIG. 5 is a simplified schematic of a fifth embodiment of a gum structure mixing system including a first continuous mixer and a second continuous mixer aligned generally in series;

FIG. 6 is a simplified schematic of a sixth embodiment of a gum structure mixing system including a continuous mixer and a batch mixer aligned generally in series;

FIG. 7 is a simplified schematic of a seventh embodiment of a gum structure mixing system including a first batch mixer, a second batch mixer, and a third batch mixer aligned generally in series;

FIG. 8 is a simplified schematic of an eight embodiment of a gum structure mixing system including a first batch mixer, a second batch mixer, and a continuous mixer aligned generally in series;

FIG. 9 is a simplified schematic of a ninth embodiment of a gum structure mixing system including a first batch mixer, continuous mixer and a second batch mixer aligned generally in series;

FIG. 10 is a simplified schematic of a tenth embodiment of a gum structure mixing system including a batch mixer, a first continuous mixer and a second continuous mixer aligned generally in series;

FIG. 11 is a simplified schematic of a third embodiment of a gum structure mixing system including a batch mixer and a continuous mixer aligned generally in series;

FIG. 12 is a simplified schematic of a third embodiment of a gum structure mixing system including a first batch mixer and a second batch mixer aligned generally in series;

FIG. 13 is a simplified schematic illustration of a gum structure mixing system configured for kitting gum structures, where a portion of the system is located at a first location and a second portion of the system for finishing the gum structure is located at a second location, remote from the first;

FIG. 14 is a simplified schematic of a first embodiment of a parallel gum structure mixing system including two mixers arranged in parallel with each other and in series with an upstream mixer;

FIG. 15 is a simplified schematic of a second embodiment of a parallel gum structure mixing system including two mixers arranged in parallel with each other and in series with a downstream mixer;

FIG. 16 is a simplified schematic of a third embodiment of a parallel gum structure mixing system including a first mixer and a second mixer arranged in parallel with each other and in series with a third mixer and a fourth mixer which are arranged in parallel with each other.

FIG. 17 is a simplified schematic of a first variation of the first embodiment of FIG. 14 including recirculation of outputs;

FIG. 18 is a simplified schematic of a second variation of the first embodiment of FIG. 14 wherein an output of a mixer is directed to another mixer arranged in parallel with the mixer;

FIG. 19 is a simplified schematic of a third variation of the first embodiment of FIG. 14 further including two more mixers arranged in parallel with each other;

FIG. 20 is a simplified schematic of a variation of the embodiment of FIG. 19 showing that ingredients may be added at different mixers using an ingredient feeder;

FIG. 21 is a simplified schematic of another variation of the embodiment of FIG. 19 including recirculation of outputs within the mixing system;

FIG. 22 is a simplified schematic of yet another variation of the embodiment of FIG. 19 including different recirculation of outputs within the mixing system;

FIG. 23 is a simplified schematic of a first variation of the second embodiment of FIG. 15 including recirculation of outputs;

FIG. 24 is a simplified schematic of a second variation of the second embodiment of FIG. 15 wherein an output of a mixer is directed to another mixer arranged in parallel with the mixer;

FIG. 25 is a simplified schematic of a third variation of the second embodiment of FIG. 15 including different recirculation of outputs;

FIG. 26 is a simplified schematic of a fourth variation of the second embodiment of FIG. 15 including yet another recirculation of outputs;

FIG. 27 is a simplified schematic of a first particular example of a parallel mixing system including three continuous mixers arranged in parallel with each other and in series with two other continuous mixers;

FIG. 28 is a simplified schematic of a second particular example of a parallel mixing system including three batch mixers arranged in parallel with each other and in series with two continuous mixers;

FIG. 29 is a simplified schematic of a third particular example of a parallel mixing system including two continuous mixers and a batch mixer arranged in parallel with each other and in series with another batch mixer;

FIG. 30 is a simplified schematic of a fourth particular example of a parallel mixing system including three batch mixers arranged in parallel with each other and in series with a continuous mixer;

FIG. 31 is a simplified schematic of a fifth particular example of a parallel mixing system including three continuous mixers arranged in parallel with each other and in series with a batch mixer which is arranged in series and upstream of another continuous mixer;

FIG. 32 is a simplified schematic of a sixth particular example of a parallel mixing system including a batch mixer arranged in parallel with a continuous mixer, which are arranged in series and upstream of another batch mixer and a continuous mixer arranged in parallel with each other; and

FIG. 33 is a simplified schematic of a seventh particular example of a parallel mixing system including a continuous mixer and a batch mixer arranged in parallel with each other and in series with another batch mixer which is arranged in series and upstream of another continuous mixer.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

The following disclosure will detail particular embodiments according to the present invention, which provides methods and systems for efficiently mixing and processing ingredients to form a gum structure.

As used herein, “gum structure” includes, but is not limited to, compositions ranging from and inclusive of compounded elastomer to finished gum, which may include compounded elastomer in addition to some compounding aids, master batch gum base, compounded elastomer in addition to some subsequent gum ingredients, compounded elastomer in addition to some gum base ingredients and some subsequent gum ingredients, gum base, gum base in addition to some subsequent gum ingredients, master batch finished gum, and finished gum.

Before explaining the various systems and methods according to the present invention, it is helpful to discuss the general composition of several typical gum structures that are or may be included in forming the most complex gum structure, namely finished gum, that can be made using embodiments of the systems and methods of the present invention.

A “finished gum”, as used herein, will refer to a gum structure that is generally ready for preparation to distribute the product to the consumer. As such, a finished gum may still require temperature conditioning, forming, shaping, packaging and coating. However, the gum composition itself is generally finished. Not all finished gums have the same ingredients or the same amounts of individual ingredients. By varying the ingredients and amounts of ingredients, textures, flavor and sensations, among other things, can be varied to provide differing characteristics to meet the needs of users.

As is generally well known, a finished gum generally includes a water soluble bulk portion, a water insoluble gum base portion, and one or more flavoring agents. The water soluble portion dissipates over a period of time during chewing. The gum base portion is retained in the mouth throughout the chewing process. A finished gum is typically ready for user consumption.

A “finished gum base”, as used herein, will refer to a gum structure that includes a sufficient combination of gum base ingredients that need only be combined with subsequent gum ingredients to form a finished gum. A finished gum base is a chewable visco-elastic material that includes at least a viscous component, an elastic component, and a softener component. For example, a typical gum base may include elastomer, at least some of the filler, resin and/or plasticizer, polyvinyl acetate, and a softener (such as an oil, fat or wax). Merely compounded elastomer without the addition of any softener, for example, would not be a finished gum base because it would not be considered useable in a finished gum structure because of its difficulty, if not impossibility, to chew.

Ingredients

Gum structures may include a vast number of ingredients in various categories. Systems and methods of the present invention may be used to mix any and all known ingredients including, but not limited to, ingredients in the following ingredient categories: elastomers, bulking agents, elastomer plasticizers (which includes resins), elastomer solvents, plasticizers, fats, waxes, fillers, antioxidants, sweeteners (e.g. bulk sweeteners and high intensity sweeteners), syrups/fluids, flavors, sensates, potentiators, acids, emulsifiers, colors, and functional ingredients.

The insoluble gum base generally includes ingredients falling under the following categories: elastomers, elastomer plasticizers (resins or solevents), plasticizers, fats, oils, waxes, softeners and fillers. Further discussion of representative ingredients within each category will be provided later on. The gum base may constitute between 5-95% by weight of a finished gum, more typically 10-50% by weight of the finished gum, and most commonly 20-30% by weight of the finished gum.

The water soluble portion of finished gum may includes subsequent gum ingredients falling under the following categories: softeners, bulk sweeteners, high intensity sweeteners, flavoring agents, acids, additional fillers, functional ingredients and combinations thereof. Softeners are added to the gum in order to optimize the chewability and mouth feel of the gum. The softeners, which are also known as plasticizers, plasticizing agents or emulsifiers, generally constitute between about 0.5-15% by weight of the gum structure. Bulk sweeteners constitute between 5-95% by weight of the gum structure, more typically 20-80% by weight of the gum and most commonly 30-60% by weight of the gum. High intensity sweeteners may also be present and are commonly used with sugarless sweeteners. When used, high intensity sweeteners typically constitute between 0.001-5% by weight of the gum structure, preferably between 0.01-3% by weight of the chewing gum. Typically, high intensity sweeteners are at least 20 times sweeter than sucrose.

Flavor should generally be present in the gum in an amount within the range of about 0.1-15% by weight of the chewing gum, preferably between about 0.2-5% by weight of the gum, most preferably between about 0.5-3% by weight of the gum. Natural and artificial flavoring agents may be used and combined in any sensorially acceptable fashion.

When included, acids typically constitute between about 0.001-5% by weight of the gum structure.

Optional ingredients such as colors, functional ingredients and additional flavoring agents may also be included in gum structures.

Now that a more general overview has been provided as to general common ingredients, more details about individual categories of ingredients and examples of specific ingredients with in various categories will be provided below.

Elastomers

The elastomers (rubbers) employed in the gum structure will vary greatly depending upon various factors such as the type of gum structure desired, the consistency of gum structure desired and the other components used in the gum structure. The elastomer may be any water-insoluble polymer known in the art, and includes those polymers utilized for chewing gums and bubble gums. Illustrative examples of suitable polymers in gum structures, and particularly gum bases, include both natural and synthetic elastomers. For example, those polymers which are suitable in gum structures include, without limitation, natural substances (of vegetable origin) such as caspi, chicle, natural rubber, crown gum, nispero, rosidinha, jelutong, guayule, perillo, niger gutta, tunu, balata, guttapercha, lechi capsi, sorva, gutta kay, and the like, and combinations thereof. Examples of synthetic elastomers include, without limitation, styrene-butadiene copolymers (SBR), polyisobutylene, isobutylene-isoprene copolymers, polyethylene, polyvinyl acetate and the like, and combinations thereof. Elastomers constitute between about 10% to about 60% by weight and more commonly between about 35-40% by weight of the gum structure.

Additional useful polymers include: crosslinked polyvinyl pyrrolidone, polymethylmethacrylate; copolymers of lactic acid, polyhydroxyalkanoates, plasticized ethylcellulose, polyvinyl acetatephthalate and combinations thereof.

Elastomer Plasticizers

The gum structure may contain elastomer solvents, also referred to herein as elastomer plasticizers, to aid in softening the elastomeric materials. Such elastomer solvents may include those elastomer solvents known in the art, for example, terpinene resins such as polymers of alpha-pinene, beta-pinene or d-limonene, methyl, glycerol and pentaerythritol esters of rosins and modified rosins and gums such as hydrogenated, dimerized and polymerized rosins, and mixtures thereof. Examples of elastomer solvents suitable for use herein may include the pentaerythritol ester of partially hydrogenated wood and gum rosin, the pentaerythritol ester of wood and gum rosin, the glycerol ester of wood rosin, the glycerol ester of partially dimerized wood and gum rosin, the glycerol ester of polymerized wood and gum rosin, the glycerol ester of tall oil rosin, the glycerol ester of wood and gum rosin and the partially hydrogenated wood and gum rosin and the partially hydrogenated methyl ester of wood and rosin, and the like, and mixtures thereof. The elastomer solvent may be employed in the gum structure in amounts from about 2% to about 15%, and preferably from about 7% to about 11%, by weight of the gum structure.

Plasticizers

The gum structure may also include plasticizers or softeners, which also fall under the Wax category described below, to provide a variety of desirable textures and consistency properties. Because of the low molecular weight of these ingredients, the plasticizers and softeners are able to penetrate the fundamental structure of the gum structure making it plastic and less viscous. Useful plasticizers and softeners include triacetin, medium chain triglycerides of non-hydrogenated, partially hydrogenated cotton seed oil, soybean oil, palm oil, palm kernel oil, coconut oil, safflower oil, tallow oil, cocoa butter, terepene resins derived from alpha-pinene, lanolin, palmitic acid, oleic acid, stearic acid, sodium stearate, potassium stearate, glyceryl triacetate, glyceryl lecithin, glyceryl monostearate, propylene glycol monostearate, acetylated monoglyceride, glycerine, and the like, and mixtures thereof. Waxes, for example, natural and synthetic waxes, hydrogenated vegetable oils, petroleum waxes such as polyurethane waxes, polyethylene waxes, paraffin waxes, sorbitan monostearate, tallow, propylene glycol, mixtures thereof, and the like, may also be incorporated into the gum structure. The plasticizers and softeners are generally employed in the gum structure in amounts up to about 20% by weight of the gum structure, and more specifically in amounts from about 9% to about 17%, by weight of the gum structure.

Plasticizers may also include hydrogenated vegetable oils, soybean oil and cottonseed oil which may be employed alone or in combination. These plasticizers provide the gum structure with good texture and soft chew characteristics. These plasticizers and softeners are generally employed in amounts from about 5% to about 14%, and more specifically in amounts from about 5% to about 13.5%, by weight of the gum structure.

Fats

Suitable oils and fats include partially hydrogenated vegetable or animal fats, such as coconut oil, palm kernel oil, beef tallow, and lard, among others. These ingredients when used are generally present in amounts up to about 7%, and preferably up to about 3.5%, by weight of the gum structure.

Waxes

In some embodiments, the gum structure may include wax. Waxes that are used may include synthetic waxes such as waxes containing branched alkanes and copolymerized with monomers such as, but not limited to, polypropylene and polyethylene and Fischer-Tropsch type waxes, petroleum waxes such as paraffin, and microcrystalline wax, and natural waxes such as beeswax, candellia, carnauba, and polyethylene wax, rice bran and petroleum.

It softens the polymeric mixture and improves the elasticity of the gum structure. When present, the waxes employed will have a melting point below about 60° C., and preferably between about 45° C. and about 55° C. The low melting wax may be a paraffin wax. The wax may be present in the gum structure in an amount from about 6% to about 10%, and preferably from about 7% to about 9.5%, by weight of the gum structure.

In addition to the low melting point waxes, waxes having a higher melting point may be used in the gum structure in amounts up to about 5%, by weight of the gum structure. Such high melting waxes include beeswax, vegetable wax, candelilla wax, carnuba wax, most petroleum waxes, and the like, and mixtures thereof.

Fillers

In some embodiments, gum structures formed using the systems and methods according to the teachings of the invention may also include effective amounts of bulking agents such as mineral adjuvants which may serve as fillers and textural agents. Useful mineral adjuvants include calcium carbonate, magnesium carbonate, alumina, aluminum hydroxide, aluminum silicate, talc, clay, titanium oxide, ground limestone, monocalcium phosphate, tricalcium phosphate, dicalcium phosphate, calcium sulfate and the like, and mixtures thereof. These fillers or adjuvants may be used in the gum structure in various amounts. The amount of filler, may be present in an amount from about zero to about 40%, and more specifically from about zero to about 30%, by weight of the gum structure. In some embodiments, the amount of filler will be from about zero to about 15%, more specifically from about 3% to about 11%.

Antioxidants

Antioxidants can include materials that scavenge free radicals. In some embodiments, antioxidants can include but are not limited to ascorbic acid, citric acid (citric acid may be encapsulated), rosemary oil, vitamin A, vitamin E, vitamin E phosphate, butylated hydroxytoluene (BHT), butylated hydroxyanisole (BHA), propyl gallate, tocopherols, di-alpha-tocopheryl phosphate, tocotrienols, alpha lipoic acid, dihydrolipoic acid, xanthophylls, beta cryptoxanthin, lycopene, lutein, zeaxanthin, astaxanthin, beta-carotene, carotenes, mixed carotenoids, polyphenols, flavonoids, and combinations thereof.

Subsequent Ingredients

The gum structure may also include amounts of conventional additives selected from the group consisting of sweetening agents (bulk and high intensity sweeteners), softeners, emulsifiers, fillers, bulking agents (carriers, extenders, bulk sweeteners), flavoring agents (flavors, flavorings), coloring agents (colorants, colorings), functional ingredients, and the like, and mixtures thereof. Some of these additives may serve more than one purpose. For example, in sugarless gum structure, a sweetener, such as maltitol or other sugar alcohol, may also function as a bulking agent and particularly a water soluble bulking agent.

Bulk Sweeteners

Suitable Bulk Sweeteners include monosaccharides, disaccharides and polysaccharides such as xylose, ribulose, glucose (dextrose), lactose, mannose, galactose, fructose (levulose), sucrose (sugar), maltose, invert sugar, partially hydrolyzed starch and corn syrup solids, sugar alcohols, randomly bonded glucose polymers such as those polymers distributed under the tradename Litesse™ which is the brand name for polydextrose and is manufactured by Danisco Sweeteners, Ltd. of 41-51 Brighton Road, Redhill, Surryey, RH1 6YS, United Kingdom; isomalt (a racemic mixture of alpha-D-glucopyranosyl-1,6-mannitol and alpha-D-glucopyranosyl-1,6-sorbitol manufactured under the tradename PALATINIT™ by Palatinit Sussungsmittel GmbH of Gotlieb-Daimler-Strause 12 a, 68165 Mannheim, Germany); maltodextrins; hydrogenated starch hydrolysates; hydrogenated hexoses; hydrogenated disaccharides; minerals, such as calcium carbonate, talc, titanium dioxide, dicalcium phosphate; celluloses; and mixtures thereof.

Suitable sugarless bulk sweeteners include sorbitol, xylitol, mannitol, galactitol, lactitol, maltitol, erythritol, isomalt and mixtures thereof. Suitable hydrogenated starch hydrolysates include those disclosed in U.S. Pat. No. 4,279,931 and various hydrogenated glucose syrups and/or powders which contain sorbitol, maltitol, hydrogenated disaccharides, hydrogenated higher polysaccharides, or mixtures thereof. Hydrogenated starch hydrolysates are primarily prepared by the controlled catalytic hydrogenation of corn syrups. The resulting hydrogenated starch hydrolysates are mixtures of monomeric, dimeric, and polymeric saccharides. The ratios of these different saccharides give different hydrogenated starch hydrolysates different properties. Mixtures of hydrogenated starch hydrolysates, such as LYCASIN®, a commercially available product manufactured by Roquette Freres of France, and HYSTAR®, a commercially available product manufactured by SPI Polyols, Inc. of New Castle, Del., are also useful.

In some embodiments, the gum structure may include a specific polyol composition including at least one polyol which is from about 30% to about 80% by weight of said gum structure, and specifically from 50% to about 60%. In some embodiments, such gum structures may have low hygroscopicity. The polyol composition may include any polyol known in the art including, but not limited to maltitol, sorbitol, erythritol, xylitol, mannitol, isomalt, lactitol and combinations thereof. Lycasin™ which is a hydrogenated starch hydrolysate including sorbitol and maltitol, may also be used.

The amount of the polyol composition or combination of polyols used in the gum structure will depend on many factors including the type of elastomers used in the gum structure and the particular polyols used. For example, wherein the total amount of the polyol composition is in the range of about 40% to about 65% based on the weight of the gum structure, the amount of isomalt may be from about 40% to about 60% in addition to an amount of sorbitol from about 0 up to about 10%, more specifically, an amount of isomalt may be from about 45% to about 55% in combination with sorbitol from about 5% to about 10% based on the weight of the gum structure.

The polyol composition which may include one or more different polyols which may be derived from a genetically modified organism (“GMO”) or GMO free source. For example, the maltitol may be GMO free maltitol or provided by a hydrogenated starch hydrolysate. For the purposes of this invention, the term “GMO-free” refers to a composition that has been derived from process in which genetically modified organisms are not utilized.

The sweetening agents which may be included in some gum structures formed using systems and methods according to the teachings of the present invention may be any of a variety of sweeteners known in the art and may be used in many distinct physical forms well-known in the art to provide an initial burst of sweetness and/or a prolonged sensation of sweetness. Without being limited thereto, such physical forms include free forms, such as spray dried, powdered, beaded forms, encapsulated forms, and mixtures thereof.

High Intensity Sweeteners

Desirably, the sweetener is a high intensity sweetener such as aspartame, neotame, sucralose, monatin, and acesulfame potassium (Ace-K). The high intensity sweetener can be in an encapsulated form, a free form, or both.

In general, an effective amount of sweetener may be utilized to provide the level of sweetness desired, and this amount may vary with the sweetener selected. In some embodiments the amount of sweetener may be present in amounts from about 0.001% to about 3%, by weight of the gum, depending upon the sweetener or combination of sweeteners used. The exact range of amounts for each type of sweetener may be selected by those skilled in the art.

The sweeteners involved may be selected from a wide range of materials including water-soluble sweeteners, water-soluble artificial sweeteners, water-soluble sweeteners derived from naturally occurring water-soluble sweeteners, dipeptide based sweeteners, and protein based sweeteners, including mixtures thereof. Without being limited to particular sweeteners, representative categories and examples include:

(a) water-soluble sweetening agents such as dihydrochalcones, monellin, steviosides, lo han quo, lo han quo derivatives, glycyrrhizin, dihydroflavenol, and sugar alcohols such as sorbitol, mannitol, maltitol, xylitol, erythritol, and L-aminodicarboxylic acid aminoalkenoic acid ester amides, such as those disclosed in U.S. Pat. No. 4,619,834, which disclosure is incorporated herein by reference, and mixtures thereof;

(b) water-soluble artificial sweeteners such as soluble saccharin salts, i.e., sodium or calcium saccharin salts, cyclamate salts, the sodium, ammonium or calcium salt of 3,4-dihydro-6-methyl-1,2,3-oxathiazine-4-one-2,2-dioxide, the potassium salt of 3,4-dihydro-6-methyl-1,2,3-oxathiazine-4-one-2,2-dioxide (Acesulfame-K), the free acid form of saccharin, and mixtures thereof;

(c) dipeptide based sweeteners, such as L-aspartic acid derived sweeteners, such as L-aspartyl-L-phenylalanine methyl ester (Aspartame), N—[N-(3,3-dimethylbutyl)-L-α-aspartyl]-L-phenylalanine 1-methyl ester (Neotame), and materials described in U.S. Pat. No. 3,492,131, L-alphaaspartyl-N-(2,2,4,4-tetramethyl-3-thietanyl)-D-alaninamide hydrate (Alitame), methyl esters of L-aspartyl-L-phenylglycerine and L-aspartyl-L-2,5-dihydrophenyl-glycine, L-aspartyl-2,5-dihydro-L-phenylalanine; L-aspartyl-L-(1-cyclohexen)-alanine, and mixtures thereof;

(d) water-soluble sweeteners derived from naturally occurring water-soluble sweeteners, such as chlorinated derivatives of ordinary sugar (sucrose), e.g., chlorodeoxysugar derivatives such as derivatives of chlorodeoxysucrose or chlorodeoxygalactosucrose, known, for example, under the product designation of Sucralose; examples of chlorodeoxysucrose and chlorodeoxygalactosucrose derivatives include but are not limited to: 1-chloro-1′-deoxysucrose; 4-chloro-4-deoxy-alpha-D-galactopyranosyl-alpha-D-fructofuranoside, or 4-chloro-4-deoxygalactosucrose; 4-chloro-4-deoxy-alpha-D-galactopyranosyl-1-chloro-1-deoxy-beta-D-fructo-f uranoside, or 4,1′-dichloro-4,1′-dideoxygalactosucrose; 1′,6′-dichloro 1′,6′-dideoxysucrose; 4-chloro-4-deoxy-alpha-D-galactopyranosyl-1,6-dichloro-1,6-dideoxy-beta-D-fructofuranoside, or 4,1′,6′-trichloro-4,1′,6′-trideoxygalactosucrose; 4,6-dichloro-4,6-dideoxy-alpha-D-galactopyranosyl-6-chloro-6-deoxy-beta-D-fructofuranoside, or 4,6,6′-trichloro-4,6,6′-trideoxygalactosucrose; 6,1′,6′-trichloro-6,1′,6′-trideoxysucrose; 4,6-dichloro-4,6-dideoxy-alpha-D-galacto-pyranosyl-1,6-dichloro-1,6-dideoxy-beta-D-fructofuranoside, or 4,6,1′,6′-tetrachloro-4,6,1′,6′-tetradeoxygalacto-sucrose; and 4,6,1′,6′-tetradeoxy-sucrose, and mixtures thereof;

(e) protein based sweeteners such as thaumaoccous danielli (Thaumatin I and II) and talin; and

(f) the sweetener monatin (2-hydroxy-2-(indol-3-ylmethyl)-4-aminoglutaric acid) and its derivatives.

The intense sweetening agents may be used in many distinct physical forms well-known in the art to provide an initial burst of sweetness and/or a prolonged sensation of sweetness. Without being limited thereto, such physical forms include free forms, spray dried forms, powdered forms, beaded forms, encapsulated forms, and mixtures thereof. In one embodiment, the sweetener is a high intensity sweetener such as aspartame, sucralose, and acesulfame potassium (e.g., Ace-K or acesulfame-K). Several representative forms of encapsulated sweeteners and methods of encapsulating sweeteners are illustrated in U.S. Pat. Nos. 7,244,454; 7,022,352; 6,759,066; 5,217,735; 5,192,561; 5,164,210; 4,997,659 and 4,981,698 as well as U.S. Patent Application Publication Nos. 2007/0231424; 2004/0096544; 2005/0112236; and 2005/0220867, the teachings and disclosure of which are hereby incorporated in their entireties by reference thereto.

The active component (e.g., sweetener), which is part of the delivery system, may be used in amounts necessary to impart the desired effect associated with use of the active component (e.g., sweetness). In general, an effective amount of intense sweetener may be utilized to provide the level of sweetness desired, and this amount may vary with the sweetener selected. The intense sweetener may be present in amounts from about 0.001% to about 3%, by weight of the composition, depending upon the sweetener or combination of sweeteners used. The exact range of amounts for each type of sweetener may be selected by those skilled in the art.

Syrups

Anhydrous glycerin may also be employed as a softening agent, such as the commercially available United States Pharmacopeia (USP) grade. Glycerin is a syrupy liquid with a sweet warm taste and has a sweetness of about 60% of that of cane sugar. Because glycerin is hygroscopic, the anhydrous glycerin may be maintained under anhydrous conditions throughout the preparation of the gum structure. Other syrups may include corn syrup and maltitol syrup.

Flavorants

In some embodiments, flavorants may include those flavors known to the skilled artisan, such as natural and artificial flavors. These flavorings may be chosen from synthetic flavor oils and flavoring aromatics and/or oils, oleoresins and extracts derived from plants, leaves, flowers, fruits, and so forth, and combinations thereof. Nonlimiting representative flavor oils include spearmint oil, cinnamon oil, oil of wintergreen (methyl salicylate), peppermint oil, Japanese mint oil, clove oil, bay oil, anise oil, eucalyptus oil, thyme oil, cedar leaf oil, oil of nutmeg, allspice, oil of sage, mace, oil of bitter almonds, and cassia oil. Also useful flavorings are artificial, natural and synthetic fruit flavors such as vanilla, and citrus oils including lemon, orange, lime, grapefruit, yazu, sudachi, and fruit essences including apple, pear, peach, grape, blueberry, strawberry, raspberry, cherry, plum, pineapple, apricot, banana, melon, apricot, ume, cherry, raspberry, blackberry, tropical fruit, mango, mangosteen, pomegranate, papaya and so forth. Other potential flavors whose release profiles can be managed include a milk flavor, a butter flavor, a cheese flavor, a cream flavor, and a yoghurt flavor; a vanilla flavor; tea or coffee flavors, such as a green tea flavor, a oolong tea flavor, a tea flavor, a cocoa flavor, a chocolate flavor, and a coffee flavor; mint flavors, such as a peppermint flavor, a spearmint flavor, and a Japanese mint flavor; spicy flavors, such as an asafetida flavor, an ajowan flavor, an anise flavor, an angelica flavor, a fennel flavor, an allspice flavor, a cinnamon flavor, a camomile flavor, a mustard flavor, a cardamom flavor, a caraway flavor, a cumin flavor, a clove flavor, a pepper flavor, a coriander flavor, a sassafras flavor, a savory flavor, a Zanthoxyli Fructus flavor, a perilla flavor, a juniper berry flavor, a ginger flavor, a star anise flavor, a horseradish flavor, a thyme flavor, a tarragon flavor, a dill flavor, a capsicum flavor, a nutmeg flavor, a basil flavor, a marjoram flavor, a rosemary flavor, a bayleaf flavor, and a wasabi (Japanese horseradish) flavor; alcoholic flavors, such as a wine flavor, a whisky flavor, a brandy flavor, a rum flavor, a gin flavor, and a liqueur flavor; floral flavors; and vegetable flavors, such as an onion flavor, a garlic flavor, a cabbage flavor, a carrot flavor, a celery flavor, mushroom flavor, and a tomato flavor. These flavoring agents may be used in liquid or solid form and may be used individually or in admixture. Commonly used flavors include mints such as peppermint, menthol, spearmint, artificial vanilla, cinnamon derivatives, and various fruit flavors, whether employed individually or in admixture. Flavors may also provide breath freshening properties, particularly the mint flavors when used in combination with the cooling agents, described herein below. In some embodiments, flavorants may chose from geraniol, linalool, nerol, nerolidal, citronellol, heliotropine, methyl cyclopentelone, ethyl vanillin, maltol, ethyl maltol, furaneol, alliaceous compounds, rose type compounds such as phenethanol, phenylacetic acid, nerol, linalyl esters, jasmine, sandlewood, patchouli, and/or cedarwood.

In some embodiments, other flavorings include aldehydes and esters such as cinnamyl acetate, cinnamaldehyde, citral diethylacetal, dihydrocarvyl acetate, eugenyl formate, p-methylamisol, and so forth may be used. Generally any flavoring or food additive such as those described in Chemicals Used in Food Processing, publication 1274, pages 63-258, by the National Academy of Sciences, may be used. This publication is incorporated herein by reference. These may include natural as well as synthetic flavors.

Further examples of aldehyde flavorings include but are not limited to acetaldehyde (apple), benzaldehyde (cherry, almond), anisic aldehyde (licorice, anise), cinnamic aldehyde (cinnamon), citral, i.e., alpha-citral (lemon, lime), neral, i.e., beta-citral (lemon, lime), decanal (orange, lemon), ethyl vanillin (vanilla, cream), heliotrope, i.e., piperonal (vanilla, cream), vanillin (vanilla, cream), alpha-amyl cinnamaldehyde (spicy fruity flavors), butyraldehyde (butter, cheese), valeraldehyde (butter, cheese), citronellal (modifies, many types), decanal (citrus fruits), aldehyde C-8 (citrus fruits), aldehyde C-9 (citrus fruits), aldehyde C-12 (citrus fruits), 2-ethyl butyraldehyde (berry fruits), hexenal, i.e., trans-2 (berry fruits), tolyl aldehyde (cherry, almond), veratraldehyde (vanilla), 2,6-dimethyl-5-heptenal, i.e., melonal (melon), 2,6-dimethyloctanal (green fruit), and 2-dodecenal (citrus, mandarin), cherry, grape, blueberry, blackberry, strawberry shortcake, and mixtures thereof.

In some embodiments, flavoring agents are used at levels that provide a perceptible sensory experience i.e. at or above their threshold levels. In other embodiments, flavoring agents are used at levels below their threshold levels such that they do not provide an independent perceptible sensory experience. At subthreshold levels, the flavoring agents may provide an ancillary benefit such as flavor enhancement or potentiation.

In some embodiments, a flavoring agent may be employed in either liquid form and/or dried form. When employed in the latter form, suitable drying means such as spray drying the liquid may be used. Alternatively, the flavoring agent may be absorbed onto water soluble materials, such as cellulose, starch, sugar, maltodextrin, gum arabic and so forth or may be encapsulated. In still other embodiments, the flavoring agent may be adsorbed onto silicas, zeolites, and the like.

In some embodiments, the flavoring agents may be used in many distinct physical forms. Without being limited thereto, such physical forms include free forms, such as spray dried, powdered, beaded forms, encapsulated forms, and mixtures thereof.

Illustrations of the encapsulation of flavors as well as other additional components can be found in the examples provided herein. Typically, encapsulation of a component will result in a delay in the release of the predominant amount of the component during consumption of a gum structure that includes the encapsulated component (e.g., as part of a delivery system added as an ingredient to the gum structure). In some embodiments, the release profile of the ingredient (e.g., the flavor, sweetener, etc.) can be managed by managing various characteristics of the ingredient, delivery system containing the ingredient, and/or the gum structure containing the delivery system and/or how the delivery system is made. For example, characteristics might include one or more of the following: tensile strength of the delivery system, water solubility of the ingredient, water solubility of the encapsulating material, water solubility of the delivery system, ratio of ingredient to encapsulating material in the delivery system, average or maximum particle size of ingredient, average or maximum particle size of ground delivery system, the amount of the ingredient or the delivery system in the gum structure, ratio of different polymers used to encapsulate one or more ingredients, hydrophobicity of one or more polymers used to encapsulate one or more ingredients, hydrophobicity of the delivery system, the type or amount of coating on the delivery system, the type or amount of coating on an ingredient prior to the ingredient being encapsulated, etc.

Sensate Ingredients

Sensate compounds can include cooling agents, warming agents, tingling agents, effervescent agents, and combinations thereof. A variety of well known cooling agents may be employed. For example, among the useful cooling agents are included xylitol, erythritol, dextrose, sorbitol, menthane, menthone, ketals, menthone ketals, menthone glycerol ketals, substituted p-menthanes, acyclic carboxamides, mono menthyl glutarate, substituted cyclohexanamides, substituted cyclohexane carboxamides, substituted ureas and sulfonamides, substituted menthanols, hydroxymethyl and hydroxymethyl derivatives of p-menthane, 2-mercapto-cyclo-decanone, hydroxycarboxylic acids with 2-6 carbon atoms, cyclohexanamides, menthyl acetate, menthyl salicylate, N,2,3-trimethyl-2-isopropyl butanamide (WS-23), N-ethyl-p-menthane-3-carboxamide (WS-3), isopulegol, 3-(1-menthoxy)propane-1,2-diol, 3-(1-menthoxy)-2-methylpropane-1,2-diol, p-menthane-2,3-diol, p-menthane-3,8-diol, 6-isopropyl-9-methyl-1,4-dioxaspiro[4,5]decane-2-methanol, menthyl succinate and its alkaline earth metal salts, trimethylcyclohexanol, N-ethyl-2-isopropyl-5-methylcyclohexanecarboxamide, Japanese mint oil, peppermint oil, 3-(1-menthoxy)ethan-1-ol, 3-(1-menthoxy)propan-1-ol, 3-(1-menthoxy)butan-1-ol, 1-menthylacetic acid N-ethylamide, 1-menthyl-4-hydroxypentanoate, 1-menthyl-3-hydroxybutyrate, N,2,3-trimethyl-2-(1-methylethyl)-butanamide, n-ethyl-t-2-c-6 nonadienamide, N,N-dimethyl menthyl succinamide, substituted p-menthanes, substituted p-menthane-carboxamides, 2-isopropanyl-5-methylcyclohexanol (from Hisamitsu Pharmaceuticals, hereinafter “isopregol”); menthone glycerol ketals (FEMA 3807, tradename FRESCOLATO® type MGA); 3-1-menthoxypropane-1,2-diol (from Takasago, FEMA 3784); and menthyl lactate; (from Haarman & Reimer, FEMA 3748, tradename FRESCOLATO® type ML), WS-30, WS-14, Eucalyptus extract (p-Mehtha-3,8-Diol), Menthol (its natural or synthetic derivatives), Menthol PG carbonate, Menthol EG carbonate, Menthol glyceryl ether, N-tertbutyl-p-menthane-3-carboxamide, P-menthane-3-carboxylic acid glycerol ester, Methyl-2-isopryl-bicyclo (2.2.1), Heptane-2-carboxamide; and Menthol methyl ether, and menthyl pyrrolidone carboxylate among others. These and other suitable cooling agents are further described in the following U.S. patents, all of which are incorporated in their entirety by reference hereto: U.S. Pat. Nos. 4,230,688; 4,032,661; 4,459,425; 4,136,163; 5,266,592; 6,627,233.

In some embodiments, warming components may be selected from a wide variety of compounds known to provide the sensory signal of warming to the user. These compounds offer the perceived sensation of warmth, particularly in the oral cavity, and often enhance the perception of flavors, sweeteners and other organoleptic components. In some embodiments, useful warming compounds can include vanillyl alcohol n-butylether (TK-1000) supplied by Takasago Perfumary Company Limited, Tokyo, Japan, vanillyl alcohol n-propylether, vanillyl alcohol isopropylether, vanillyl alcohol isobutylether, vanillyl alcohol n-aminoether, vanillyl alcohol isoamyleather, vanillyl alcohol n-hexyleather, vanillyl alcohol methylether, vanillyl alcohol ethylether, gingerol, shogaol, paradol, zingerone, capsaicin, dihydrocapsaicin, nordihydrocapsaicin, homocapsaicin, homodihydrocapsaicin, ethanol, isopropyl alcohol, iso-amylalcohol, benzyl alcohol, glycerine, and combinations thereof.

In some embodiments, a tingling sensation can be provided. One such tingling sensation is provided by adding jambu, oleoresin, or spilanthol to some examples. In some embodiments, alkylamides extracted from materials such as jambu or sanshool can be included. Additionally, in some embodiments, a sensation is created due to effervescence. Such effervescence is created by combining an alkaline material with an acidic material. In some embodiments, an alkaline material can include alkali metal carbonates, alkali metal bicarbonates, alkaline earth metal carbonates, alkaline earth metal bicarbonates and mixtures thereof. In some embodiments, an acidic material can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. Examples of “tingling” type sensates can be found in U.S. Pat. No. 6,780,443, the entire contents of which are incorporated herein by reference for all purposes.

Sensate components may also be referred to as “trigeminal stimulants” such as those disclosed in U.S. Patent Application No. 205/0202118, which is incorporated herein by reference. Trigeminal stimulants are defined as an orally consumed product or agent that stimulates the trigeminal nerve. Examples of cooling agents which are trigeminal stimulants include menthol, WS-3, N-substituted p-menthane carboxamide, acyclic carboxamides including WS-23, methyl succinate, menthone glycerol ketals, bulk sweeteners such as xylitol, erythritol, dextrose, and sorbitol, and combinations thereof. Trigeminal stimulants can also include flavors, tingling agents, Jambu extract, vanillyl alkyl ethers, such as vanillyl n-butyl ether, spilanthol, Echinacea extract, Northern Prickly Ash extract, capsaicin, capsicum oleoresin, red pepper oleoresin, black pepper oleoresin, piperine, ginger oleoresin, gingerol, shoagol, cinnamon oleoresin, cassia oleoresin, cinnamic aldehyde, eugenol, cyclic acetal of vanillin and menthol glycerin ether, unsaturated amides, and combinations thereof.

In some embodiments, sensate components are used at levels that provide a perceptible sensory experience i.e. at or above their threshold levels. In other embodiments, sensate components are used at levels below their threshold levels such that they do not provide an independent perceptible sensory experience. At subthreshold levels, the sensates may provide an ancillary benefit such as flavor or sweetness enhancement or potentiation.

Potentiator Ingredients

Potentiators can include of materials that may intensify, supplement, modify or enhance the taste and/or aroma perception of an original material without introducing a characteristic taste and/or aroma perception of their own. In some embodiments, potentiators designed to intensify, supplement, modify, or enhance the perception of flavor, sweetness, tartness, umami, kokumi, saltiness and combinations thereof can be included.

In some embodiments, examples of suitable potentiators, also known as taste potentiators include, but are not limited to, neohesperidin dihydrochalcone, chlorogenic acid, alapyridaine, cynarin, miraculin, glupyridaine, pyridinium-betain compounds, glutamates, such as monosodium glutamate and monopotassium glutamate, neotame, thaumatin, tagatose, trehalose, salts, such as sodium chloride, monoammonium glycyrrhizinate, vanilla extract (in ethyl alcohol), sugar acids, potassium chloride, sodium acid sulfate, hydrolyzed vegetable proteins, hydrolyzed animal proteins, yeast extracts, adenosine monophosphate (AMP), glutathione, nucleotides, such as inosine monophosphate, disodium inosinate, xanthosine monophosphate, guanylate monophosphate, alapyridaine (N-(1-carboxyethyl)-6-(hydroxymethyl)pyridinium-3-ol inner salt, sugar beet extract (alcoholic extract), sugarcane leaf essence (alcoholic extract), curculin, strogin, mabinlin, gymnemic acid, hydroxybenzoic acids, 3-hydrobenzoic acid, 2,4-dihydrobenzoic acid, citrus aurantium, vanilla oleoresin, sugarcane leaf essence, maltol, ethyl maltol, vanillin, licorice glycyrrhizinates, compounds that respond to G-protein coupled receptors (T2Rs and T1Rs) and taste potentiator compositions that impart kokumi, as disclosed in U.S. Pat. No. 5,679,397 to Kuroda et al., which is incorporated in its entirety herein by reference. “Kokumi” refers to materials that impart “mouthfulness” and “good body”.

Sweetener potentiators, which are a type of taste potentiator, enhance the taste of sweetness. In some embodiments, exemplary sweetener potentiators include, but are not limited to, monoammonium glycyrrhizinate, licorice glycyrrhizinates, citrus aurantium, alapyridaine, alapyridaine (N-(1-carboxyethyl)-6-(hydroxymethyl)pyridinium-3-ol) inner salt, miraculin, curculin, strogin, mabinlin, gymnemic acid, cynarin, glupyridaine, pyridinium-betain compounds, sugar beet extract, neotame, thaumatin, neohesperidin dihydrochalcone, hydroxybenzoic acids, tagatose, trehalose, maltol, ethyl maltol, vanilla extract, vanilla oleoresin, vanillin, sugar beet extract (alcoholic extract), sugarcane leaf essence (alcoholic extract), compounds that respond to G-protein coupled receptors (T2Rs and T1Rs) and combinations thereof.

Additional examples of potentiators for the enhancement of salt taste include acidic peptides, such as those disclosed in U.S. Pat. No. 6,974,597, herein incorporated by reference. Acidic peptides include peptides having a larger number of acidic amino acids, such as aspartic acid and glutamic acid, than basic amino acids, such as lysine, arginine and histidine. The acidic peptides are obtained by peptide synthesis or by subjecting proteins to hydrolysis using endopeptidase, and if necessary, to deamidation. Suitable proteins for use in the production of the acidic peptides or the peptides obtained by subjecting a protein to hydrolysis and deamidation include plant proteins, (e.g. wheat gluten, corn protein (e.g., zein and gluten meal), soybean protein isolate), animal proteins (e.g., milk proteins such as milk casein and milk whey protein, muscle proteins such as meat protein and fish meat protein, egg white protein and collagen), and microbial proteins (e.g., microbial cell protein and polypeptides produced by microorganisms).

The sensation of warming or cooling effects may also be prolonged with the use of a hydrophobic sweetener as described in U.S. Patent Application Publication 2003/0072842 A1 which is incorporated in its entirety herein by reference.

Food Acid Ingredients

Acids can include, but are not limited to acetic acid, adipic acid, ascorbic acid, butyric acid, citric acid, formic acid, fumaric acid, glyconic acid, lactic acid, phosphoric acid, malic acid, oxalic acid, succinic acid, tartaric acid, aspartic acid, benzoic acid, caffeotannic acid, iso-citric acid, citramalic acid, galacturonic acid, glucuronic acid, glyceric acid, glycolic acid, ketoglutaric acid, a-ketoglutaric acid, lactoisocitric acid, oxalacetic acid, pyruvic acid, quinic acid, shikimic acid, succinic acid, tannic acid, hydroxyacetic acid, suberic acid, sebacic acid, azelaic acid, pimelic acid, capric acid and combinations thereof.

Emulsifiers

The gum structure may also include emulsifiers which aid in dispersing the immiscible components into a single stable system. The emulsifiers useful in this invention include glyceryl monostearate, lecithin, fatty acid monoglycerides, diglycerides, propylene glycol monostearate, methyl cellulose, alginates, carrageenan, xanthan gum, gelatin, carob, tragacanth, locust bean gum, pectin, alginates, galactomannans such as guar gum, carob bean gum, glucomannan, gelatin, starch, starch derivatives, dextrins and cellulose derivatives such as carboxy methyl cellulose, acidulants such as malic acid, adipic acid, citric acid, tartaric acid, fumaric acid, and the like, used alone and mixtures thereof. The emulsifier may be employed in amounts from about 2% to about 15%, and more specifically, from about 7% to about 11%, by weight of the gum structure.

Colors

Coloring agents may be used in amounts effective to produce the desired color. The coloring agents may include pigments which may be incorporated in amounts up to about 6%, by weight of the gum. For example, titanium dioxide may be incorporated in amounts up to about 2%, and preferably less than about 1%, by weight of the gum structure. The colorants may also include natural food colors and dyes suitable for food, drug and cosmetic applications. These colorants are known as F.D.& C. dyes and lakes. The materials acceptable for the foregoing uses are preferably water-soluble. Illustrative nonlimiting examples include the indigoid dye known as F.D.& C. Blue No. 2, which is the disodium salt of 5,5-indigotindisulfonic acid. Similarly, the dye known as F.D.& C. Green No. 1 comprises a triphenylmethane dye and is the monosodium salt of 4-[4-(N-ethyl-p-sulfoniumbenzylamino) diphenylmethylene]-[1-(N-ethyl-N-p-sulfoniumbenzyl)-delta-2,5-cyclohexadieneimine]. A full recitation of all F.D.& C. colorants and their corresponding chemical structures may be found in the Kirk-Othmer Encyclopedia of Chemical Technology, 3rd Edition, in volume 5 at pages 857-884, which text is incorporated herein by reference.

As classified by the United States Food, Drug, and Cosmetic Act (21 C.F.R. 73), colors can include exempt from certification colors (sometimes referred to as natural even though they can be synthetically manufactured) and certified colors (sometimes referred to as artificial), or combinations thereof. In some embodiments, exempt from certification or natural colors can include, but are not limited to annatto extract, (E160b), bixin, norbixin, astaxanthin, dehydrated beets (beet powder), beetroot red/betanin (E162), ultramarine blue, canthaxanthin (E161g), cryptoxanthin (E161c), rubixanthin (E161d), violanxanthin (E161e), rhodoxanthin (E161f), caramel (E150(a-d)), β-apo-8′-carotenal (E160e), β-carotene (E160a), alpha carotene, gamma carotene, ethyl ester of beta-apo-8 carotenal (E160f), flavoxanthin (E161a), lutein (E161b), cochineal extract (E120); carmine (E132), carmoisine/azorubine (E122), sodium copper chlorophyllin (E141), chlorophyll (E140), toasted partially defatted cooked cottonseed flour, ferrous gluconate, ferrous lactate, grape color extract, grape skin extract (enocianina), anthocyanins (E163), haematococcus algae meal, synthetic iron oxide, iron oxides and hydroxides (E172), fruit juice, vegetable juice, dried algae meal, tagetes (Aztec marigold) meal and extract, carrot oil, corn endosperm oil, paprika, paprika oleoresin, phaffia yeast, riboflavin (E101), saffron, titanium dioxide, turmeric (E100), turmeric oleoresin, amaranth (E123), capsanthin/capsorbin (E160c), lycopene (E160d), and combinations thereof.

In some embodiments, certified colors can include, but are not limited to, FD&C blue #1, FD&C blue #2, FD&C green #3, FD&C red #3, FD&C red #40, FD&C yellow #5 and FD&C yellow #6, tartrazine (E102), quinoline yellow (E104), sunset yellow (E110), ponceau (E124), erythrosine (E127), patent blue V (E131), titanium dioxide (E171), aluminium (E173), silver (E174), gold (E175), pigment rubine/lithol rubine BK (E180), calcium carbonate (E170), carbon black (E153), black PN/brilliant black BN (E151), green S/acid brilliant green BS (E142), and combinations thereof. In some embodiments, certified colors can include FD&C aluminum lakes. These include of the aluminum salts of FD&C dyes extended on an insoluble substrate of alumina hydrate. Additionally, in some embodiments, certified colors can be included as calcium salts.

Functional Ingredients

Additional additives including functional ingredients include physiological cooling agents, throat-soothing agents, spices, warming agents, tooth-whitening agents or other dental care ingredients, breath-freshening agents, vitamins, nutraceuticals, phytochemicals, polyphenols, antioxidants, active ingredients, minerals, caffeine, drugs and other actives may also be included in the gum composition. Such components may be used in amounts sufficient to achieve their intended effects and will be more fully discussed below.

Breath Freshening Ingredients

Breath fresheners can include essential oils as well as various aldehydes, alcohols, and similar materials. In some embodiments, essential oils can include oils of spearmint, peppermint, wintergreen, sassafras, chlorophyll, citral, geraniol, cardamom, clove, sage, carvacrol, eucalyptus, cardamom, magnolia bark extract, marjoram, cinnamon, lemon, lime, grapefruit, and orange. In some embodiments, aldehydes such as cinnamic aldehyde and salicylaldehyde can be used. Additionally, chemicals such as menthol, carvone, iso-garrigol, and anethole can function as breath fresheners. Of these, the most commonly employed are oils of peppermint, spearmint and chlorophyll.

In addition to essential oils and chemicals derived from them, in some embodiments breath fresheners can include but are not limited to zinc citrate, zinc acetate, zinc fluoride, zinc ammonium sulfate, zinc bromide, zinc iodide, zinc chloride, zinc nitrate, zinc fluorosilicate, zinc gluconate, zinc tartarate, zinc succinate, zinc formate, zinc chromate, zinc phenol sulfonate, zinc dithionate, zinc sulfate, silver nitrate, zinc salicylate, zinc glycerophosphate, copper nitrate, chlorophyll, copper chlorophyll, chlorophyllin, hydrogenated cottonseed oil, chlorine dioxide, beta cyclodextrin, zeolite, silica-based materials, carbon-based materials, enzymes such as laccase, and combinations thereof.

In some embodiments, the release profiles of probiotics can be managed for a gum structure including, but not limited to lactic acid producing microorganisms such as Bacillus coagulans, Bacillus subtilis, Bacillus laterosporus, Bacillus laevolacticus, Sporolactobacillus inulinus, Lactobacillus acidophilus, Lactobacillus curvatus, Lactobacillus plantarum, Lactobacillus jenseni, Lactobacillus casei, Lactobacillus fermentum, Lactococcus lactis, Pedioccocus acidilacti, Pedioccocus pentosaceus, Pedioccocus urinae, Leuconostoc mesenteroides, Bacillus coagulans, Bacillus subtilis, Bacillus laterosporus, Bacillus laevolacticus, Sporolactobacillus inulinus and mixtures thereof. Breath fresheners are also known by the following trade names: Retsyn,™ Actizol,™ and Nutrazin.™ Examples of malodor-controlling compositions are also included in U.S. Pat. No. 5,300,305 to Stapler et al. and in U.S. Patent Application Publication Nos. 2003/0215417 and 2004/0081713 which are incorporated in their entirety herein by reference for all purposes.

Dental Care Ingredients

Dental care ingredients (also known as oral care ingredients) may include but are not limited to tooth whiteners, stain removers, oral cleaning, bleaching agents, desensitizing agents, dental remineralization agents, antibacterial agents, anticaries agents, plaque acid buffering agents, surfactants and anticalculus agents. Non-limiting examples of such ingredients can include, hydrolytic agents including proteolytic enzymes, abrasives such as hydrated silica, calcium carbonate, sodium bicarbonate and alumina, other active stain-removing components such as surface-active agents, including, but not limited to anionic surfactants such as sodium stearate, sodium palminate, sulfated butyl oleate, sodium oleate, salts of fumaric acid, glycerol, hydroxylated lecithin, sodium lauryl sulfate and chelators such as polyphosphates, which are typically employed as tartar control ingredients. In some embodiments, dental care ingredients can also include tetrasodium pyrophosphate and sodium tri-polyphosphate, sodium bicarbonate, sodium acid pyrophosphate, sodium tripolyphosphate, xylitol, sodium hexametaphosphate.

In some embodiments, peroxides such as carbamide peroxide, calcium peroxide, magnesium peroxide, sodium peroxide, hydrogen peroxide, and peroxydiphospate are included. In some embodiments, potassium nitrate and potassium citrate are included. Other examples can include casein glycomacropeptide, calcium casein peptone-calcium phosphate, casein phosphopeptides, casein phosphopeptide-amorphous calcium phosphate (CPP-ACP), and amorphous calcium phosphate. Still other examples can include papaine, krillase, pepsin, trypsin, lysozyme, dextranase, mutanase, glycoamylase, amylase, glucose oxidase, and combinations thereof.

Further examples can include surfactants such as sodium stearate, sodium ricinoleate, and sodium lauryl sulfate surfactants for use in some embodiments to achieve increased prophylactic action and to render the dental care ingredients more cosmetically acceptable. Surfactants can preferably be detersive materials which impart to the composition detersive and foaming properties. Suitable examples of surfactants are water-soluble salts of higher fatty acid monoglyceride monosulfates, such as the sodium salt of the monosulfated monoglyceride of hydgrogenated coconut oil fatty acids, higher alkyl sulfates such as sodium lauryl sulfate, alkyl aryl sulfonates such as sodium dodecyl benzene sulfonate, higher alkyl sulfoacetates, sodium lauryl sulfoacetate, higher fatty acid esters of 1,2-dihydroxy propane sulfonate, and the substantially saturated higher aliphatic acyl amides of lower aliphatic amino carboxylic acid compounds, such as those having 12 to 16 carbons in the fatty acid, alkyl or acyl radicals, and the like. Examples of the last mentioned amides are N-lauroyl sarcosine, and the sodium, potassium, and ethanolamine salts of N-lauroyl, N-myristoyl, or N-palmitoyl sarcosine.

In addition to surfactants, dental care ingredients can include antibacterial agents such as, but not limited to, triclosan, chlorhexidine, zinc citrate, silver nitrate, copper, limonene, and cetyl pyridinium chloride. In some embodiments, additional anticaries agents can include fluoride ions or fluorine-providing components such as inorganic fluoride salts. In some embodiments, soluble alkali metal salts, for example, sodium fluoride, potassium fluoride, sodium fluorosilicate, ammonium fluorosilicate, sodium monofluorophosphate, as well as tin fluorides, such as stannous fluoride and stannous chloride can be included. In some embodiments, a fluorine-containing compound having a beneficial effect on the care and hygiene of the oral cavity, e.g., diminution of enamel solubility in acid and protection of the teeth against decay may also be included as an ingredient. Examples thereof include sodium fluoride, stannous fluoride, potassium fluoride, potassium stannous fluoride (SnF.sub.2-KF), sodium hexafluorostannate, stannous chlorofluoride, sodium fluorozirconate, and sodium monofluorophosphate. In some embodiments, urea is included.

Further examples are included in the following U.S. patents and U.S. published patent applications, the contents of all of which are incorporated in their entirety herein by reference for all purposes: U.S. Pat. No. 5,227,154 to Reynolds, U.S. Pat. No. 5,378,131 to Greenberg, U.S. Pat. No. 6,846,500 to Luo et al., U.S. Pat. No. 6,733,818 to Luo et al., U.S. Pat. No. 6,696,044 to Luo et al., U.S. Pat. No. 6,685,916 to Holme et al., U.S. Pat. No. 6,485,739 to Luo et al., U.S. Pat. No. 6,479,071 to Holme et al., U.S. Pat. No. 6,471,945 to Luo et al., U.S. Patent Publication Nos. 20050025721 to Holme et al., 2005008732 to Gebreselassie et al., and 20040136928 to Holme et al.

Active Ingredients

Actives generally refer to those ingredients that are included in a delivery system and/or gum structure for the desired end benefit they provide to the user. In some embodiments, actives can include medicaments, nutrients, nutraceuticals, herbals, nutritional supplements, pharmaceuticals, drugs, and the like and combinations thereof.

Examples of useful drugs include ace-inhibitors, antianginal drugs, anti-arrhythmias, anti-asthmatics, anti-cholesterolemics, analgesics, anesthetics, anti-convulsants, anti-depressants, anti-diabetic agents, anti-diarrhea preparations, antidotes, anti-histamines, anti-hypertensive drugs, anti-inflammatory agents, anti-lipid agents, anti-manics, anti-nauseants, anti-stroke agents, anti-thyroid preparations, anti-tumor drugs, anti-viral agents, acne drugs, alkaloids, amino acid preparations, anti-tussives, anti-uricemic drugs, anti-viral drugs, anabolic preparations, systemic and non-systemic anti-infective agents, anti-neoplastics, anti-parkinsonian agents, anti-rheumatic agents, appetite stimulants, biological response modifiers, blood modifiers, bone metabolism regulators, cardiovascular agents, central nervous system stimulates, cholinesterase inhibitors, contraceptives, decongestants, dietary supplements, dopamine receptor agonists, endometriosis management agents, enzymes, erectile dysfunction therapies such as sildenafil citrate, which is currently marketed as Viagra™, fertility agents, gastrointestinal agents, homeopathic remedies, hormones, hypercalcemia and hypocalcemia management agents, immunomodulators, immunosuppressives, migraine preparations, motion sickness treatments, muscle relaxants, obesity management agents, osteoporosis preparations, oxytocics, parasympatholytics, parasympathomimetics, prostaglandins, psychotherapeutic agents, respiratory agents, sedatives, smoking cessation aids such as bromocryptine or nicotine, sympatholytics, tremor preparations, urinary tract agents, vasodilators, laxatives, antacids, ion exchange resins, anti-pyretics, appetite suppressants, expectorants, anti-anxiety agents, anti-ulcer agents, anti-inflammatory substances, coronary dilators, cerebral dilators, peripheral vasodilators, psycho-tropics, stimulants, anti-hypertensive drugs, vasoconstrictors, migraine treatments, antibiotics, tranquilizers, anti-psychotics, anti-tumor drugs, anti-coagulants, anti-thrombotic drugs, hypnotics, anti-emetics, anti-nauseants, anti-convulsants, neuromuscular drugs, hyper- and hypo-glycemic agents, thyroid and anti-thyroid preparations, diuretics, anti-spasmodics, terine relaxants, anti-obesity drugs, erythropoietic drugs, anti-asthmatics, cough suppressants, mucolytics, DNA and genetic modifying drugs, and combinations thereof.

Examples of active ingredients contemplated for use in some embodiments can include antacids, H2-antagonists, and analgesics. For example, antacid dosages can be prepared using the ingredients calcium carbonate alone or in combination with magnesium hydroxide, and/or aluminum hydroxide. Moreover, antacids can be used in combination with H2-antagonists.

Analgesics include opiates and opiate derivatives, such as Oxycontin™, ibuprofen, aspirin, acetaminophen, and combinations thereof that may optionally include caffeine.

Other drug active ingredients for use in embodiments can include anti-diarrheals such as Immodiumm AD, anti-histamines, anti-tussives, decongestants, vitamins, and breath fresheners. Also contemplated for use herein are anxiolytics such as Xanax™; anti-psychotics such as Clozaril™ and Haldol™; non-steroidal anti-inflammatories (NSAID's) such as ibuprofen, naproxen sodium, Voltaren™ and Lodine™, anti-histamines such as Claritin™, Hismanal™, Relafen™, and Tavist™; anti-emetics such as Kytril™ and Cesamet™; bronchodilators such as Bentolin™, Proventil™; anti-depressants such as Prozac™, Zolof™, and Paxil™; anti-migraines such as Imigra™, ACE-inhibitors such as Vasotec™, Capoten™ and Zestril™; anti-Alzheimer's agents, such as Nicergoline™; and CaH-antagonists such as Procardia™, Adalat™, and Calan™.

The popular H2-antagonists which are contemplated for use in the present invention include cimetidine, ranitidine hydrochloride, famotidine, nizatidien, ebrotidine, mifentidine, roxatidine, pisatidine and aceroxatidine.

Active antacid ingredients can include, but are not limited to, the following: aluminum hydroxide, dihydroxyaluminum aminoacetate, aminoacetic acid, aluminum phosphate, dihydroxyaluminum sodium carbonate, bicarbonate, bismuth aluminate, bismuth carbonate, bismuth subcarbonate, bismuth subgallate, bismuth subnitrate, bismuth subsilysilate, calcium carbonate, calcium phosphate, citrate ion (acid or salt), amino acetic acid, hydrate magnesium aluminate sulfate, magaldrate, magnesium aluminosilicate, magnesium carbonate, magnesium glycinate, magnesium hydroxide, magnesium oxide, magnesium trisilicate, milk solids, aluminum mono-ordibasic calcium phosphate, tricalcium phosphate, potassium bicarbonate, sodium tartrate, sodium bicarbonate, magnesium aluminosilicates, tartaric acids and salts.

A variety of nutritional supplements may also be used as active ingredients including virtually any vitamin or mineral. For example, vitamin A, vitamin C, vitamin D, vitamin E, vitamin K, vitamin B6, vitamin B12, thiamine, riboflavin, biotin, folic acid, niacin, pantothenic acid, sodium, potassium, calcium, magnesium, phosphorus, sulfur, chlorine, iron, copper, iodine, zinc, selenium, manganese, choline, chromium, molybdenum, fluorine, cobalt and combinations thereof, may be used.

Examples of nutritional supplements that can be used as active ingredients are set forth in U.S. Patent Application Publication Nos. 2003/0157213 A1, 2003/0206993 and 2003/0099741 A1 which are incorporated in their entirety herein by reference for all purposes.

Various herbals may also be used as active ingredients such as those with various medicinal or dietary supplement properties. Herbals are generally aromatic plants or plant parts and or extracts thereof that can be used medicinally or for flavoring. Suitable herbals can be used singly or in various mixtures. Commonly used herbs include Echinacea, Goldenseal, Calendula, Rosemary, Thyme, Kava Kava, Aloe, Blood Root, Grapefruit Seed Extract, Black Cohosh, Ginseng, Guarana, Cranberry, Gingko Biloba, St. John's Wort, Evening Primrose Oil, Yohimbe Bark, Green Tea, Ma Huang, Maca, Bilberry, Lutein, and combinations thereof.

Effervescing System Ingredients

An effervescent system may include one or more edible acids and one or more edible alkaline materials. The edible acid(s) and the edible alkaline material(s) may react together to generate effervescence.

In some embodiments, the alkaline material(s) may be selected from, but is not limited to, alkali metal carbonates, alkali metal bicarbonates, alkaline earth metal carbonates, alkaline earth metal bicarbonates, and combinations thereof. The edible acid(s) may be selected from, but is not limited to, citric acid, phosphoric acid, tartaric acid, malic acid, ascorbic acid, and combinations thereof. In some embodiments, an effervescing system may include one or more other ingredients such as, for example, carbon dioxide, oral care ingredients, flavorants, etc.

For examples of use of an effervescing system in a gum, refer to U.S. Provisional Patent No. 60/618,222 filed Oct. 13, 2004, and entitled “Effervescent Pressed Confectionery Tablet Compositions,” the contents of which are incorporated herein by reference for all purposes. Other examples can be found in U.S. Pat. No. 6,235,318, the contents of which are incorporated herein by reference for all purposes.

Appetite Suppressor Ingredients

Appetite suppressors can be ingredients such as fiber and protein that function to depress the desire to consume food. Appetite suppressors can also include benzphetamine, diethylpropion, mazindol, phendimetrazine, phentermine, hoodia (P57), Olibra,™ ephedra, caffeine and combinations thereof. Appetite suppressors are also known by the following trade names: Adipex,™ Adipost,™ Bontril™ PDM, Bontril™ Slow Release, Didrex,™ Fastin,™ Ionamin,™ Mazanor,™ Melfiat,™ Obenix,™ Phendiet,™ Phendiet-105,™ Phentercot,™ Phentride,™ Plegine,™ Prelu-2,™ Pro-Fast,™ PT 105,™ Sanorex,™ Tenuate,™ Sanorex,™ Tenuate,™ Tenuate Dospan,™ Tepanil Ten-Tab,™ Teramine,™ and Zantryl.™ These and other suitable appetite suppressors are further described in the following U.S. patents, all of which are incorporated in their entirety by reference hereto: U.S. Pat. No. 6,838,431 to Portman, U.S. Pat. No. 6,716,815 to Portman, U.S. Pat. No. 6,558,690 to Portman, U.S. Pat. No. 6,468,962 to Portman, U.S. Pat. No. 6,436,899 to Portman.

Micronutrient Ingredients

Micronutrients can include materials that have an impact on the nutritional well being of an organism even though the quantity required by the organism to have the desired effect is small relative to macronutrients such as protein, carbohydrate, and fat. Micronutrients can include, but are not limited to vitamins, minerals, enzymes, phytochemicals, antioxidants, and combinations thereof.

In some embodiments, vitamins can include fat soluble vitamins such as vitamin A, vitamin D, vitamin E, and vitamin K and combinations thereof. In some embodiments, vitamins can include water soluble vitamins such as vitamin C (ascorbic acid), the B vitamins (thiamine or B1, riboflavoin or B2, niacin or B3, pyridoxine or B6, folic acid or B9, cyanocobalimin or B12, pantothenic acid, biotin), and combinations thereof.

In some embodiments minerals can include but are not limited to sodium, magnesium, chromium, iodine, iron, manganese, calcium, copper, fluoride, potassium, phosphorous, molybdenum, selenium, zinc, and combinations thereof.

In some embodiments micronutrients can include but are not limited to L-carnitine, choline, coenzyme Q10, alpha-lipoic acid, omega-3-fatty acids, pepsin, phytase, trypsin, lipases, proteases, cellulases, and combinations thereof.

In some embodiments phytochemicals can include but are not limited to cartotenoids, chlorophyll, chlorophyllin, fiber, flavanoids, anthocyanins, cyaniding, delphinidin, malvidin, pelargonidin, peonidin, petunidin, flavanols, catechin, epicatechin, epigallocatechin, epigallocatechingallate (EGCG), theaflavins, thearubigins, proanthocyanins, flavonols, quercetin, kaempferol, myricetin, isorhamnetin, flavononeshesperetin, naringenin, eriodictyol, tangeretin, flavones, apigenin, luteolin, lignans, phytoestrogens, resveratrol, isoflavones, daidzein, genistein, glycitein, soy isoflavones, and combinations thereof.

Mouth Moistening Ingredients

Mouth moisteners can include, but are not limited to, saliva stimulators such as acids and salts and combinations thereof. In some embodiments, acids can include acetic acid, adipic acid, ascorbic acid, butyric acid, citric acid, formic acid, fumaric acid, glyconic acid, lactic acid, phosphoric acid, malic acid, oxalic acid, succinic acid, tartaric acid and combinations thereof. In some embodiments, salts can include sodium chloride, calcium chloride, potassium chloride, magnesium chloride, sea salt, sodium citrate, and combinations thereof.

Mouth moisteners can also include hydrocolloid materials that hydrate and may adhere to oral surface to provide a sensation of mouth moistening. Hydrocolloid materials can include naturally occurring materials such as plant exudates, seed confectioneries, and seaweed extracts or they can be chemically modified materials such as cellulose, starch, or natural confectionery derivatives. In some embodiments, hydrocolloid materials can include pectin, gum arabic, acacia gum, alginates, agar, carageenans, guar gum, xanthan gum, locust bean gum, gelatin, gellan gum, galactomannans, tragacanth gum, karaya gum, curdlan, konjac, chitosan, xyloglucan, beta glucan, furcellaran, gum ghatti, tamarin, bacterial gums, and combinations thereof. Additionally, in some embodiments, modified natural gums such as propylene glycol alginate, carboxymethyl locust bean gum, low methoxyl pectin, and their combinations can be included. In some embodiments, modified celluloses can be included such as microcrystalline cellulose, carboxymethlcellulose (CMC), methylcellulose (MC), hydroxypropylmethylcellulose (HPCM), and hydroxypropylcellulose (MPC), and combinations thereof.

Similarly, humectants which can provide a perception of mouth hydration can be included. Such humectants can include, but are not limited to glycerol, sorbitol, polyethylene glycol, erythritol, and xylitol. Additionally, in some embodiments, fats can provide a perception of mouth moistening. Such fats can include medium chain triglycerides, vegetable oils, fish oils, mineral oils, and combinations thereof.

Throat Care Ingredients

Throat soothing ingredients can include analgesics, anesthetics, demulcents, antiseptic, and combinations thereof. In some embodiments, analgesics/anesthetics can include menthol, phenol, hexylresorcinol, benzocaine, dyclonine hydrochloride, benzyl alcohol, salicyl alcohol, and combinations thereof. In some embodiments, demulcents can include but are not limited to slippery elm bark, pectin, gelatin, and combinations thereof.

In some embodiments, antiseptic ingredients can include cetylpyridinium chloride, domiphen bromide, dequalinium chloride, and combinations thereof.

In some embodiments, antitussive ingredients such as chlophedianol hydrochloride, codeine, codeine phosphate, codeine sulfate, dextromethorphan, dextromethorphan hydrobromide, diphenhydramine citrate, and diphenhydramine hydrochloride, and combinations thereof can be included.

In some embodiments, throat soothing agents such as honey, propolis, aloe vera, glycerine, menthol and combinations thereof can be included. In still other embodiments, cough suppressants can be included. Such cough suppressants can fall into two groups: those that alter the consistency or production of phlegm such as mucolytics and expectorants; and those that suppress the coughing reflex such as codeine (narcotic cough suppressants), antihistamines, dextromethorphan and isoproterenol (non-narcotic cough suppressants). In some embodiments, ingredients from either or both groups can be included.

In still other embodiments, antitussives can include, but are not limited to, the group consisting of codeine, dextromethorphan, dextrorphan, diphenhydramine, hydrocodone, noscapine, oxycodone, pentoxyverine and combinations thereof. In some embodiments, antihistamines can include, but are not limited to, acrivastine, azatadine, brompheniramine, chlorpheniramine, clemastine, cyproheptadine, dexbrompheniramine, dimenhydrinate, diphenhydramine, doxylamine, hydroxyzine, meclizine, phenindamine, phenyltoloxamine, promethazine, pyrilamine, tripelennamine, triprolidine and combinations thereof. In some embodiments, non-sedating antihistamines can include, but are not limited to, astemizole, cetirizine, ebastine, fexofenadine, loratidine, terfenadine, and combinations thereof.

In some embodiments, expectorants can include, but are not limited to, ammonium chloride, guaifenesin, ipecac fluid extract, potassium iodide and combinations thereof. In some embodiments, mucolytics can include, but are not limited to, acetylcycsteine, ambroxol, bromhexine and combinations thereof. In some embodiments, analgesic, antipyretic and anti-inflammatory agents can include, but are not limited to, acetaminophen, aspirin, diclofenac, diflunisal, etodolac, fenoprofen, flurbiprofen, ibuprofen, ketoprofen, ketorolac, nabumetone, naproxen, piroxicam, caffeine and mixtures thereof. In some embodiments, local anesthetics can include, but are not limited to, lidocaine, benzocaine, phenol, dyclonine, benzonotate and mixtures thereof.

In some embodiments nasal decongestants and ingredients that provide the perception of nasal clearing can be included. In some embodiments, nasal decongestants can include but are not limited to phenylpropanolamine, pseudoephedrine, ephedrine, phenylephrine, oxymetazoline, and combinations thereof. In some embodiments ingredients that provide a perception of nasal clearing can include but are not limited to menthol, camphor, bomeol, ephedrine, eucalyptus oil, peppermint oil, methyl salicylate, bornyl acetate, lavender oil, wasabi extracts, horseradish extracts, and combinations thereof.

In some embodiments, a perception of nasal clearing can be provided by odoriferous essential oils, extracts from woods, confectioneries, flowers and other botanicals, resins, animal secretions, and synthetic aromatic materials.

In some embodiments, optional or functional ingredients can include breath fresheners, dental care components, actives, herbals, effervescing systems, appetite suppressors, vitamins, micronutrients, mouth moistening components, throat care components, energy boosting agents, concentration boosting agents, and combinations thereof.

In some embodiments, the modified release component includes at least one ingredient selected from the group comprising flavors, sweeteners, sensates, breath fresheners, dental care components, actives, herbals, effervescing systems, appetite suppressors, potentiators, food acids, micronutrients, mouth moistening components, throat care components, and combinations thereof. These ingredients can be in encapsulated form, in free form, or both.

Series Mixing Systems & Methods

Now that a review of representative ingredients has been provided, further detail will be had as to mixing systems and methods according to embodiments of the present invention.

Depending on the formulation of the gum structure and the system for mixing and processing the ingredients forming the gum structure, ingredients may be added at various locations within the mixing process, be added at various times within the mixing process, be added at multiple locations within the mixing process, have various residence times within the mixing system, be exposed to various residence temperatures, be added at various weight percentages of the finished gum structure, be blended with other ingredients prior to being added to the mixing systems, and be added for various reasons. Some embodiments of gum structures and methods may include multiple ingredients from a single ingredient category, e.g. one gum structure may have several different elastomer ingredients. In addition, some methods and systems may add ingredients in varying orders. For example, in one implementation, the filler may be added prior to an elastomer, while in another method the elastomer may be added prior to the filler.

Some of the steps of forming gum structures may be performed at various physical locations or at various times. For example, it may be highly efficient to mass produce a first generic gum structure, also referred to as a “master batch”, that may be less than a finished gum or finished gum base, at a central location or in mass quantity during a single production run (i.e. all at one time). Then, at a later time, the master batch is combined with the rest of the ingredients required to form a finished gum. The addition of the rest of the ingredients may occur at the same location or the master batch may be shipped to a remote processing plant where the finished gum is formed. Remote processing may occur, for example, when the final ingredients, which may form a substantial amount of the finished gum by weight percent, can be acquired and processed locally more easily, practically and inexpensively than shipping a completed finished gum or importing the finished composition due to various reasons. Large quantity production may occur, for example, when it is desired to form several finished gum compositions that are substantially similar gum structures except for a few ingredients, such as, for example, finished gums having slightly differing flavors or colors.

Two typical forms of master batch include “gum base master batch” and “finished gum master batch.”

A “gum base master batch”, as used herein is a gum composition that is not yet a finished gum base composition, but it includes some or most of the gum base ingredients for forming a finished gum base. For example, a gum base master batch may be a set of gum base ingredients sufficient to form a finished gum based except for the desired amount of filler or emulsifier. For a more specific example, this set of gum base ingredients may include the elastomers, the plasticizers, and the fats, oils, and waxes required to form the desired finished gum base composition but is devoid of some or all of the necessary filler. For another more specific example, this set of gum base ingredients may include the elastomers, the plasticizers, and the fillers required to form the desired finished gum base composition but is devoid of some or all of the necessary fats, oils, and waxes.

A “finished gum master batch”, as used herein, is a gum composition that is not yet a finished gum composition, but it includes most of the gum base and subsequent gum ingredients necessary to from a finished gum. For example, a finished gum master batch may be a set of gum base ingredients sufficient to form the desired gum base in combination with a set of subsequent gum ingredients that provides the desired sweeteners and potentiators but is devoid of the desired colorants and flavors. The production of a finished gum master batch can be desired in the same situation as discussed above, but for potential reasons such as that desired flavors, and corresponding colors, are very regional specific or much cheaper to obtain in a given region.

Kitting can occur with gum base master batch as well. For example, in a central location a gum base master batch may be formed that includes the elastomers, the plasticizers, and the fats, oils, and waxes required to form the desired finished gum base composition but is devoid of some or all of the necessary filler. This gum base master batch is then distributed to other locations where the requisite necessary filler is subsequently added to complete a finished gum base. This can be highly beneficial when the filler can be acquired at a cheaper rate at the remote location or it is cheaper to acquire the filler at the remote location rather than pay for the increased shipping costs, as filler can provide a large portion of the weight and volume of a finished gum base.

Alternatively, it may be highly efficient to provide a mass production of a very common finished gum master batch, which only requires subsequent processing to add the desired flavoring and color to produce the desired finished gum.

This production of a portion of a finished gum structure, i.e. a master batch, at one location and then finishing the finished gum at a local processing facility is one form of a process that can be referred to as kitting. Another form of kitting is when a large mass production of a master batch is formed and then only a few differing ingredients are added to the master batch to form finished gum compositions, such as explained previously with regard to the finished gum master batch. Kitting occurs, where a large batch of a gum structure, e.g. a master batch, is mixed and then that master batch is then used as an ingredient in producing other gum structures, typically finished gums. Some forms of kitting include the formation of several master batches and then blending these master batches with or without additional ingredients at various ratios to form desired gum bases or finished gums. As such master batch itself can be considered an ingredient.

Processing the ingredients to form gum structures can be performed by mixing the ingredients of the gum structures using many existing mixers known in the art. For example, mixers including, but not limited to, static mixers, kettle mixers, sigma blade mixers, planetary mixers, Hobart mixers, Z-blade gum mixers, kneaders, single screw extruders, twin screw extruders, co-rotating twin-screw extruders, counter-rotating twin-screw extruders, reciprocating extruders, blade-and-pin mixers, etc. can be used to blend and processes gum structures. Other known mixers in the art that may suitably be used in practicing the systems and methods of the present invention are disclosed in previously cited patents that are incorporated in their entirety by reference.

In some embodiments, a mixer can be temperature controlled to maintain the residence temperature at a minimum, maximum or other desired level such as by being steam, cold fluid, or hot fluid jacketed, or otherwise heated or cooled. The term “residence temperature” as used herein will refer to the temperature of a composition while it is in a mixer or processing system at a given location or time. As such, a residence temperature may vary as the mixing process progresses either at different times/stages or at different locations of the mixer.

Mixers may provide different types of mixing depending on the ingredients being mixed or the condition of the ingredients being mixed. Two primary types of mixing include distributive and dispersive mixing. Dispersive mixing is typically high shear mixing that breaks up individual ingredients and aggregations of ingredients within a composition into smaller pieces. Distributive mixing is typically lower shear mixing than distributive mixing and is used to distribute the individual ingredients throughout the composition to provide a more uniform composition. Dispersive and distributive mixing are more thoroughly described and discussed in U.S. Pat. No. 5,562,936, the teachings and disclosure of which are hereby incorporated in their entireties by reference thereto.

As used herein, “a continuous mixer”, which may also be referred to herein as a “continuous processor”, is processing equipment in which the various ingredients used to prepare an effluent are fed substantially continuously into the device while those ingredients are being mixed and removed or ejected from the mixing system. For example, in a continuous mixing extruder, ingredients are substantially continuously introduced through various upstream and downstream feed ports, all the while, the screws, blades, pins, paddles or other mixing elements continue to convey the mixture through the system, all the while mixing the same. At a downstream portion of the extruder, the wholly or partly combined downstream portion of the mass is ejected from the extruder by the force of the mass substantially continually or continually being conveyed. The ejection of the mass from the extruder may be facilitated by inclusion of an external or supplemental pump.

A continuous mixer may provide dispersive mixing, distributive mixing or a combination of both dispersive mixing and distributive mixing. For example, a continuous mixer in the form of an extruder can have all dispersive mixing elements, all distributive mixing elements, or a combination of dispersive mixing elements and distributive mixing elements. Due to the characteristics and requirements of mixing gum compositions, the dispersive mixing elements are typically upstream of the distributive mixing elements, however, continuous mixers according to the present invention are not limited to that arrangement.

Representative continuous mixers and methods of continuously mix gum ingredients are exemplified by the following U.S. Pat. Nos. 7,087,254; 6,858,237; 6,811,797; 6,030,647; 6,017,565; 5,976,581; 5,908,645; 5,827,549; 5,800,847; 5,614,234; 5,612,071; 5,543,160; 6,238,710; 6,086,925; 6,017,566; 6,010,723; 6,004,589; 5,773,053; 5,571,543; 5,567,450; 5,562,936; 5,545,416; 5,523,097; 5,486,366; 5,419,919; 5,397,580; 5,085,872; and 5,045,325, the teachings and disclosure of which are hereby incorporated in their entireties by reference thereto.

As used herein, “a batch mixer”, which may also be referred to herein as a “batch processor”, is processing equipment used to prepare a composition that once the composition is prepared the composition is ejected from the equipment all at once or at least discrete non-continuous portions of the composition will be ejected at intermittent intervals, but the composition is not continuously ejected during mixing. Typically, individual ingredients or portions of the individual ingredients used to prepare the composition are fed into the device substantially all at one time or in a predetermined temporal sequence in discrete amounts. Individual ingredients added to a batch mixer may be added at different times throughout the mixing cycle such that some ingredients have a residence time substantially equal to the entire length of the mixing cycle while other ingredients have a residence time for only a fraction of the entire length of the mixing cycle. Further, individual ingredients that are used for different purposes through out the mixing cycle may have different discrete portions of the ingredient added at different times throughout the mixing process. For example, one ingredient may be used to facilitate compounding elastomer as well as may be used as a bulking agent. Such an ingredient may have a first portion added at the beginning of the mixing cycle such that it has a residence time equal to the entire mixing time while a second portion of the same ingredient may be added later in the mixing cycle such that the second portion has a residence time less than the entire mixing time.

A batch mixer will typically provide either dispersive mixing or distributive mixing, but usually not both dispersive and distributive mixing. A batch mixer used in practicing the present invention could be configured to provide both dispersive and distributive mixing. For example, it is contemplated that a kettle mixer that includes internal blades could be configured to shift between dispersive and distributive mixing by modifying the pitch or orientation of the blades. Alternatively, the kettle mixer could include multiple sets of blades, such that one set is configured for dispersive mixing while another set is configured for distributive mixing. It is contemplated the mixer would most likely only use on set of the blades at a time to provide one type of mixing at a time.

Various systems for and methods of mixing various ingredients to form gum structures will follow.

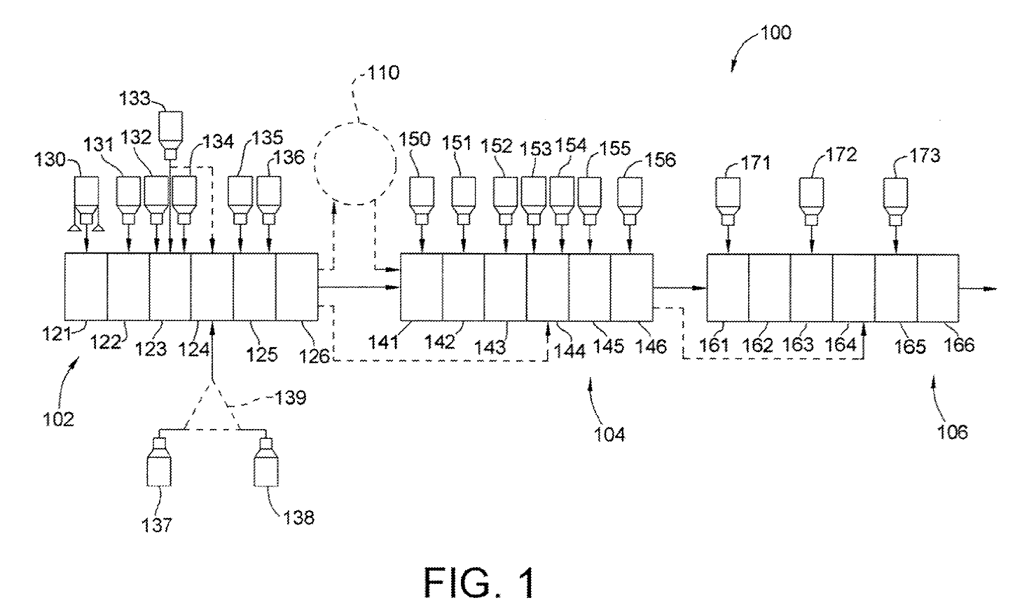

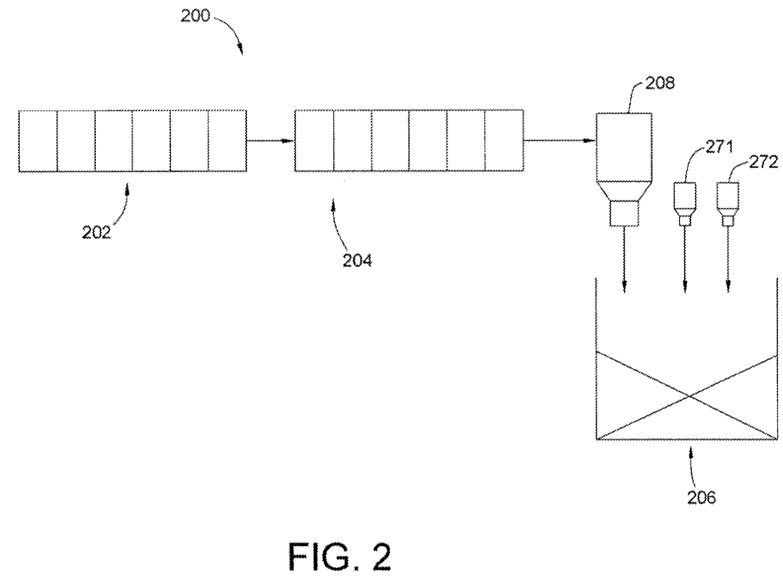

Referring to FIG. 1, a first representative embodiment of a system 100 for use in mixing and processing gum structures is illustrated. This first system 100 will be explained in significant detail, while other embodiments illustrated in FIGS. 2-12, which are similar in many respects to system 100, will be discussed and described in more limited detail highlighting differences and similarities relative to system 100.

System 100 includes three continuous mixers 102, 104, 106 arranged in series, which may comprise any of the aforementioned types of continuous mixers. The three continuous mixers 102, 104, 106 may provide varying levels or types of mixing ranging from high shear dispersive mixing to intermediate or low shear highly distributive mixing, and may even include mixing that is substantially free of shear. Preferably, the first continuous mixer 102 is high shear or includes a high shear section. High shear may alternatively be employed in the second mixer, continuous mixer 104. High sear refers generally to the amount of shear force needed to masticate and compound elastomers.

The continuous mixers 102, 104, 106 include a plurality of feed ports 121-126, 141-146, 161-166, respectively, at which various ingredients may be added to the mixers 102, 104, 106. Continuous mixers 102, 104, 106 are illustrated as each having six feed ports. However, continuous mixers used in practicing embodiments and methods of the present invention are not limited to or require any specific number of feed ports.

The continuous mixers 102, 104, 106 may incorporate any known mixing elements such as high shear elements, low shear elements, kneading elements, neutral elements, high speed elements, low speed elements, etc.

Ingredients may be stored, preferably in a readily available condition, prior to being added to a mixer in ingredient supplies, illustrated schematically in FIG. 1 and identified by reference numerals 131-138, 150-156, 171-173. Representative, ingredient supplies may include storage devices such as gravity flow bins or hoppers, liquid holding tanks or canisters, ingredient impermeable sacks, carts, trays, or other known applicable ingredient storage devices.

The ingredients may be delivered from the ingredient supplies 131-138, 150-156, 171-173 by appropriate ingredient handling systems (individual handling systems are shown schematically as a connecting arrow) such as augers, conveyor belts, side feeders, gravity flow, vacuum conveying systems, liquid pumping, etc. Ingredient handling systems may also incorporate optional blending devices, illustrated schematically and identified by reference numeral 139, such as blenders or low shear mixers. The blending device 139 mixes, also known as pre-blends, ingredients as the ingredients are being delivered from ingredient supplies. For example, ingredient supplies 137, 138 supply ingredients to continuous mixers 102, but prior to being added to the continuous mixer 102. The ingredients from ingredient supplies 137, 138 may be mixed using mixer 139. As a blending device is an optional device to provide some pre-blending and mixing of ingredients, the blending device is illustrated using dashed lines.

Further, the material handling systems will typically include metering devices such as load cells for monitoring the weight loss of a specific ingredient from a given ingredient supply. Alternatively, flow metering devices that measure volume per unit of time may also be used.

As illustrated in FIG. 1, the continuous mixers 102, 104, 106 are aligned generally in series. As such, continuous mixer 102 is upstream from continuous mixer 104 and the effluent of continuous mixer 102 is considered an ingredient added to continuous mixer 104, such as at feed port 141. Similarly, continuous mixer 104 is upstream of continuous mixer 106 and the effluent of continuous mixer 104 is considered an ingredient added to continuous mixer 106, such as at feed port 161.

As used herein, “series” will refer to both (a) the systems described above where the effluent of an upstream mixer is added as the first ingredient in a downstream mixer and (b) the system where the effluent of an upstream mixer is added to a downstream mixer in a downstream feed port. For example, the effluent of continuous mixer 102 may be added to feed port 144 of continuous mixer 104 (illustrated by a dashed line arrow), rather than the first feed port 141 (illustrated as a solid line arrow), whilst other ingredients are being added to continuous mixer 104 upstream of feed port 144 such as to feed ports 141, 142 or 143. Further, an individual mixer, such as any one of continuous mixer 102, 104, 106, may comprise multiple mixers arranged in parallel (but nevertheless in series with the upstream or downstream mixers).

The effluent of continuous mixer 106 will be a gum structure that will typically, but not always, be at least a gum base, something between a gum base and a finished gum, e.g. a gum base plus additional subsequent gum ingredients, or a finished gum, however other gum structure effluents are contemplated. When the effluent is a finished gum, the effluent will be sent on to other gum finishing processes (not shown) including, but not limited to, forming, cooling/conditioning, coating, packaging, shipping, etc.

In some implementations of system 100, the gum structure effluent of the first continuous mixer 102 is not a gum base, but may be something more or may be something less. For example, in a basic implementation, continuous mixer 102 may be used for generally compounding elastomer ingredients such that the effluent of continuous mixer 102 is substantially a compounded elastomer, which may or may not include additional compounding aids. Compounding aids include, by way of example only, fillers, elastomer plasticizers, fats, waxes, resins or combinations thereof. Continuous mixer 102 compounds the elastomer to open up the elastomer matrix such that other ingredients, e.g. the water soluble flavoring or functional ingredients, of a finished gum can be carried by and then released over time as the finished gum is chewed.

Each of the elastomer, filler and elastomer plasticizer can include a single ingredient from each category or can include a combination or combinations of several ingredients from each category of ingredients.

The elastomer, filler and elastomer plasticizer may be fed into the continuous mixer 102 at separate feed ports 121-126 and in varying upstream and downstream arrangements. For example, in some implementations an elastomer ingredient may be fed from ingredient supply 130 to feed port 121 upstream from a filler that is fed from ingredient supply 131 to feed port 122. In other implementations, the filler may be fed from ingredient supply 130 to upstream feed port 130 while the elastomer is fed from ingredient supply 131 to downstream feed port 122 such that the filler is added upstream from the elastomer. This varied arrangement can be applied, where appropriate, to all ingredients added to any of the continuous mixers 102, 104, 106.

In some embodiments and implementations, multiple ingredients such as a filler and an elastomer plasticizer are fed into continuous mixer 102 substantially at the same location or feed port such as a filler may be fed from ingredient supply 132 to feed port 123 while an elastomer plasticizer may be fed from ingredient supply 134 also to feed port 123. Feed port 123 may be provided by one opening that allows multiple ingredients to be fed into the mixer or may include several openings that allow individual or multiple ingredients to be fed into the mixer at substantially equal locations.

In other embodiments and implementations, combinations of the elastomer, filler and/or plasticizer ingredients may be fed into the continuous mixer 102 as a pre-blended mix. For example, one of the elastomer, filler and/or plasticizer may be fed from ingredient supply 137 while another one of the elastomer, filler and/or plasticizer may be fed from supply 138. As these ingredients are fed to feed port 124, the ingredients may be blended such as by an optional blender 139 or merely added together by the ingredient handling system such as an auger, side feeder, fluid flow pipe, a vacuum transporter, conveyor, etc. represented schematically by the connecting arrows.

The addition of ingredients in the continuous mixer can occur at different feed ports so as to partially or wholly mix the ingredients added at a certain point prior to the addition of further ingredients. Also, by varying the location at which various ingredients are added, residence time, residence temperature and types of mixing of a relevant ingredients may be varied, which can be used to vary the characteristics of the gum structure produced by continuous mixer 102. By way of example only, modifying these feed and residence characteristics of individual ingredients can be used to vary the viscosity, texture and consistency of the material to alter the flowability of the composition through the continuous mixer.

Further, an individual ingredient supply, for example feed supply 133 is not limited to storing ingredients for use in a single feed port. For example, feed supply 133 can supply ingredient to both feed port 123 as well as feed port 124. Similarly, a single feed supply may be used for feeding ingredients to multiple mixers.

Additionally, a single ingredient supply may include a plurality of individual temporary storage devices that may serve as a surge device and/or accumulator. For example, a single feed supply could be provided by a plurality of bulk bins connected to a ingredient handling system. In this situation, when one of the storage devices runs empty, the other storage device can be used while filling the empty storage device.

To facilitate compounding and stretching the elastomer, in one embodiment, continuous mixer 102 will be configured for high-shear dispersive mixing. In most implementations, the high-shear dispersive mixing generates high temperatures within the mixer exposing the ingredients within the high-shear portions of the mixer 102 to high residence temperatures. Consequently, the ingredients typically fed to continuous mixer 102 will be ingredients that are generally tolerant of high residence temperatures. The compounding of the elastomer may occur between a range of 125° F. and an excess of 400° F. More typically, compounding residence temperatures will range between about of 225° F. and 375° F.

Cooling can be employed along mixer 102 if desired to facilitate attaining temperatures conducive to other ingredients to afford input of ingredients including water soluble ingredients. Portions of the mixer 102 can be independently cooled as compared to other portions.

Because these ingredients will be exposed to further processing and mixing, e.g. via continuous mixers 104 and 106, these ingredients will also typically be tolerant of longer residence times within the mixing system. The ingredients added to continuous mixers, and particularly continuous mixer 102, may have typical residence times (i.e. average residence times) within continuous mixer 102 of between about 15 seconds and 5 minutes and more typically between about 30 seconds and 2 minutes. However, longer residence times within a continuous mixer are contemplated and may be up to or in excess of 15 minutes depending upon the mixer or gum structure.

To facilitate delivery and/or mixing, some ingredients, such as elastomer, may be first pulverized or ground into chunks prior to being fed into any one of the feed ports 121-126 of continuous mixer 102.

The elastomer ingredients can be fed to the continuous mixer 102 at ambient temperature in a flake, powder or chunk form and the shearing action of the continuous mixer 102 will stretch and heat the elastomer. In other embodiments, the elastomer may be fed into the continuous mixer as a liquid, and in some embodiments a pre-heated liquid at a temperature of between about 160° F. and 275° F. In even further embodiments, both liquid, powder and solid elastomers may be added to continuous processor 102.

In some embodiments, the entire weight percent of an ingredient is added at continuous mixer 102. In other embodiments, only a portion of the total weight percent of an ingredient in the finished gum structure is added in continuous mixer 102, while another portion is added to either or both of continuous mixers 104 and 106. For example, between about 10 to 90% by weight of the total filler added to a finished gum structure may be added at continuous mixer 102, more typically between about 25 to 75% by weight of the total filler added to a finished gum structure or even more typically about 35% to about 50% by weight of the total filler added to a finished gum structure while the remaining portion of the filler is added at other downstream mixers, e.g. continuous mixers 104, 106.

This can be advantageous when a given ingredient can have different effects on the composition at different times with in the mixing process or at different residence temperatures. Further an ingredient may be used to carry another ingredient as it is being added to a continuous mixer.

Adding different weight percentages of a given ingredient at different portions of the ultimate mixing process can be particularly beneficial when kitting, as a lower weight and volume product can be produced and shipped. As such, the final portion of the total amount of the ingredient can be added later at other locations, such as filler. This can be advantageous when shipping product between facilities by lowering shipping costs and/or allowing for more practical, efficient or cheaper materials to be used at the local facility.

In some embodiments, the elastomer plasticizer is added downstream of the elastomer, such that the elastomer plasticizer is added to a feed port 122-126 that is downstream from another one of the feed ports 121-125 of continuous mixer 102. Alternatively, the elastomer plasticizer could be added to the same feed port such as feed port 123 as an elastomer, but be fed into the feed port downstream from the elastomer. For example, the elastomer plasticizer could be fed into feed port 122 while the elastomer is fed into feed port 124. Alternatively, the elastomer plasticizer could be fed from supply 134 while the elastomer is fed from supply 132. In this latter example, both ingredients are fed to feed port 123. In other embodiments, the elastomer plasticizer is added downstream of a first portion of elastomer, but upstream from another portion of the elastomer or a completely different elastomer. For example, a first portion of the elastomer could be fed into feed port 121 from supply 130, an elastomer plasticizer could be fed to feed port 122 from supply 131 and yet another portion or another elastomer could be fed from supply 136 into feed port 125. In yet further embodiments, the elastomer plasticizer is added upstream of the elastomer to the same or another feed port.

These previous examples utilizing specific ingredients also apply to other ingredients added to continuous mixer 102 as well as the ingredients being added to the other continuous mixers 104 and 106 of system 100. These examples of ingredient arrangement and delivery are also, generally applicable to the other systems in FIGS. 2-13.

In some embodiments, the elastomer plasticizer are exposed to a maximum residence temperature of approximately 210° F. within continuous mixer 102 and more preferably a maximum residence temperature of about 200° F.

Other ingredients that may be added to continuous mixer 102 include emulsifiers, preservatives or stabilizing ingredients such as antioxidants.

As illustrated in FIG. 1, the effluent of continuous mixer 102, e.g. compounded elastomer and some compounding aids, may be directly fed and added to continuous mixer 104. Thus, the effluent of continuous mixer 102 is as an ingredient added to continuous mixer 104. The product of continuous mixer 102 may be the first ingredient added to continuous mixer 104 at feed port 141 (illustrated by a solid connecting arrow). Alternatively, it may be added downstream relative to other ingredients that are added to upstream feed ports. For example, the effluent of continuous mixer 102 could be added at feed port 144 (illustrated by the dashed connecting arrow), while other ingredients are added upstream at feed ports 140-143 of continuous mixer 104.

In some embodiments, the effluent of continuous mixer 102 could be diverted to an optional storage system 110, which may be in the form of a holding/surge tank, a recirculating circuit, a chiller/cooler, a forming processor such as to form a storable gum structure, such as in the form of pellets, bricks, agglomerated pellets (pellets in a brittle like form that have not completely separated from one another), or semi-viscous material so that the effluent can be stored until needed or shipped. A similar storage system could also be interposed additionally or alternatively between second mixer 104 and third mixer 106.

In some embodiments, antioxidants or other preservative ingredients are added to the gum structure formed in continuous processor 102. Addition of antioxidants or other preservatives may be particularly useful if the effluent is a master batch or used in kitting such that the effluent is stored for extended periods of time or shipped to other locations for further processing.

Continuous mixer 104 is typically used for mixing the effluent of continuous mixer 102, e.g. generally compounded elastomer, with other ingredients to form a gum structure that will typically be a gum base, a gum base plus additional subsequent gum ingredients, or something short of a gum base that also includes subsequent gum ingredients, such as by adding, for example, additional plasticizers, fats, waxes and additional fillers. At this point, some flavors or sweeteners or other ingredients that effect the taste or intensity of the taste of the finished gum may be introduced.

As the elastomer is typically compounded prior to being added to continuous mixer 104, continuous mixer 104 is typically configured for lower shear mixing that is more distributive than continuous mixer 102. By performing low shear, distributive mixing, the residence temperatures of the composition as it progresses through continuous mixer 104 are typically lower than continuous mixer 102. Maximum residence temperatures (i.e. typical average residence temperatures) of continuous mixer 104 may reach 325° F., but are more typically below 250° F. and even more preferably the residence temperatures vary between about 150° F. and 225° F. Thus, more temperature sensitive ingredients may be fed to continuous mixer 104 with a lower risk of temperature induced degradation or ingredient loss resulting from flash-off. Further, as degradation of an ingredient due to temperature is typically time sensitive, an otherwise temperature sensitive ingredient may be subjected to high temperatures beyond normal temperatures, if the length of exposure is very short.

The lower temperature facilitates the addition of ingredients such as fats, waxes, fillers, sweeteners, plasticizers or syrups/fluids. However, other ingredients that are not as temperature sensitive and that were previously added to the composition in continuous mixer 102 such as additional elastomers, elastomer plasticizers or fillers may also be added to continuous mixer 104.

The ingredients added to continuous mixer 104 will have similar residence times as those ingredients added to continuous mixer 102. The short residence time within a continuous mixer can permit temperature sensitive ingredients that would otherwise not be added to a composition to be added to these mixers, because an ingredient may only be exposed to the high temperature for a very brief period of time, the high temperature has little to no degrading effects on the ingredient.

Further, ingredients such as colors, flavors, sensates and potentiators may also be added to the composition using continuous mixer 104. However, if the product of continuous mixer 104 is going to be used as a master batch, typically colors and flavors will not be added or will be provided in only limited amounts to prevent adding limitations on the uses of the master batch in forming various different finished gum structures.

The order of the addition of these additional ingredients can be varied to alter the flavor and texture of the product of continuous mixer 104. Further, as the residence temperatures within a continuous mixer fluctuate up and downstream, the temperature sensitive ingredients may be added at various locations so that the ingredients are not exposed to the high residence temperatures. In the event that the ingredients must be exposed to the high residence temperatures, the ingredients may be added at a location such that the ingredients are only exposed to the high residence temperature for a short period of time.

Additionally, when adding temperature sensitive ingredients that require or are preferably subjected to lower residence temperatures, continuous mixer 104 may include a cooler/chiller for cooling the composition prior to or while the temperature sensitive ingredient is being mixed and added. Further, a cooler/chiller may also be used to maintain the composition at a lower temperature after the ingredient has been added and mixed.

The ingredients fed to continuous mixer 104, are generally fed using similar ingredient supplies and ingredient handling systems identified previously. The ingredient orientation may also be altered to provide a desired effluent.

The effluent of continuous mixer 104 may be fed to continuous mixer 106 in a similar fashion as the effluent of continuous mixer 102 was fed to continuous mixer 104. For example, the effluent may be fed directly into continuous mixer 106 such as the first ingredient at feed port 161 or as a downstream ingredient at feed port 164. However, in alternative embodiments, the product could be diverted to a chiller/cooler, a holding tank, a recirculating circuit, or a finishing processor as discussed previously.

Continuous mixer 106 can be used to finish the gum structure. The effluent of continuous mixer 106 may be at least a gum base, a gum base plus subsequent gum ingredients, or a finished gum. The ingredients mixed in continuous mixer may be fed from ingredient supplies 170-176 to feed ports 161-166 as discussed previously.

An ingredient fed to continuous mixer 106 may be added to the composition in continuous mixer 106, rather than the earlier continuous mixers 102, 104 for such reasons the individual ingredient may be any one or any combination of highly sensitive to high temperatures, an expensive ingredient, required to be provided and distributed throughout the composition precisely or provided in very limited quantity. The ingredients added to continuous mixer 106 may includes, by way of example only, colors, flavors, sweeteners, sensates and functional ingredients.

Continuous mixer 106 typically includes mixing elements that provide any and all of the following characteristics, low shear, low temperature and highly distributive mixing. The low temperature mixing of continuous mixer 106 is very suitable for the addition of highly temperature sensitive ingredients such as the flavors and sweeteners including both bulk sweeteners and high intensity sweeteners. The temperature of the composition as it flows through continuous mixer 106 is typically limited to below 150° F. and more preferably below 130° F. Other ingredients such as, syrups/fluids, sensates, potentiators, acids, emulsifiers, color, functional ingredients would also typically be added in continuous mixer 106.

The highly distributive mixing of continuous mixer 106 facilitates distribution of ingredients that provide a very limited weight percentage of the finished gum structure such that a substantially homogenous composition is formed. This can be very advantageous, particularly with active ingredients, where the ingredient needs to be distributed at an accurate concentration relative to the rest of the gum structure, such as where an individual stick of gum can and/or must have a very precise amount of ingredient. For example, such as gum that is used for medical reasons.

The product of continuous mixer 106 will typically be a finished gum structure that is ready for finishing processes, such as forming, shaping, conditioning, coating, packaging, etc.

With general reference to system 100, in some embodiments, the liquid ingredients added to individual continuous mixers 102, 104, 106 are added upstream of the dry ingredients. In other embodiments, the dry ingredients may be added to the continuous mixers 102, 104, 106 upstream from the liquid ingredients. In yet further embodiments, the dry and liquid ingredients may be interspersed relative to one another such that dry ingredients are added between upstream and downstream liquid ingredients and/or liquid ingredients are added between upstream and downstream dry ingredients.

Several significant aspects are provided by a system that uses a plurality of mixers to form gum structures.

First, individual mixers can be highly configured for performing desired functions and are not limited to a single volume or movement speed input. As identified previously, a first mixer can be used for compounding the elastomer ingredients. Thus, the mixer can be configured for high shear and highly dispersive mixing. However, a second mixer can be more easily configured for low-shear and low temperature, highly distributive mixing for adding more temperature sensitive ingredients.

Second, by having the mixers separated, the individual drive speeds and throughput of an individual mixer can be tailored to the mixing that it requires. This can reduce energy consumption and power required to drive the mixers.

Third, if one of the mixers breaks down, it can, potentially, be repaired or replaced without requiring complete disassembly of all the other mixers.

A continuous mixer that starts with raw materials and produces finished gum cannot be used when kitting gum structures to form finished gum. Further, when using multiple mixers for all gum production, consistency between different finished gum may be maintained because all gum may formed using similar systems, both, locally and remotely.

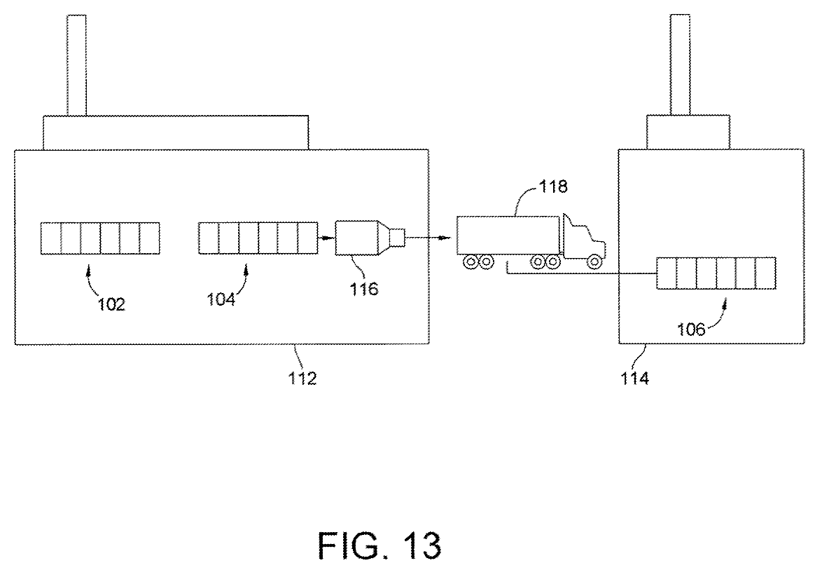

As indicated previously, kitting of the effluents of the various continuous mixers may occur. FIG. 13 illustrates one example of a kitting system generally utilizing the system of FIG. 1. In this system, the first two continuous mixers 102, 104 are located at a first plant 112 while the third continuous mixer 106 is located at a second remote plant 114. In this system, the effluent of continuous mixer 104 may be formed and then packaged or otherwise prepared to be shipped by packaging system 116 which may include devices fzzor pelletizing or forming bricks of the effluent of continuous mixer 104. The effluent is then shipped using shipping system 118 to the second plant 114 where it is used as an ingredient by continuous mixer 106.

When the effluent is shipped to various locations for production of various different flavors or colors, the effluent of continuous mixer 104 will typically be relatively standard in flavor profile and color.

Other ingredients beyond flavoring and coloring may be added to the composition at plant 114 using mixer 106. For example, additional fillers or bulking agents may be added to the gum structure. This is advantageous, as indicated previously, in reducing the volume and weight of product that is shipped to the remote second plant 114. Particularly, where the fillers, bulking agents, or other ingredients can be acquired cheaply at the location of the continuous mixer 106.

While FIG. 13 illustrates continuous mixers 102 and 104 at the first plant 112 and continuous mixer 106 at the second plant 114, other configurations are clearly contemplated. For example, only continuous mixer 102 may be provided at the first plant 112 and the second two continuous mixers 104 and 106 may be provided at the second plant 114. Additionally, continuous mixer 102 may be provided at a first plant, continuous mixer 104 may be provided at a second plant and continuous mixer 106 may be provided at a third plant.

One of ordinary skill in the art will recognize that the kitting system may be applied to the other embodiments disclosed in FIGS. 2-12.

FIG. 2 illustrates an alternative system 200 for processing and mixing various combinations of ingredients to form gum structures. This system includes two continuous mixers 202 and 204 and a batch mixer 206. In this system, continuous mixer 202 is upstream of continuous mixer 204, which is upstream of batch mixer 206. In this system, upstream continuous mixers 202, 204 function and operate much like continuous mixers 102, 104 discussed previously. Mixers 202, 204, 206 will typically receive similar ingredients as identified with respect to mixers 102, 104, 106, discussed previously.

In this embodiment, batch mixer 206 is used for producing the finished gum structure. In one embodiment, continuous mixer 204 supplies its effluent to batch mixer 206 as an ingredient for only a portion of the mixing process. After the requisite quantity of effluent is supplied to the batch mixer 206 for a mixing cycle, continuous mixers 202, 204 are either stopped or, preferably, the effluent of continuous mixer 204 is diverted to another location such as to an accumulator or a surge tank to temporarily hold the effluent of continuous mixer 204 while batch mixer 206 cycles through a batch. In some embodiments, the mixer, accumulator or surge tank maintains the effluent of continuous mixer 204 at an elevated temperature, and preferably substantially as a fluid elevated above ambient such that the effluent can be pumped to batch mixer 206.

Alternatively, the effluent of continuous mixer 204 can be diverted to a storage device 208 that uses a forming device such as a pelletizer or a brick molding system that forms storable effluent in pellets or bricks, respectively. In some embodiments, particularly where the temporary storage device 208 pelletizes or molds bricks of effluent, the temperature of the effluent may significantly drop. As such the storage device 208 may be in the form of a system that further includes a heating or melting system for melting, or at least pre-heating, the pellets or bricks before they are added to batch mixer 206. Such a heating device may include bulk melting tanks, a continuous processor such as an extruder, or other well known devices for heating and melting the effluent.

Pelletizing or molding bricks of the effluent of continuous mixer 204 is very advantageous when kitting, such as when the effluent must be shipped to another location.

In some embodiments, the effluent of continuous mixer 204 is added to batch mixer 206 for substantially the entire length of the mixing process. In other embodiments, the effluent of continuous mixer 204 is added to batch mixer 206 for only a short period of the mixing process. The effluent of continuous mixer 204 may be added to batch mixer 206 prior to any other ingredients, after other ingredients have been added or simultaneously as other ingredients are being added.

In some implementations, the effluent of continuous mixer 204 may pass through a chiller/cooler prior to being added to batch mixer 206, such as when the effluent is fed directly to batch mixer 206. This is particularly beneficial when the effluent of continuous mixer 204 is significantly high that other ingredients added to batch mixer 204 would experience degradation.

Ingredient supplies, such as ingredient supplies 271, 272 for supplying ingredients to batch mixer 206 and corresponding ingredient handling systems are substantially similar to those identified previously and may be used to store and automatically supply ingredients to batch mixer 206. However, unlike continuous mixers, ingredients may be more easily manually added to batch mixer 206. Rather than the point of location being important, usually the timing and sequence of ingredient addition is more important in batch mixing.

In some implementations, dry ingredients may be added to the batch mixer 206 prior to addition of any liquid or moist ingredients. This can be beneficial when one of the dry ingredients, such as a filler, being added to batch mixer 206 can be used to clean residue from a previous batch from the internal components of the batch mixer to prepare the batch mixer 206 for mixing a new batch of ingredients.

Batch cycle times from the start and finish of mixing with batch mixer 206 may range between 2 minutes and 40 minutes and more preferably between about 10 minutes and 30 minutes. However, in some embodiments, individual ingredients have residence times less than the batch cycle time while other ingredients have residence times equal to the batch cycle time.

The time of the mixing cycle at which ingredients are added to batch mixer 206 correlates in many respects as to the location at which an ingredient is added to a continuous mixer. For example, a new ingredient being added later in the mixing cycle of batch mixer 206 may be added at a later time to ensure that the previously added ingredients are adequately mixed prior to adding the new ingredient. Similarly, a new ingredient to be added to a composition using a continuous mixer may be added downstream from a plurality of ingredients so that the upstream ingredients are adequately processed and/or mixed prior to presenting the new ingredient.

Similar to continuous mixers discussed previously, the batch mixer 206 may be heated or cooled to maintain the residence temperature of the ingredients during mixing. The heating or cooling may be varied depending on the particular period of the mixing cycle and the ingredients that are being mixed.

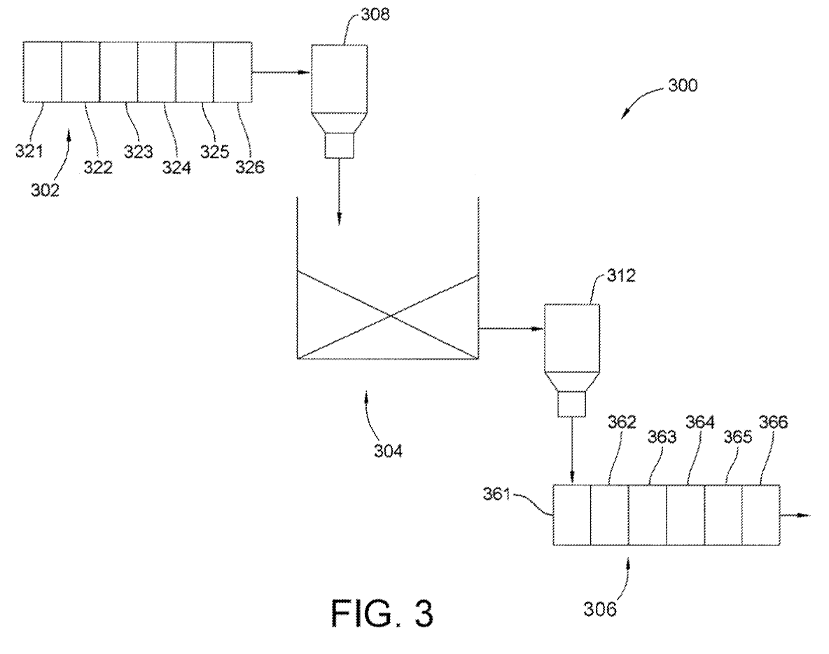

FIG. 3 illustrates a further embodiment of a system 300 for processing and mixing ingredients to produce gum structures. This embodiment utilizes three mixers including a continuous mixer 302, a batch mixer 304 and a continuous mixer 306, with the continuous mixers 302, 306 upstream and downstream, respectively, of batch mixer 304. Continuous mixers 302 and 306 function substantially similar to continuous mixers 102 and 106 discussed previously.

In one embodiment after continuous mixer 302 supplies batch mixer 304 with sufficient effluent for the gum structure formed during one mixing cycle in batch mixer 304, continuous mixer 302 is shut down while it awaits batch mixer 304 to be emptied after each mixing cycle.

In alternative embodiments, the mixing system 300 includes a temporary storage device 308 to hold the effluent of continuous mixer 302 while 304 cycles through a batch. Similarly to storage device 208 discussed previously, temporary storage device 308 may include a recirculating system, a surge tank or accumulator such that the effluent of continuous mixer 302 remains fluid and may include heaters to maintain the effluent at a temperature elevated above ambient. Alternatively, the temporary storage device 308 may pelletize or mold bricks of the effluent of continuous mixer 302 such that the effluent can be stored until needed by batch mixer 304.

In some embodiments, particularly, where the temporary storage device 308 substantially solidifies the effluent to form pellets or bricks, storage device 308 may further include a heating or melting device for raising the temperature of the effluent prior to adding it to the batch mixer 304. In alternative embodiments, mixer 304 may be heated to melt the effluent prior to addition of other ingredients. In even further embodiments, batch mixer 304 may provide sufficient shear to generate enough heat to melt the bricks or pellets.

Because batch mixer 304 generates periodic batches of gum structure effluent that are complete at the end of the mixing cycle, the entire batch is generally simultaneously expelled from batch mixer 304. By expelling all of the effluent of batch mixer 304, typically, more effluent is available for use by the downstream continuous mixer 306 than can be simultaneously fed into the continuous mixer 306. Particularly, because continuous mixer 306 is configured to be continuously fed ingredients, rather than fed a bulk quantity of ingredient that is greater than can be added directly to the continuous mixer 306. Thus, the effluent of batch mixer 304 typically must be pumped or otherwise transported to another storage device 312, which may take the form of a surge tank, storage bin, storage tank or forming device to form bricks or pellets to hold the excess effluent until it can be processed through continuous mixer 306.

Thus, in embodiments of systems that incorporate batch mixers as well as continuous mixers, a storage device of some type will typically be required between the batch mixer and the continuous mixer either to store the effluent of an upstream continuous mixer while the batch mixer is full and performing a mixing cycle or to hold the effluent of the batch mixer as it is progressively fed through a downstream continuous mixer.

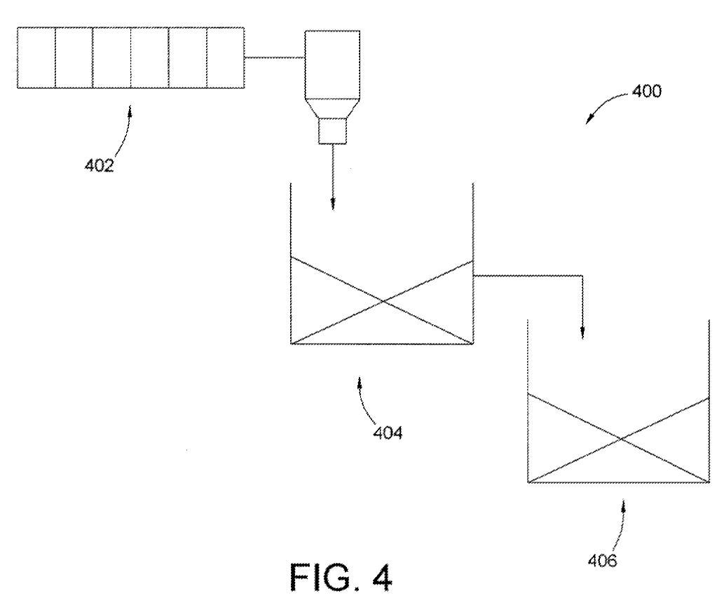

However, with reference to system 400 of FIG. 4, a batch mixer to batch mixer system such as between batch mixer 404 to batch mixer 406 in FIG. 4 does not typically require intermediate storage devices interposed between the batch mixers 404, 406. More particularly, effluent of batch mixer 404 may be expelled from batch mixer 404 and directly fed, manually or automatically, to batch mixer 406. However, in the circumstance where an upstream batch mixer, e.g. batch mixer 404, has a shorter batch cycle than a downstream batch mixer, e.g. batch mixer 406, a temporary storage device (not shown) may be utilized in between the two batch mixers 404, 406.

Generally, system 400 operates and utilizes its continuous mixer 402 and batch mixers 404, 406 in a substantially similar manner as previously discussed continuous mixers and batch mixers.

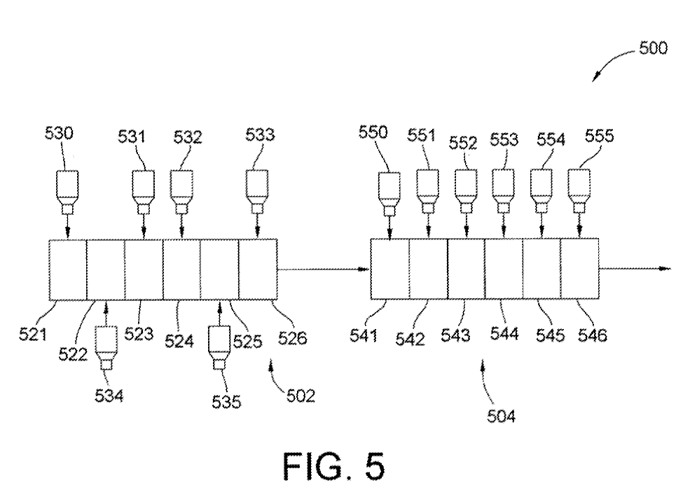

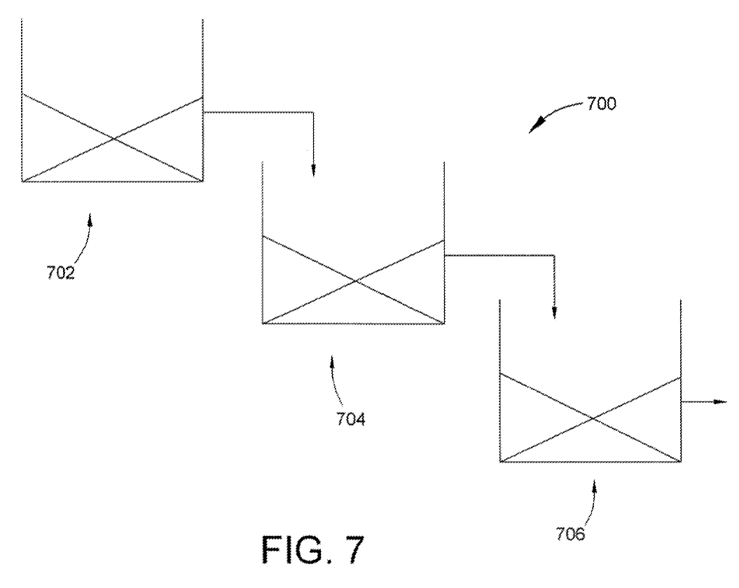

FIGS. 5-12 illustrate additional embodiments of systems for processing subsequent gum ingredients to produce finished gum. These systems may include two mixers such as the systems 500, 600, 1100 and 1200 illustrated in FIGS. 5, 6, 11 and 12, respectively, or three mixers such as systems 700-1000 illustrated in FIGS. 7-10, respectively.

In the two mixer systems 500, 600, 1100 and 1200, the functions of portions of two of the three mixers of the three mixer systems 100-400 and 700-1000 are performed by at least one of the mixers of the two mixer systems 500, 600, 1100 and 1200.

For example, with reference to FIG. 5, system 500 may be configured such that continuous mixer 502 functions substantially similar to mixer 102 discussed previously and continuous mixer 504 combines the mixing elements of continuous mixers 104 and 106 of system 100 to perform the similar functions.

For example, in one embodiment, continuous mixer 502 includes primarily high shear, high temperature mixing and the effluent of mixer 502. The ingredients added to continuous mixer 502 at feed ports 521-526 from ingredient supplies 530-533 may be elastomers, and potentially some compounding aids such as fillers and elastomer plasticizers. As such the effluent from continuous mixer 502 may be substantially only a compounded elastomer, with or without some compounding aids. Continuous mixer 504 will be configured for lower shear and lower temperature mixing. As such, continuous mixer 504 will be fed the rest of the ingredients to form the desired gum structure from ingredient supplies 550-555 at various feed ports 541-546. Ingredients such as flavors, sweeteners, colors, emulsifiers, fats, waxes will typically be added to the composition in continuous mixer 504. Additional portions of fillers and ingredients used to compound the elastomer may also added to the composition in continuous mixer 504.

In some embodiments, the gum structure effluent of continuous mixer 502 may be substantially more than a compounded elastomer. In this implementation, continuous mixer 502 will be fed elastomers, fillers, preservatives, resins, emulsifiers, elastomer plasticizers, plasticizers, fats, waxes, and/or some initial colors or flavors. In such an implementation, continuous mixer 502 will typically include both high shear and low shear mixing elements. For example, the mixing elements of continuous mixer 502 proximate feed ports 521-523 may be similar to the mixing elements of continuous mixer 102, while downstream mixing elements proximate feed ports 524-526 may be intermediate or low shear similar to the mixing elements of continuous mixer 104.

In some embodiments a portion of continuous mixer 502 will preferably be, at least partially, cold fluid jacketed or include an intermediate cooling section so as to attempt to reduce the temperature of the composition as it passes through continuous mixer 502. Typically the cold fluid jacket or cooling sections are positioned prior to the location where the more temperature sensitive ingredients, e.g. sweeteners or flavors, are added. For example, the portion of continuous mixer proximate feed ports 524-526 may be cold fluid jacketed or a cooling section may be provided between feed ports 523 and 524. Further, the portion of continuous mixer 502 proximate feed ports 521-523 may be warm fluid or steam jacketed to maintain the proper temperature for compounding the elastomer.

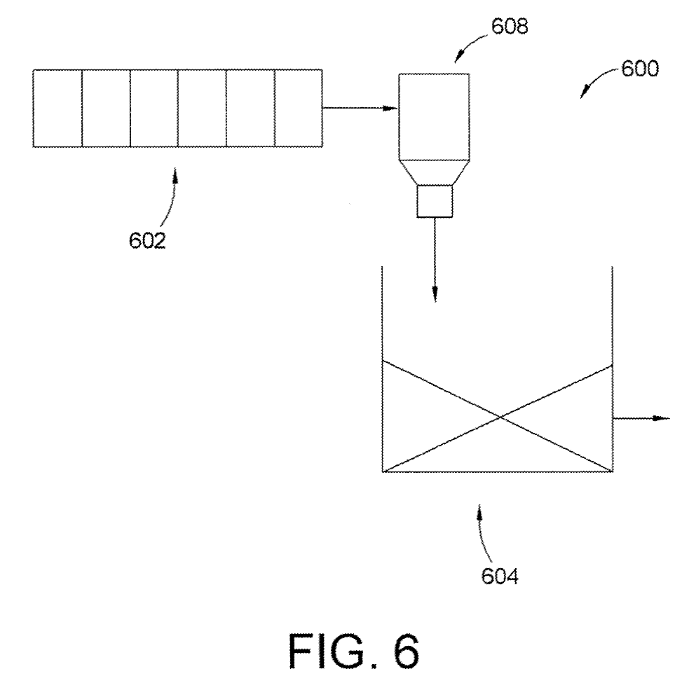

FIG. 6 illustrates a system 600 that includes a continuous mixer 602 upstream of a batch mixer 604. This system 600 is similar to system 500 because it includes two mixers. In some embodiments, continuous mixer 602 functions much like continuous mixer 502 and may be used for the limited purpose of compounding the elastomer or in other embodiments continuous mixer 502 may be used for producing much more than a compounded elastomer. The rest of the ingredients required to finish the desired gum structure are then added to the composition at batch mixer 604. Because system 600 has continuous mixer 602 upstream and feeding batch mixer 604, some embodiments may include a storage device 608, which may be implemented or include such devices as discussed previously.

FIG. 7 illustrates a further embodiment of a system 700 for mixing and processing ingredients to form gum structures. This embodiment includes three batch mixers 702, 704, 706 aligned in series. The effluent of batch mixer 702 is added to batch mixer 704 as an ingredient and the effluent of batch mixer 704 is added to batch mixer 706 as an ingredient.

Preferably, batch mixers 702, 704, 706 have similar shear characteristics as continuous mixers 102, 104, 106, respectively.

The order in which ingredients are mixed using batch mixers 702, 704, 706 is dependent upon the time at which an individual ingredient is added to the batch mixers 702, 704, 706 during the mixing cycle. In some embodiments, a portion of dry filler may be added to the batch mixers 702, 704, 706 to assist in cleaning or preparing the internal components of the batch mixers 702, 704, 706 for a new batch prior to adding other ingredients, particularly liquid ingredients.

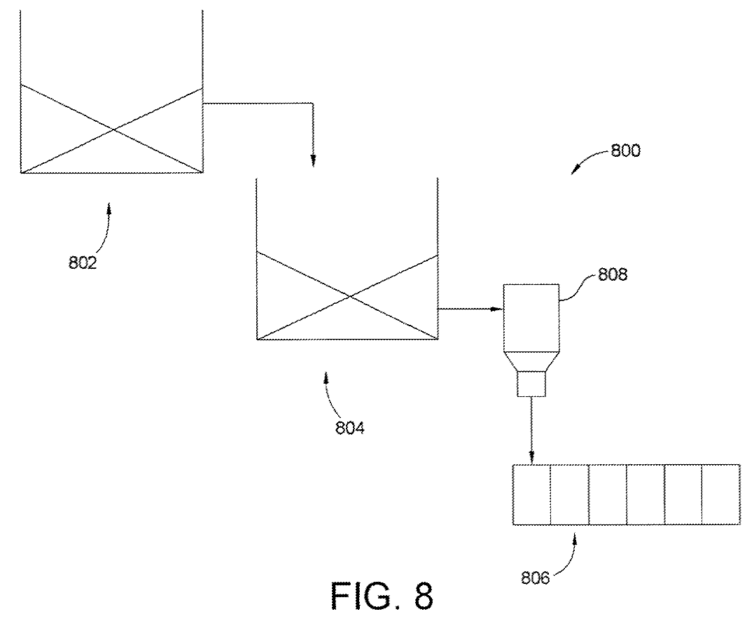

FIGS. 8-12 illustrate additional representative systems for mixing and processing ingredients to form gum structures. The understanding and operation of these additional systems can be understood from the description of the previous embodiments of systems 100-700.

FIG. 8 illustrates an alternative system 800 for processing and mixing various combinations of ingredients to form gum structures. This system includes two batch mixers 802 and 804 and a continuous mixer 806 in series, respectively. In this system, batch mixer 802 is upstream of batch mixer 804, which is upstream of continuous mixer 806. System will typically include a temporary storage device 808 to hold the excess effluent from batch mixer 804 while the effluent is waiting to be processed through continuous mixer 806. The individual mixers will function in a similar manner as discussed previously. Further, the system may incorporate similar features such as cooling devices and ingredient supply and handling systems as discussed previously.

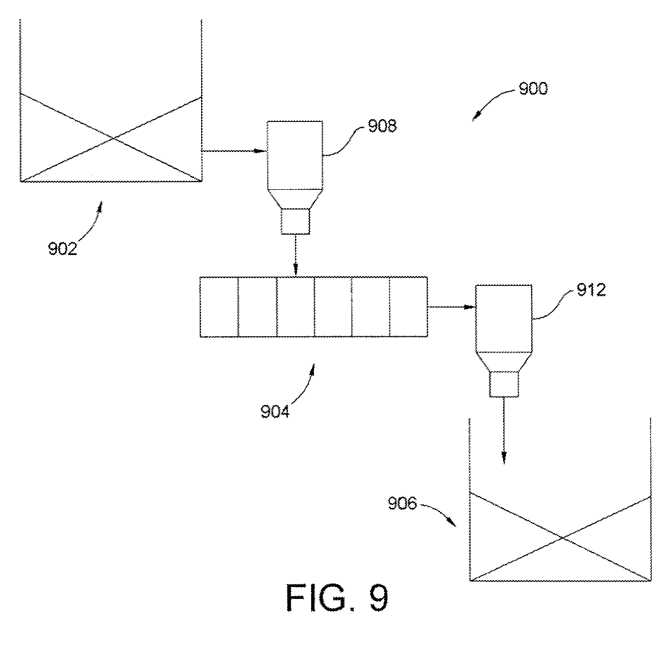

FIG. 9 illustrates an alternative system 900 for processing and mixing various combinations of ingredients to form gum structures. This system includes a first batch mixer 902, a continuous mixer 904 and a second batch mixer 906 arranged in series, respectively. In this system, batch mixer 902 is upstream of continuous mixer 904, which is upstream of batch mixer 906. The system 900 will include a first temporary storage device 908 for storing the batch of effluent from batch mixer 902 while it is being fed into continuous mixer 904. Also, system 900 will incorporate a temporary storage device 912 between the continuous mixer 904 and the batch mixer to store the effluent from continuous mixer 904 while batch mixer 906 processes a batch. The individual mixers will function in a similar manner as discussed previously. Further, the system may incorporate similar features such as cooling devices and ingredient supply and handling systems as discussed previously.

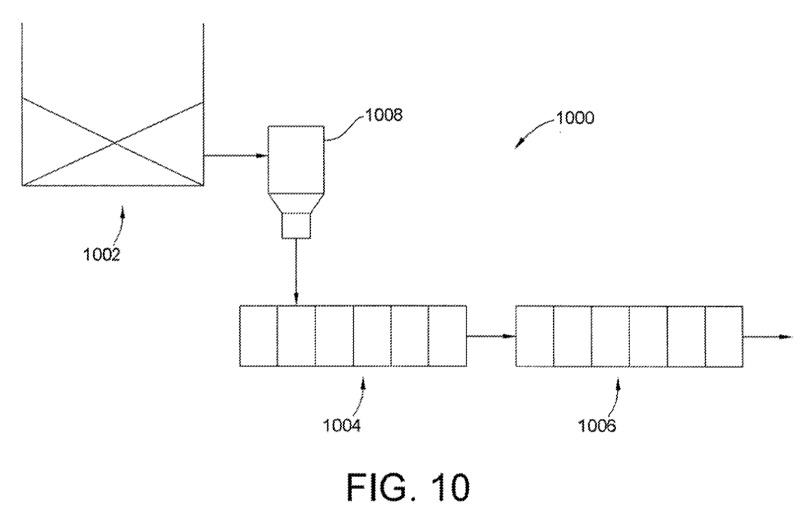

FIG. 10 illustrates an alternative system 1000 for processing and mixing various combinations of ingredients to form gum structures. This system includes a batch mixer and two continuous mixers 1004, 1006 arranged in series, respectively. In this system, batch mixer 1002 is upstream of continuous mixer 1004, which is upstream of continuous mixer 1006. As batch mixer 1002 supplies effluent to a continuous mixer 1004, the system 1000 will typically incorporate a temporary storage device 1008, as described previously. The individual mixers will function in a similar manner as discussed previously. Further, the system may incorporate similar features such as cooling devices and ingredient supply and handling systems as discussed previously.

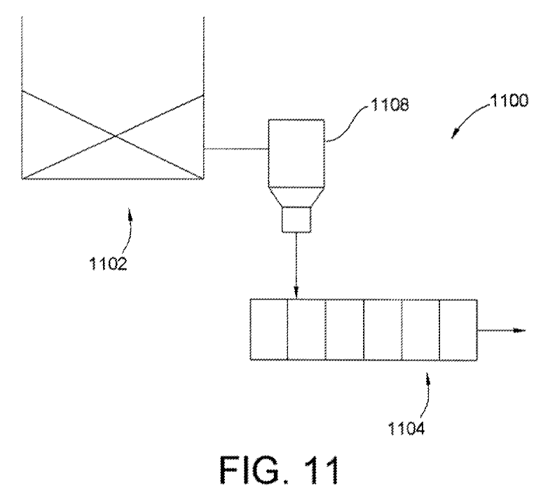

FIG. 11 illustrates an alternative system 1100 for processing and mixing various combinations of ingredients to form gum structures. This system includes a batch mixer 1102 and a continuous mixer 1104 arranged in series, respectively. In this system, batch mixer 1102 is upstream of batch mixer 1104. The individual mixers will function in a similar manner as discussed previously. As batch mixer 1102 supplies effluent to a continuous mixer 1104, the system 1100 will typically incorporate a temporary storage device 1108, as described previously. The individual mixers will function in a similar manner as discussed previously. Further, the system may incorporate similar features such as cooling devices and ingredient supply and handling systems as discussed previously.

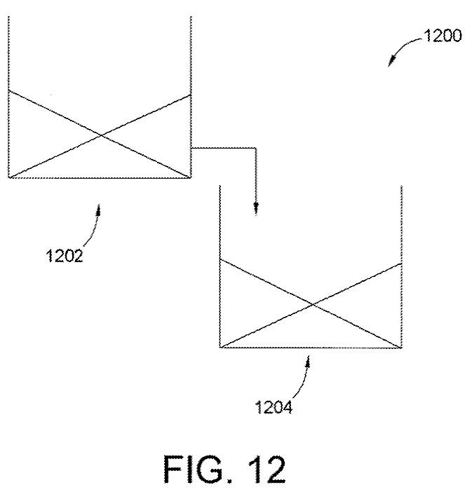

FIG. 12 illustrates an alternative system 1200 for processing and mixing various combinations of ingredients to form gum structures. This system includes two batch mixers 1202 and 1204 arranged in series, respectively. In this system, batch mixer 802 is upstream of batch mixer 804. The individual mixers will function in a similar manner as discussed previously. Further, the system may incorporate similar features such as cooling, temporary storage devices and ingredient supply and handling system as discussed previously.

### SERIES MIXING EXAMPLES

Now that individual ingredients and representative mixing systems for combining the ingredients have been discussed, the following examples will provide representative finished gum compositions and potential ingredients in those finished gum compositions by weight percent. Further examples will illustrate potential intermediate gum structure effluents discharged from individual mixers used in the mixing processes performed by the mixing systems 100-1200. Even further examples will illustrate gum structures that are less than finished gum structures can be generated.

Table 1 begins by illustrating a general break down of representative weight percentages of various ingredients, by broad category, that are typically, but not always, employed in finished gum structures.

TABLE 1

| Ingredient | % by Weight Percent |
|---|---|
| Elastomers | 1-30% |
| Elastomer Plasticizer or Resins | 0-50% |
| Plasticizers | 0-20% |
| Fats | 0-40% |
| Waxes | 0-20% |
| Fillers | 0-50% |
| Antioxidants | 0-5% |
| Bulk Sweeteners | 5-75% |
| High Intensity Sweeteners | 0-5% |
| Syrups/fluids | 0-15% |
| Flavors | 0.1-15% |
| Sensates | 0-5% |
| Potentiators | 0-5% |
| Acids | 0-5% |
| Emulsifiers | 0-10% |
| Colors | 0-5% |
| Functional Ingredients | 0-5% |

Table 2 illustrates a few examples of representative finished gum bases that can be used in finished gum compositions. More particularly, Table 2 illustrates representative gum base ingredients illustrated by weight percents of a contemplated finished gum base. These, and other, gum bases can be formed using the mixing systems 100-1200 discussed previously.

TABLE 2
Examples 1-5; Representative Gum Bases

| Ingredient | 1 | 2 | 3 | 4 | 5 |
|---|---|---|---|---|---|
| Elastomers (High | | | | | |
| Molecular Weight) | | | | | |
| Butyl Rubber | 8-12 | 4-8 | 0 | 4-8 | 6-10 |
| Styrene-butadiene | | | 5-11 | | |
| Rubber | | | | | |
| Additional Elastomers | | | | | |
| Polyvinyl Acetate (PVA) | 5-15 | 10-30 | 15-25 | 10-20 | 20-30 |
| Elastomers (Low | | | | | |
| Molecular Weight) | | | | | |
| Polyisobutylene | 10-20 | 8-10 | 0 | 5-10 | 10-20 |
| Softeners/Plasticizers/ | | | | | |
| Oils/Waxes | | | | | |
| Rosin esters | 5-30 | 5-10 | 15-20 | 20-35 | 5-10 |
| Waxes | 4-10 | 8-12 | 5-15 | 5-10 | 5-10 |
| Vegetable oils | 10-30 | 15-25 | 5-15 | 2-5 | 20-30 |
| (hydrogenated) | | | | | |
| Emulsifiers | 3-8 | 5-10 | 3-8 | 0-2 | 2-5 |
| Triacetin | | | | | |
| Glycerol Monostearate | | | | | |
| Lecithin | | | | | |
| Fillers | | | | | |
| Calcium Carbonate | 30-40 | 0-10 | 10-20 | | |
| Talc | | | | 10-20 | 10-20 |
| Totals: | 100 | 100 | 100 | 100 | 100 |

Table 3 illustrates a few examples of representative finished gums. More particularly, Table 3 illustrates representative finished gum structures that incorporate at least one of the finished gum base structures of Table 2. These finished gum structures additionally incorporate subsequent gum ingredients to form finished gum structures. The ingredients are listed by way of weight percent of the finished gum composition. These, and other, finished gum structures can be formed using the mixing systems 100-1200 discussed previously.

Other gum structures based on the finished gum structures of Examples 6-10 that are not finished gums because the gum structure lacks one or more of the listed ingredients are contemplated as being potential outputs of the mixing systems 100-1200.

TABLE 3
Examples 6-10; Finished Gum Compositions

| Ingredient | 6 | 7 | 8 | 9 | 10 |
|---|---|---|---|---|---|
| Finished Gum | | | | | |
| Base | | | | | |
| Gum Base from | 20%-60% | | | | |
| Example 1 | | | | | |
| Gum Base from | | 10%-30% | | | |
| Example 2 | | | | | |
| Gum Base from | | | 20%-50% | | |
| Example 3 | | | | | |
| Gum Base from | | | | 30%-60% | |
| Example 4 | | | | | |
| Gum Base from | | | | | 10%-30% |
| Example 5 | | | | | |
| Subsequent Gum | | | | | |
| Ingredients | | | | | |
| Bulk Sweeteners | | | | | |
| Sucrose | 30%-70% | 0 | 25%-50% | 30%-70% | 0 |
| Corn Syrup | 50%-30% | 0 | 10-30% | 10%-30% | 0 |
| Hydrogenated | 0 | 0.1-10% | 0.1-10% | 0 | 0.1-10% |
| Starch Hydrolysates | | | | | |
| Sorbitol | 0 | 30%-70% | 10%-30% | 0 | 30%-70% |
| Erythritol | 0 | 0-20% | 1%-10% | 0 | 0-20% |
| Xylitol | 0 | 0-20% | 0-10% | 0 | 0-20% |
| Maltitol | 0 | 0-60% | 0-30% | 0 | 0-60% |
| Isomalt | 0 | 0-20% | 0-10% | 0 | 0-20% |
| Mannitol | 0 | 0-60% | 0-50% | 0 | 0-60% |
| High Intensity | | | | | |
| Sweeteners | | | | | |
| Neotame | 0-1% | 0-1% | 0-1% | 0-1% | 0-1% |
| Sucralose | 0-1% | 0-1% | 0-1% | 0-1% | 0-1% |
| Ace-K | 0-1% | 0-1% | 0-1% | 0-1% | 0-1% |
| Aspartame | 0-3% | 0-3% | 0-3% | 0-3% | 0-3% |
| Encapsulated | | | | | |
| Sweetener | | | | | |
| Sucralose | 0-7% | 0-7% | 0-2% | 0-7% | 0-2% |
| Encapsulated in | | | | | |
| PVA | | | | | |
| Aspartame | 0-7% | 0-7% | 0-2% | 0-7% | 0-2% |
| Encapsulated in | | | | | |
| PVA | | | | | |
| Fluids | | | | | |
| Glycerin | 0.1-1% | 0.1-15% | 0.1-5% | 0.1-1% | 0.1-1% |
| Emulsifiers | | | | | |
| Lecithin | 0.1-10% | 0.1-10% | 0.1%-10% | 0.1-10% | 0.1-10% |
| Flavor | 2-5% | 0.1-3% | 0.1-3% | 0.1-3% | 2-5% |
| Acid(s) | 0.1-10% | 0.1-10% | | 0.1-10% | |
| Color(s) | 0.001-0.2% | .001-0.2% | 0.001-0.2% | 0.001-0.2% | 0.001-0.2% |

Table 4 expands on Tables 1, 2 and 3 by illustrating contemplated processes and individual steps for generally mixing and adding the ingredients identified in Tables 1, 2 and 3 using mixing systems and methods according to the present invention. In doing so, Table 4 provides an overarching map of potential types of effluents, i.e. intermediate and final gum structures, from the various mixers in the mixing systems 100-1200 discussed previously.

Mixer 1 generally corresponds to the first mixer in the series of mixers of the previously discussed mixing systems 100-1200 (i.e. the mixer in a given system having a reference numeral ending in “02”). Similarly, mixer 2 corresponds to the second mixer in the series of mixers of the previously discussed mixing systems 100-1200 (i.e. the mixer in a given system having the reference numeral ending in “04”). Downstream mixing, where applicable, is contemplated to be performed by the third mixer (i.e. the mixer in a given system having a reference numeral ending in “06”) in the previously discussed mixing systems that include three mixers.

It will be understood, in view of the previous discussion of the mixing systems 100-1200, that various intermediate structures such as holding tanks, temporary storage devices, cooling devices, etc. may be interposed between or included in mixers 1, 2 and downstream mixing such that the effluent of one mixer does not necessarily need to flow directly from one mixer to the next. Further, individual mixers may include various means to maintain or reduce temperature of the internal mixtures as the ingredients in individual mixers are being processed.

One of ordinary skill in the art can correlate the effluent of each mixer to the types of ingredients, namely gum base ingredients or subsequent gum ingredients, that are contemplated to be added to each mixer. The immediately following discussion will provide a key to the symbols used in the Table 4.

FG is a finished/complete gum product including a finished gum base (FGB) and a finished set of subsequent gum ingredients (FSGI), but that has not yet been rolled, scored, formed, conditioned, coated or exposed to other post mixing processes. Tables 1 and 3, provided above, illustrate compositional examples of several contemplated FGs.

FGB is set of gum base ingredients (GBI^{x}) forming a finished gum base. FGBs may vary such that not all FGBs are the same. Table 2, provided above, illustrates compositional examples of several contemplated FGBs. As illustrated by the FGBs of Examples 1 and 3 of Table 2, it is clear that an FGB can have different ingredients within an ingredient category, e.g. Example 1 uses Butyl Rubber while Example 3 does not use any Butyl Rubber but instead uses Styrene-butadiene Rubber. Further, Examples 1 and 3 illustrate that a specific ingredient can be used in different rations. For example, the FGB of Example 1 uses between 5-15 by weight percent PVA, while Example 3 uses between 15-25 by weight percent PVA.

FSGI is a set of subsequent gum ingredients (SGTx), not including gum base or coating ingredients, in a finished gum product, also referred to herein as a “finished set of subsequent gum ingredients”. FSGIs may vary such that not all FSGIs are the same. Generally, these ingredients form the water soluble portion of a gum structure. The set of subsequent gum ingredients identified in Examples 6-10 of Table 3 illustrate several contemplated representative FSGIs. For Example, the FSGI of Example 6 identified above includes a desired combination of bulk sweeteners, high intensity sweeteners, encapsulated sweeteners, fluids, emulsifiers, flavor, acids and colors. However, Example 7 is an FSGI that is different than Example 6 and fails to include any encapsulated sweeteners.

GBIx is a set of gum base ingredients that does not include subsequent gum ingredients. GBIxs may vary such that not all GBIxs are the same. When used in Table 4, a GBIx is less than a finished gum base. However, a GBIx in one gum structure may be a FGB of another gum structure. For example, a first GBIx for a first gum structure or process may merely be elastomer, while a second GBIx for a second gum structure or process may include elastomer, plasticizer, fats, waxes, oils, filler and softeners. In this second example, the set of ingredients is not sufficient to form a FGB for the desired gum structure, but may be sufficient to form an FGB for a different gum structure.

As used herein, a “set” may include one or more ingredients. As such, a “set”, as used herein and above, need not include multiple ingredients.

GBIxy is a GBIx effluent or portion of an effluent from an upstream mixer plus at least one additional gum base ingredient GBIy. When used in Table 4, a GBIxy is less than a finished gum base. GBIxys may vary such that not all GBIxys are the same. However, a GBIxy in one gum structure may be a GBIx of another gum structure. Further, a GBIxy may be the combination of the same ingredient added in two different mixers. For example, a GBIxy may be generated by adding a first portion of filler (GBIx) in a first mixer and then adding a second portion of the same exact type of filler (GBIy) in a second mixer to form a GBIxy in the second mixer that is formed entirely of a single ingredient Alternatively, a GBIxy of a first gum structure or process may be the combination of an elastomer (GBIx) added in an upstream mixer and a plasticizer (GBIy) added in a downstream mixer.

GBIxyz is a GBIxy effluent or portion of an effluent from an upstream mixer plus at least one additional gum base ingredient GBIz. When used in Table 4, a GBIxyz is less than a finished gum base. GBIxyzs may vary such that not all GBIxyzs are the same.

SGIx is a set of subsequent gum ingredients that not including gum base or coating ingredients. SGIxs may vary such that not all SGIxs are the same. When used in Table 4, a SGIx is less than a finished set of gum ingredients. Further, a SGIx in one gum structure may be a FSGI of another gum structure. For example, a first SGIx for a first gum structure or process may merely be bulk sweeteners, while a second SGIx for a second gum structure or process may include bulk sweeteners, encapsulated sweeteners, high intensity sweeteners as well as flavors.

SGIxy is a SGIx effluent or portion of an effluent from an upstream mixer plus at least one additional gum ingredient SGIy (but is not yet a FSGI). SGIxys may vary such that not all SGIxys are the same. When used in Table 4, a SGIxy is less than a finished set of gum ingredients. Further, a SGIxy may be the combination of the same ingredient added in two different mixers. For example, a SGIxy may be generated by adding a first portion of the bulk sweetener (SGIx) in an upstream mixer and then adding a second portion of the same exact bulk sweetener (SGIy) n a second mixer to form a SGIxy in the second mixer formed entirely of a single ingredient. Alternatively, a SGIxy of a first gum structure or process may be the combination of a bulk sweetener (SGIx) in an upstream mixer and the addition of an encapsulated sweetener (SGIy) in a downstream mixer.

SGIxyz is a SGIxy effluent or portion of an effluent from an upstream mixer plus at least one additional gum ingredient SGIz (but is not yet a FSGI). SGIxyzs may vary such that not all SGIxyzs are the same. When used in Table 4, a SGIxyz is less than a finished set of gum ingredients.

It should be noted that all of the ingredients of a GBIxy or a GBIxyz could include the ingredients of a GBIx of another mixing process. Further, in an individual given process example that includes mixing a GBIx, GBIy and/or GBIz, a portion of each of the sets of gum base ingredients could include some if not all of the same category of ingredients as the previously added set of gum base ingredients. For example, if elastomer is added in GBIx more of the same elastomer and/or an additional elastomer could be added in GBIy or GBIz. Additionally, in a given process a GBIx, GBIy and/or GBIz could be finished gum bases such that the process mixes individual finished gum bases together to form a new desired gum base such as in kitting as discussed previously.

Similarly, all of the ingredients of a SGIxy or SGIxyz could include the ingredients of a SGIx of another mixing process. Further, in an individual given process example that includes mixing a SGIx, SGIy and/or SGIz, a portion of each of the sets of subsequent gum ingredients could include some if not all of the same category of ingredients as the previously added set of subsequent gum ingredients. For example, if a bulk sweetener is added in SGIx more of the same bulk sweetener and/or an additional bulk sweetener could be added in SGIy or SGIz.

TABLE 4

| | Effluent of | Effluent of | Options For Output of Downstream |
|---|---|---|---|
| Example | Mixer 1 | Mixer 2 | Mixing |
| 1 | GBI^{x} | GBI^{xy} | GBI^{xyz}, FGB, GBI^{xy} + SGI^{x}, GBI^{xyz} + |
| | | | SGI^{x}, FGB + SGI^{x}, GBI^{xy} + FSGI, |
| | | | GBI^{xyz} + FSGI; FG |
| 2 | GBI^{x} | FGB | FGB + SGI^{x}, FG |
| 3 | GBI^{x} | GBI^{x} + SGI^{x} | GBI^{x} + SGI^{xy}, GBI^{xy} + SGI^{x}, GBI^{xy} + |
| | | | SGI^{xy}, GBI^{x} + FSGI, FGB + SGI^{x}, |
| | | | GBI^{xy} + FSGI, FGB + SGI^{xy}, FG |
| 4 | GBI^{x} | GBI^{xy} + SGI^{x} | GBI^{xyz} + SGI^{x}, GBI^{xy} + SGI^{xy}, GBI^{xyz} + |
| | | | SGI^{xy}, FGB + SGI^{x}, GBI^{xy} + FSGI, |
| | | | GBI^{xyz} + FSGI, FGB + SGI^{xy}, FG |
| 5 | GBI^{x} | GBI^{x} + FSGI | GBI^{xy} + FSGI, FG |
| 6 | GBI^{x} | GBI^{xy} + FSGI | GBI^{xyz} + FSGI, FG |
| 7 | GBI^{x} | FG | — |
| 8 | SGI^{x} | SGI^{xy} | SGI^{xyz}, FSGI, GBI^{x} + SGI^{xy}, GBI^{x} + |
| | | | SGI^{xyz}, GBI^{x} + FSGI, FGB + SGI^{xy}, |
| | | | FGB + SGI^{xyz}, FG |
| 9 | SGI^{x} | FSGI | GBI^{x} + FSGI, FG |
| 10 | SGI^{x} | GBI^{x} + SGI^{x} | GBI^{x} + SGI^{xy}, GBI^{xy} + SGI^{x}, GBI^{xy} + |
| | | | SGI^{xy}, GBI^{x} + FSGI, FGB + SGI^{x}, |
| | | | GBI^{xy} + FSGI, FGB + SGI^{xy}, FG |
| 11 | SGI^{x} | GBI^{x} + SGI^{xy} | GBI^{xy} + SGI^{xy}, GBI^{xy} + SGI^{xyz}, GBI^{x} + |
| | | | SGI^{xyz}, GBI^{x} + FSGI, GBI^{xy} + FSGI, |
| | | | FGB + SGI^{xy}, FGB + SGI^{xyz}, FG |
| 12 | SGI^{x} | FGB + SGI^{x} | FGB + SGI^{xy}, FG |
| 13 | SGI^{x} | FGB + SGI^{xy} | FGB + SGI^{xyz}, FG |
| 14 | SGI^{x} | FG | — |
| 15 | GBI^{x} + SGI^{x} | GBI^{xy} + SGI^{x} | GBI^{xyz} + SGI^{x}, GBI^{xy} + SGI^{xy}, GBI^{xyz} + |
| | | | SGI^{xy}, FGB + SGI^{x}, GBI^{xy} + FSGI, |
| | | | GBI^{xyz} + FSGI, FGB + SGI^{xy}, FG |
| 16 | GBI^{x} + SGI^{x} | FGB + SGI^{x} | FGB + SGI^{xy}, FG |
| 17 | GBI^{x} + SGI^{x} | GBI^{x} + SGI^{xy} | GBI^{xy} + SGI^{xy}, GBI^{x} + SGI^{xyz}, GBI^{xy} + |
| | | | SGI^{xyz}, GBI^{x} + FSGI, GBI^{xy} + FSGI, |
| | | | FGB + SGI^{xy}, FGB + SGI^{xyz}, FG |
| 18 | GBI^{x} + SGI^{x} | GBI^{x} + FSGI | GBI^{xy} + FSGI, FG |
| 19 | GBI^{x} + SGI^{x} | GBI^{xy} + SGI^{xy} | GBI^{xy} + FSGI, GBI^{xyz} + FSGI, FGB + |
| | | | SGI^{xy}, FGB + SGI^{xyz}, GBI^{xy} + SGI^{xyz}, |
| | | | GBI^{xyz} + SGI^{xy}, GBI^{xyz} + SGI^{xyz}, FG |
| 20 | GBI^{x} + SGI^{x} | FGB + SGI^{xy} | FGB + SGI^{xyz}, FG |
| 21 | GBI^{x} + SGI^{x} | GBI^{xy} + FSGI | GBI^{xyz} + FSGI, FG |
| 22 | GBI^{x} + SGI^{x} | FG | — |
| 23 | FGB | FGB + SGI^{x} | FGB + SGI^{xy}, FG |
| 24 | FGB | FG | — |
| 25 | FGB + SGI^{x} | FGB + SGI^{xy} | FGB + SGI^{xyz}, FG |
| 26 | FGB + SGI^{x} | FG | — |
| 27 | FSGI | GBI^{x} + FSGI | GBI^{xy} + FSGI, FG |
| 28 | FSGI | FG | — |
| 29 | GBI^{x} + FSGI | GBI^{xy} + FSGI | GBI^{xyz} + FSGI, FG |
| 30 | GBI^{x} + FSGI | FG | — |

The individual processes of Table 4 will now be discussed in relation to the potential outputs of individual mixers and the types of ingredients that are added to individual mixers during the process.

Processes 1-7 represent mixing processes where the effluent of mixer 1 is a set of gum base ingredients (GBI^{x}s) that does not yet form a gum base. For example, GBI^{x} of mixer 1 could be an elastomer in combination with one or more compounding aids such as a filler and/or an elastomer plasticizer.

In Process 1, the effluent of mixer 1 is added to mixer 2 as an ingredient and added to another set of gum base ingredients, namely GBIy, to form a set of gum base ingredients GBIxy, which is not yet a finished gum base. For example, GBIy could be an additional elastomer, more filler, or other GBI identified in Table 3. Numerous options exist for downstream mixing of effluent GBIxy of mixer 2. Another set of gum base ingredients GBIz, only, could be added to effluent GBIxy to form a gum structure that is either a finished gum base (FGB) or a set of gum base ingredients that does not yet form a FGB (GBIxyz). A first set of subsequent gum ingredients, SGIx, could be added to the effluent of mixer 2 to form a gum structure that is a combination of gum base ingredients plus subsequent gum ingredients that does not yet form a finished gum base (GBIxy+SGIx) or a finished set of subsequent gum ingredients (GBIxy+FSGI). Alternatively, another set of gum base ingredients GBIz and a set of subsequent gum ingredients (SGIx) could be added to effluent GBIxy to form a gum structure that is either a finished gum base plus some subsequent gum ingredients that do not form a finished set of subsequent gum ingredients (FGB+SGIx); a set of gum base ingredients and subsequent gum ingredients that is both less than a finished gum base and a finished set of subsequent gum ingredients (GBIxyz+SGIx); a set of gum base ingredients that is less than a finished gum base but includes a finished set of subsequent gum ingredients (GBIxyz+FSGI); or forms a finished gum product (FG) that includes both a finished gum base and a finished set of subsequent gum ingredients.

Process 2 is similar to Example 1 in that only gum base ingredients are added to effluent GBIx of mixer 1. However, in this embodiment, the additional gum base ingredients add to effluent GBIx in mixer 2 are sufficient to form a finished gum base (FGB). As the effluent FGB of mixer 2 includes all of the gum base ingredients necessary for the contemplated gum structure, no more gum base ingredients will typically be added in downstream mixing. Thus, potential options for downstream mixing are limited to adding a set of subsequent gum ingredients SGIx. The set of subsequent gum ingredients SGIx may be a finished set of subsequent gum ingredients FSGI such that the effluent of continuous mixer is a finished gum composition (FG). Alternatively, the set of subsequent gum ingredients SGIx may be less than a finished set of subsequent gum ingredients such that the effluent of the down stream mixing is a finished gum base in combination with some subsequent gum ingredients that is not yet a finished gum composition (FGB+SGIx). This second option would be subjected to further processing by a secondary system. This could occur such as when kitting occurs and the final ingredient set that may be added may be some bulking agents such as bulk sweeteners at a local plant.

Process 3 adds a set of subsequent gum ingredients SGIx that is not yet a finished set of subsequent gum ingredients (FSGI) to the effluent GBIx of mixer 1 to form effluent GBIx+SGIx of mixer 2. Numerous downstream mixing options occur for effluent GBIx+SGIx of mixer 2. An additional set of gum base ingredients GBIy, only, may be added to form a combination of gum base ingredients plus subsequent gum ingredients that does not yet form a finished gum base, but is closer to a FGB, or a finished set of subsequent gum ingredients (GBIxy+SGIx) or a finished gum base plus a set a subsequent gum ingredients that does not yet form a finished set of subsequent gum ingredients (FGB+SGIx). Alternatively, an additional set of subsequent gum ingredients SGIy, only, may be added to form a combination of gum base ingredients plus subsequent gum ingredients that does not yet form a finished gum base or a finished set of subsequent gum ingredients, but is closer to a FSGI, (GBIx+SGIxy) or a finished set of subsequent gum ingredients plus a set a gum base ingredients that does not yet form a finished gum base (GBIx+FSGI). Alternatively, another set of gum base ingredients GBIy and another set of subsequent gum ingredients SGIy could be added to effluent GBIx+SGIx to form either a gum structure that is of a set of gum base ingredients and subsequent gum ingredients that is less than either a FGB or FSGI, but is closer to a FGB and FSGI, (GBIxy+SGIxy); a gum structure that includes a finished gum base plus a set of subsequent gum ingredients that is less than a FSGI (FGB+SGIxy); a gum structure that is less than a gum base plus a finished set of subsequent gum ingredients (GBIxy+FSGI); or a finished gum composition (FG).

Process 4 adds an additional set of gum base ingredients GBIy and a set of subsequent gum ingredients SGIx to effluent GBIx of mixer 1. However, the gum structure effluent GBIxy+SGIx of mixer 2 is less than a FGB or a FSGI. Numerous downstream mixing options occur for effluent GBIxy+SGIx of mixer 2. An additional set of gum base ingredients GBIz, only, may be added to form a combination of gum base ingredients plus subsequent gum ingredients that does not yet form a finished gum base (GBIxyz+SGIx); or a finished gum base plus a set a subsequent gum ingredients that does not yet form a finished set of subsequent gum ingredients (FGB+SGIx). Alternatively, an additional set of subsequent gum ingredients SGIy, only, may be added to form a combination of gum base ingredients plus subsequent gum ingredients that does not yet form a finished gum base or a finished set of subsequent gum ingredients (GBIxy+SGIxy); or a finished set of subsequent gum ingredients plus a set a gum base ingredients that does not yet form a finished gum base (GBIxy+FSGI). Alternatively, another set of gum base ingredients GBIz and another set of subsequent gum ingredients SGIy could be added to effluent GBIxy+SGIx to form either a gum structure that is of a set of gum base ingredients and subsequent gum ingredients that is less than either a FGB or FSGI (GBIxyz+SGIxy); a gum structure that includes a finished gum base plus a set of subsequent gum ingredients that is less than a FSGI (FGB+SGIxy); a gum structure that is less than a gum base plus a finished set of subsequent gum ingredients (GBIxyz+FSGI); or a finished gum composition (FG).

Process 5 adds a set of subsequent gum ingredients SGIx to mixer 2 that is a finished set of subsequent gum ingredients to effluent GBIx of mixer 1. The subsequent gum ingredients added to effluent GBIx in mixer 2 are sufficient to form a finished set of subsequent gum ingredients. As effluent GBIx+FSGI of mixer 2 includes all of the subsequent gum ingredients necessary for a contemplated gum structure, no more subsequent gum ingredients will typically be added in downstream mixing. Thus, potential options for downstream mixing are limited to adding a set of gum base ingredients GBIy. The set of gum base ingredients GBIy may finish the set of gum base ingredients such that the effluent of continuous mixer is a finished gum composition (FG). Alternatively, the set of gum base ingredients GBIy may be less than a finished gum base such that the effluent of downstream mixing is a finished set of subsequent gum ingredients in combination with some gum base ingredients that are not yet a finished gum base (GBIxy+FSGI).

Process 6 adds an additional set of gum base ingredients GBIy and a set of subsequent gum ingredients SGIx to mixer 2 that is a finished set of subsequent gum ingredients to effluent GBIx of mixer 1. The set of gum base ingredients GBIy add to effluent GBIx in mixer 2 is not sufficient to form a finished gum base. However, as effluent GBIxy+FSGI of mixer 2 includes all of the subsequent gum ingredients necessary for a contemplated gum structure, no more subsequent gum ingredients will typically be added in downstream mixing. Thus, potential options for downstream mixing are limited to adding a set of gum base ingredients GBIz. The set of gum base ingredients GBIz may finish the set of gum base ingredients such that the effluent of continuous mixer is a finished gum composition (FG). Alternatively, the set of gum base ingredients GBIz in combination with the previously added gum base ingredients GBIxy may be less than a finished gum base such that the effluent of downstream mixing is a finished set of subsequent gum ingredients in combination with some gum base ingredients that are not yet a finished gum base (GBIxyz+FSGI).

Process 7 adds an additional set of gum base ingredients GBIy and a set of subsequent gum ingredients SGIx to effluent GBIx of continuous mixer 502. The additional set of gum base ingredients GBIy is sufficient to form finished gum base and the set of subsequent gum ingredients SGIx is sufficient to form a finished set of subsequent gum ingredients. As such, the effluent of continuous mixer 504 is a finished gum composition (FG). No further gum base or subsequent gum ingredients are typically added to the effluent of continuous mixer 504 and thus only two mixers are required for this embodiment.

Process 8-14 represent mixing processes where the effluent of mixer 1, such as mixer 102, 502 of mixing system 100, 500, is a set of subsequent gum ingredients (SGIxs) that does not yet form a finished set of subsequent gum ingredients (FSGI).

In Process 8, the effluent of mixer 1 is added to mixer 2 as an ingredient and added to another set of subsequent gum ingredients, namely SGIy, to form a set of subsequent gum ingredients SGIxy, which is not yet a finished set of subsequent gum ingredients. Numerous options exist for downstream mixing of effluent SGIxy of mixer 2. Another set of subsequent gum ingredients SGIz, only, could be added to effluent SGIxy to form a gum structure that is either a finished set of subsequent gum ingredients (FSGI) or a set of subsequent gum ingredients that does not yet form a finished set of subsequent gum ingredients (SGIxyz). A set of gum base ingredients GBIx could be added to the effluent of mixer 2 to form a gum structure that is a combination of gum base ingredients plus subsequent gum ingredients that does not yet form a FGB or FSGI (GBIx+SGIxy) or a finished gum base plus a set of subsequent gum ingredients that does not yet form a FSGI (FGB+SGIxy). Alternatively, another set of subsequent gum ingredients SGIz and a set of gum base ingredients GBIx could be added to effluent SGIxy to form a gum structure that is either a finished gum base plus some subsequent gum ingredients that do not form a finished set of subsequent gum ingredients (FGB+SGIxyz); a set of gum base ingredients and subsequent gum ingredients that is both less than a finished gum base and a finished set of subsequent gum ingredients (GBIx+SGIxyz); a set of gum base ingredients that is less than a finished gum base but includes a finished set of subsequent gum ingredients (GBIxyz+FSGI); or a finished gum product (FG) that includes both a finished gum base and a finished set of subsequent gum ingredients.

In processes where subsequent gum ingredients are added upstream of gum base ingredients that require compounding, it may be beneficial to add the subsequent gum ingredient effluent of an upstream mixer downstream of some of the compounded gum base ingredients. For example and with reference to FIG. 1 and example 8 above, the effluent of continuous mixer 104 is an SGIxy and therefore is complete subsequent gum ingredients. In downstream mixing where a gum base ingredient GBIx is added to continuous mixer 106, this SGIxy may be added to continuous mixer 106 at feed port 164 and the gum base ingredients GBIx may be added at an upstream feed port such as feed port 162. The gum base ingredients can be compounded and then exposed to a cooling device or process prior to being mixed with the SGIxy. This may allow the subsequent gum ingredients SGIxy to be shielded from the high heat and shear that occurs during compounding an elastomer.

Process 9 is similar to Example 8 in that only subsequent gum ingredients are added to effluent SGIx of mixer 1. However, in this embodiment, the additional set of subsequent gum ingredients add to effluent SGIx in mixer 2 is sufficient to form a finished set of subsequent gum ingredients (FSGI). As the effluent FSGI of mixer 2 includes all of the subsequent gum ingredients necessary for the contemplated gum structure, no more subsequent gum ingredients will typically be added in downstream mixing. Thus, potential options for downstream mixing are limited to adding a set of gum base ingredients GBIx. The set of gum base ingredients GBIx may be a finished gum base FGB such that the effluent of continuous mixer is a finished gum composition (FG). Alternatively, the set of gum base ingredients GBIx may be less than a finished gum base such that the effluent of downstream mixing is a finished set of subsequent gum ingredients in combination with at least one gum base ingredient that is not yet a FGB (GBIx+FSGI). This second option would be subjected to further processing by a secondary system. This could occur such as when kitting occurs and the final ingredient set that may be added may be some bulking agents such as additional filler or if additional plasticizers are needed.

Process 10 adds a set of gum base ingredients GBIx that is not yet a finished gum base (FGB) to the effluent SGIx of mixer 1 to form effluent GBIx+SGIx of mixer 2. The downstream mixing options for this example are identical as the downstream mixing options for Process 3.

Process 11 adds an additional set of subsequent gum ingredients SGIy and a set of gum base ingredients GBIx to effluent SGIx of mixer 1. However, the gum structure effluent GBIx+SGIxy of mixer 2 is less than a FGB or a FSGI. Numerous downstream mixing options occur for effluent GBIx+SGIxy of mixer 2. An additional set of gum base ingredients GBIy, only, may be added to form a combination of gum base ingredients plus subsequent gum ingredients that does not yet form a finished gum base (GBIxy+SGIxy); or a finished gum base plus a set a subsequent gum ingredients that does not yet form a finished set of subsequent gum ingredients (FGB+SGIxy). Alternatively, an additional set of subsequent gum ingredients SGIz, only, may be added to form a combination of gum base ingredients plus subsequent gum ingredients that does not yet form a finished gum base or a finished set of subsequent gum ingredients (GBIx+SGIxyz); or a finished set of subsequent gum ingredients plus a set a gum base ingredients that does not yet form a finished gum base (GBIxy+FSGI). Alternatively, another set of gum base ingredients GBIy and another set of subsequent gum ingredients SGIz could be added to effluent GBIx+SGIxy to form either a gum structure that is a set of gum base ingredients and subsequent gum ingredients that is less than either a FGB or FSGI (GBIxy+SGIxyz); a gum structure that includes a finished gum base plus a set of subsequent gum ingredients that is less than a FSGI (FGB+SGIxyz); a gum structure that is less than a gum base plus a finished set of subsequent gum ingredients (GBIxy+FSGI); or a finished gum composition (FG).

Process 12 adds a set of gum base ingredients GBIx to mixer 2 that is a finished gum base to effluent SGIx of mixer 1. As effluent FGB+SGIx of mixer 2 includes a finished gum base, no more gum base ingredients will typically be added in downstream mixing. Thus, potential options for downstream mixing are limited to adding a set of subsequent gum ingredients SGIy. The set of subsequent gum ingredients SGIy may finish the set of subsequent gum ingredients such that the effluent of continuous mixer is a finished gum composition (FG). Alternatively, the set of subsequent gum ingredients SGIy in combination with the previously added subsequent gum ingredients may not form a finished set of subsequent gum ingredients such that the effluent of downstream mixing is a finished gum base in combination with less than a finished set of subsequent gum ingredients (FGB+SGIxy).

Process 13 adds an additional set of subsequent gum ingredients SGIy and a set of gum base ingredients GBIx to mixer 2 that is a finished gum base to effluent SGIx of mixer 1. As effluent FGB+SGIxy of mixer 2 includes a finished gum base, no more gum base ingredients will typically be added in downstream mixing. Thus, potential options for downstream mixing are limited to adding a set of subsequent gum ingredients SGIz. The set of subsequent gum ingredients SGIz in combination with subsequent gum ingredients SGIxy may finish the set of subsequent gum ingredients such that the effluent of continuous mixer is a finished gum composition (FG). Alternatively, the set of subsequent gum ingredients SGIz in combination with the previously added subsequent gum ingredients SGIxy may not form a finished set of subsequent gum ingredients such that the effluent of downstream mixing is a finished gum base in combination with less than a finished set of subsequent gum ingredients (FGB+SGIxyz).

Process 14 adds a set of gum base ingredients GBIx and an additional set of subsequent gum ingredients SGIy to effluent SGIx of continuous mixer 502. The set of gum base ingredients GBIx is sufficient to form a finished gum base and the additional set of subsequent gum ingredients SGIy is sufficient to form a finished set of subsequent gum ingredients. As such, the effluent of continuous mixer 504 is a finished gum composition (FG). No further gum base or subsequent gum ingredients are typically added to the effluent of continuous mixer 504 and thus only two mixers are required for this embodiment.

Process 15-22 represent mixing processes where the effluent of mixer 1, such as mixer 102, 502 of mixing system 100, 500, respectively, is a set of gum base ingredients (GBIx) that is less than a finished gum base in combination with set of subsequent gum ingredients (SGIx) that does not yet form a finished set of subsequent gum ingredients (GBIx+SGIx). If the gum base ingredients are not yet compounded elastomer when added to mixer 1, the gum base ingredients will typically be added prior to the subsequent gum ingredients such that the gum base ingredients can be subjected to some cooling prior to adding any subsequent gum ingredients. However, if the subsequent gum ingredients that are being added are not subject to degradation when exposed to high temperatures, such an order of addition to mixer 1 would not be necessary.

In Process 15, effluent GBIx+SGIx of mixer 1 is added to mixer 2 as an ingredient and added to another set of gum base ingredients, namely GBTy, to form a set of gum base ingredients GBIxy+SGIx, which is not yet a finished gum base or a finished set of subsequent gum ingredients. Numerous options exist for downstream mixing of effluent GBIxy+SGIx of mixer 2. Another set of gum base ingredients GBIz, only, could be added to form a gum structure that is either a finished gum base plus a set of subsequent gum ingredients that is less than a finished set of subsequent gum ingredients (FGB+SGIx) or a set of gum base ingredients that does not yet form a FGB in combination with a set of subsequent gum ingredients that is less than a finished set of subsequent gum ingredients (GBIxyz+SGIx). Another set of subsequent gum ingredients SGIy, only, could be added to the effluent of mixer 2 to form a gum structure that is a combination of gum base ingredients plus subsequent gum ingredients that does not yet form a finished gum base (GBIxy+SGIxy) or a finished set of subsequent gum ingredients (GBIxy+FSGI). Alternatively, another set of gum base ingredients GBIz and a set of subsequent gum ingredients (SGIy) could be added to effluent GBIxy+SGIx to form a gum structure that is either a finished gum base plus some subsequent gum ingredients that do not form a finished set of subsequent gum ingredients (FGB+SGIxy); a set of gum base ingredients and subsequent gum ingredients that is both less than a finished gum base and a finished set of subsequent gum ingredients (GBIxyz+SGIxy); a set of gum base ingredients that is less than a finished gum base but includes a finished set of subsequent gum ingredients (GBIxyz+FSGI); or forms a finished gum product (FG) that includes both a finished gum base and a finished set of subsequent gum ingredients.

Process 16 adds an additional set of gum base ingredients GBIy to effluent GBIx+SGIx of mixer 1. In this embodiment, the additional set of gum base ingredients added to effluent GBIx+SGIx in mixer 2 is sufficient to form a finished gum base. As the effluent of mixer 2 includes all of the gum base ingredients necessary for the contemplated gum structure, no more gum base ingredients will typically be added in downstream mixing. Thus, potential options for downstream mixing are limited to adding an additional set of subsequent gum ingredients SGIy. The set of subsequent gum ingredients SGIy may be sufficient to form a finished set of subsequent gum ingredients FSGI such that the effluent of downstream mixing is a finished gum composition (FG). Alternatively, the set of subsequent gum ingredients SGIy in combination with the previously added set of subsequent gum ingredients may be insufficient to form a finished set of subsequent gum ingredients such that the effluent of downstream mixing is a finished gum base in combination with some subsequent gum ingredients that is not yet a finished gum composition (FGB+SGIxy).

In Process 17, effluent GBIx+SGIx of mixer 1 is added to mixer 2 as an ingredient and added to another set of subsequent gum ingredients, namely SGIy, to form a set of gum base ingredients GBIx+SGIxy, which is not yet a finished gum base or a finished set of subsequent gum ingredients. Numerous options exist for downstream mixing of effluent GBIx+SGIxy of mixer 2. Another set of gum base ingredients GBIy, only, could be added to form a gum structure that is either a finished gum base plus a set of subsequent gum ingredients that is less than a finished set of subsequent gum ingredients (FGB+SGIxy) or a set of gum base ingredients that does not yet form a FGB in combination with a set of subsequent gum ingredients that is less than a finished set of subsequent gum ingredients (GBIxy+SGIxy). Another set of subsequent gum ingredients SGIz, only, could be added to the effluent of mixer 2 to form a gum structure that is a combination of gum base ingredients plus subsequent gum ingredients that does not yet form a finished gum base (GBIx+SGIxyz) or a finished set of subsequent gum ingredients (GBIx+FSGI). Alternatively, another set of gum base ingredients GBIy and a set of subsequent gum ingredients (SGIZ) could be added to effluent GBIx+SGIxy to form a gum structure that is either a finished gum base plus some subsequent gum ingredients that do not form a finished set of subsequent gum ingredients (FGB+SGIxyz); a set of gum base ingredients and subsequent gum ingredients that is both less than a finished gum base and a finished set of subsequent gum ingredients (GBIxy+SGIxyz); a set of gum base ingredients that is less than a finished gum base but includes a finished set of subsequent gum ingredients (GBIxy+FSGI); or forms a finished gum product (FG) that includes both a finished gum base and a finished set of subsequent gum ingredients.

Process 18 adds an additional set of subsequent gum ingredients SGIy to effluent GBIx+SGIx of mixer 1. In this embodiment, the additional set of subsequent gum ingredients SGIy added to effluent GBIx+SGIx in mixer 2 is sufficient to form a finished set of subsequent gum ingredients. As the effluent of mixer 2 includes all of the subsequent gum ingredients necessary for the contemplated gum structure, no more subsequent gum ingredients will typically be added in downstream mixing. Thus, potential options for downstream mixing in are limited to adding an additional set of gum base ingredients GBIy. The set of gum base ingredients GBIy may be sufficient to form a finished gum base such that the effluent of downstream mixing is a finished gum composition (FG). Alternatively, the set of gum base ingredients GBIy in combination with the previously added set of subsequent gum ingredients may be insufficient to form a finished gum base such that the effluent of downstream mixing is a finished set of subsequent gum ingredients in combination with some gum base ingredients that do not yet form a finished gum base (GBIxy+FSGI).

Process 19 adds an additional set of gum base ingredients GBIy and an additional set of subsequent gum ingredients SGIy to effluent GBIx+SGIx of mixer 1 during mixing in mixer 2. However, the gum structure effluent GBIxy+SGIxy of mixer 2 is less than a FGB or a FSGI. Numerous downstream mixing options occur for effluent GBIxy+SGIxy of mixer 2. An additional set of gum base ingredients GBIz, only, may be added to form a combination of gum base ingredients plus subsequent gum ingredients that does not yet form a finished gum base (GBIxyz+SGIxy); or a finished gum base plus a set a subsequent gum ingredients that does not yet form a finished set of subsequent gum ingredients (FGB+SGIxy). Alternatively, an additional set of subsequent gum ingredients SGIz, only, may be added to form a combination of gum base ingredients plus subsequent gum ingredients that does not yet form a finished gum base or a finished set of subsequent gum ingredients (GBIxy+SGIxyz); or a finished set of subsequent gum ingredients plus a set a gum base ingredients that does not yet form a finished gum base (GBIxy+FSGI). Alternatively, another set of gum base ingredients GBIz and another set of subsequent gum ingredients SGIz could be added to effluent GBIxy+SGIxy to form either a gum structure that is of a set of gum base ingredients and subsequent gum ingredients that is less than either a FGB or FSGI (GBIxyz+SGIxyz); a gum structure that includes a finished gum base plus a set of subsequent gum ingredients that is less than a FSGI (FGB+SGIxyz); a gum structure that is less than a gum base plus a finished set of subsequent gum ingredients (GBIxyz+FSGI); or a finished gum composition (FG).

Process 20 adds an additional set of gum base ingredients GBIy and an additional set of subsequent gum ingredients SGIy to effluent GBIx+SGIx of mixer 1 during mixing in mixer 2. However, in this example, the additional set of gum base ingredients GBIy is sufficient to form a finished gum base. As such, the effluent of mixer 2 is a finished gum base in combination with a set of subsequent gum ingredients that does not form a finished set of subsequent gum ingredients (FGB+SGIxy). The downstream mixing options for this example are the same as for Example 13.

Process 21 adds an additional set of gum base ingredients GBIy and an additional set of subsequent gum ingredients SGIy to effluent GBIx+SGIx of mixer 1 during mixing in mixer 2. However, in this example, the additional set of subsequent gum ingredients SGIy is sufficient to form a finished set of subsequent gum ingredients. As such, the effluent of mixer 2 is a set gum base ingredients that does not form a finished gum base in combination with a finished set of subsequent gum ingredients (GBIxy+FSGI). The downstream mixing options for this example are the same as for Process 6.

Process 22 adds an additional set of gum base ingredients GBIy and an additional set of subsequent gum ingredients SGIy to effluent GBIx+SGIx of continuous mixer 502 during mixing in continuous mixer 504. It will be seen that only two mixers are needed for this example. In this example, the additional set of gum base ingredients GBIy and additional set of subsequent gum ingredients SGIy are sufficient to form, respectively, a finished gum base and a finished set of subsequent gum ingredients. As such, the effluent of continuous mixer 504 is a finished gum composition (FG). No further gum base or subsequent gum ingredients are typically added to the effluent of continuous mixer 504 and thus only two mixers are required for this embodiment.

In Process 23, the effluent of mixer 1 is a finished gum base. As the effluent FGB of mixer 1 includes all of the gum base ingredients necessary for the contemplated gum structure, no more gum base ingredients will typically be added in subsequent downstream mixing. Thus, in this example a first set of subsequent gum ingredients SGIx is added to effluent FGB of mixer 102 such that the effluent of mixer 104 is a finished gum base in combination with a set of subsequent gum ingredients that is not a finished set of subsequent gum ingredients (FGB+SGIx). The downstream mixing options are limited, again, to adding an additional set of subsequent gum ingredients SGIy. This additional set of subsequent gum ingredients may be sufficient to form a finished set of subsequent gum ingredients such that the effluent of mixer 2 is a finished gum composition (FG). Alternatively, the additional set of subsequent gum ingredients may not be sufficient to form a finished set of subsequent gum ingredients such that the effluent of downstream mixing is a finished gum base in combination with a set of subsequent gum ingredients that is less than a finished set of subsequent gum ingredients (FGB+SGIxy).

In Process 24, the effluent of continuous mixer 502 is a finished gum base. As the effluent FGB of continuous mixer 502 includes all of the gum base ingredients necessary for the contemplated finished gum base, no more gum base ingredients will typically be added in subsequent downstream mixing. In this example, a set of subsequent gum ingredients is added to the effluent of continuous mixer 502 that is a finished set of subsequent gum ingredients such that the effluent of continuous mixer 504 is a finished gum composition (FG).

In Process 25, the effluent of mixer 1 is a finished gum base plus a set of subsequent gum ingredients SGIx that is less than a finished set of subsequent gum ingredients. As the effluent of mixer 1 includes all of the gum base ingredients necessary for the contemplated gum structure, no more gum base ingredients will typically be added in subsequent downstream mixing. Thus, in this example a second set of subsequent gum ingredients SGIy is added to effluent of mixer 102 such that the effluent of mixer 104 is a finished gum base in combination with a set of subsequent gum ingredients that is not a finished set of subsequent gum ingredients (FGB+SGIxy). The downstream mixing options are limited, again, to adding an additional set of subsequent gum ingredients SGIz. This additional set of subsequent gum ingredients may be sufficient to form a finished set of subsequent gum ingredients such that the effluent of downstream mixing is a finished gum composition (FG). Alternatively, the additional set of subsequent gum ingredients may not be sufficient to form a finished set of subsequent gum ingredients such that the effluent of downstream mixing is a finished gum base in combination with a set of subsequent gum ingredients that is less than a finished set of subsequent gum ingredients (FGB+SGIxyz).

In Process 26, the effluent of continuous mixer 502 is a finished gum base plus a set of subsequent gum ingredients SGIx that is less than a finished set of subsequent gum ingredients (FGB+SGIx). As the effluent FGB+SGIx of continuous mixer 502 includes all of the gum base ingredients necessary for the contemplated finished gum base, no more gum base ingredients will typically be added in subsequent downstream mixing. In this example, a set of subsequent gum ingredients is added to the effluent of continuous mixer 502 that forms a finished set of subsequent gum ingredients with the previously added set of subsequent gum ingredients such that the effluent of continuous mixer 504 is a finished gum composition (FG) that does not require any additional downstream mixing.

In Process 27, the effluent of mixer 1 is a finished set of subsequent gum ingredients. As the effluent FSGI of mixer 1 includes all of the subsequent gum ingredients necessary for the contemplated gum structure, no more subsequent gum ingredients will typically be added in subsequent downstream mixing. Thus, in this example a first set of gum base ingredients GBIx is added to effluent FSGI of mixer 102 such that the effluent of mixer 104 is a finished set of subsequent gum ingredients in combination with a set of gum base ingredients that does not form a finished gum base (GBIx+FSGI). The downstream mixing options are limited, again, to adding an additional set of gum base ingredients GBIy. This additional set of gum base ingredients GBIy may be sufficient to form a finished gum base such that the effluent of mixer 2 is a finished gum composition (FG). Alternatively, the additional set of gum base ingredients GBIy may not be sufficient to form a finished gum base such that the effluent of downstream mixing is a finished set of subsequent gum ingredients base in combination with a set of gum base ingredients that is less than a finished gum base (GBIxy+FSGI).

In Process 28, the effluent of continuous mixer 502 is a finished set of subsequent gum ingredients. As the effluent FSGI of continuous mixer 502 includes all of the subsequent gum ingredients necessary for the contemplated finished gum composition, no more subsequent gum ingredients will typically be added in subsequent downstream mixing. In this example, a set of gum base ingredients GBIx is added to the effluent of continuous mixer 502 that is a finished gum base such that the effluent of continuous mixer 504 is a finished gum composition (FG).

In Process 29, the effluent of mixer 1 is a finished set of subsequent gum ingredients plus a set of gum base ingredients GBIx that is less than a finished gum base (GBIx+FSGI). As the effluent of mixer 1 includes all of the subsequent gum ingredients necessary for the contemplated gum structure, no more subsequent gum ingredients will typically be added in subsequent downstream mixing. Thus, in this example a second set of gum base ingredients GBIy is added to the effluent of mixer 102 such that the effluent of mixer 104 is a finished set of subsequent gum ingredients but still does not include a finished gum base (GBIxy+FSGI). The downstream mixing options are limited, again, to adding an additional set of gum base ingredients GBIz. This additional set of gum base ingredients may be sufficient to form a finished gum base such that the effluent of downstream mixing is a finished gum composition (FG). Alternatively, the additional set of gum base ingredients GBIz may not be sufficient to form a finished gum base such that the effluent of downstream mixing is a finished set of subsequent gum ingredients in combination with a set of gum base ingredients that is less than a finished set of subsequent gum ingredients (GBIxyz+FSGI).

In Process 30, the effluent of continuous mixer 502 is a finished set of subsequent gum ingredients plus a set of gum base ingredients GBIx that is less than a finished gum base (GBIx+FSGI). As the effluent GBIx+FSGI of continuous mixer 502 includes all of the subsequent gum ingredients necessary for the contemplated finished gum structure, no more subsequent gum ingredients will typically be added in subsequent downstream mixing. In this example, an additional set of gum base ingredients GBIy is added to the effluent of continuous mixer 502 that forms a finished gum base in combination with the previously added set of gum base ingredients such that the effluent of continuous mixer 504 is a finished gum composition (FG) that does not require any additional downstream mixing.

### SPECIFIC EXAMPLES BASED ON GUM STRUCTURES OF TABLE 3 AND PROCESSES OF TABLE 4

Now that a general conceptual map of mixing processes that can be used with the mixing systems 100-1200 of the present invention, several more specific examples will be described. These examples will use the mixing process examples of Table 4 and the finished gum structures of Table 3. These more specific examples will focus on individual ones of the mixing systems. However, while individual examples described below are discussed with reference to an individual mixing system, one of ordinary skill in the art will recognize that the examples can be extended to other appropriate ones of the various mixing systems, particularly as described previously.

### SPECIFIC EXAMPLE 1

A first contemplated example that will be described will focus on the formation of the finished gum structure of Example 7 of Table 3 using mixing system 300 of FIG. 3 and Process 16 of Table 4.

In this example, mixer 1 takes the form of a continuous mixer 302 in the form of an extruder having a high shear section with high shear extruder elements suitable for dispersive mixing followed by a low shear section with lower shear elements suitable for distributive mixing. The high shear elements may be generally provided between feed ports 321 and 323 while the lower shear mixing elements may be provided between feed ports 324 and 326. While not illustrated, in this example, the high shear section and low shear section can be separated by a chiller portion, such as between feed port 323 and feed port 324.

In mixer 1 (continuous mixer 302), a first set of gum base ingredients GBIx are added. The finished gum base (FGB) of the desired finished gum (FG) is approximately 25% by weight of the FG.

This set of gum base ingredients GBIx includes the following gum base ingredients. A high molecular weight elastomer in the form of butyl rubber is added at a rate of 5% by weight of the desired FGB along with a low molecular weight elastomer in the form of polyisobutylene at a rate of 10% by weight of the desired FGB to mixer 302 at feed port 321. A filler in the form of calcium carbonate is added at a rate of 10% by weight of the desired FGB at feed port 321. In addition, elastomer plasticizers in the form of rosin esters at the rate of 10% by weight of the desired FGB are added at feed port 323. These gum base ingredients of GBIx are used to form an effluent of mixer 1 that includes a compounded elastomer gum structure and are thus subjected to the high shear mixing at a temperature of approximately 325° F. However, as evident from the terminology at this point and gum base Example 2 of Table 2, GBIx is not yet a finished gum base (FGB) for the contemplated finished gum composition of Example 7.

Thereafter, the mixture is to undergo a temperature drop in mixer 1 via a chiller proximate feed ports 323 and 324 to cool the mixture to a temperature of between about 160° F. to 210° F. With the temperature reduced, a set of subsequent gum ingredients SGIx is added. The set of subsequent gum ingredients includes bulk sweeteners in the form of maltitol at a rate of 10% by weight of the C; xylitol at a rate of 10% by weight of the of the desired FG, and sorbitol at a rate of 30% by weight of the FG. The combination of gum base ingredients (GBIx) and subsequent gum ingredients (SGIx) is then expelled from continuous mixer 302.

It can be seen from the terminology and the listing of ingredients in Tables 2-4 that the effluent of mixer 1 is only a partial gum base in combination with a set of subsequent gum ingredients that is not yet a finished set of gum ingredients (i.e. a GBIx+SGIx).

Effluent GBIx+SGIx of continuous mixer 302 is then added to one or more mixer 2's in the form of a lower shear batch mixer(s) 304 in the form of a kettle mixer. Effluent GBIx+SGIx is preferably added to batch mixer in a substantially liquid form with the kettle preheated to approximately 180-190° F.

In the mixer 2, more gum base ingredients GBIy are added. More particularly, the additional gum base ingredients of GBIy include the following ingredients. An additional elastomer in the form of polyvinyl acetate at the rate of 25% by weight of the desired FGB is added. Also, plasticizers/emulsifiers in the form of lecithin, triacetin, and glycerol monosterate are added at a rate of 8% by weight of the desired FGB. Further, waxes at a rate of 12% by weight and oils in the form of vegetable oils at the rate of 20% by weight of the desired FGB are added to mixer 2. Mixing of the ingredients in mixer 2 occurs for approximately 30 minutes. The final temperature should range from 160° F. to 210° F. As evidenced by Example 2 of Table 2, the gum structure effluent of batch mixer 304 (i.e. mixer 2) is a finished gum base (FGB) in combination with some subsequent gum ingredients (SGIx) but is not yet a finished gum composition as the effluent does not include all of the subsequent gum ingredients necessary for the contemplated finished gum composition of Example 7 of Table 3. Thus, with reference to Process 16 of Table 4, the effluent of batch mixer 304 is a FGB+SGIx.

To complete the gum structure, an additional set of subsequent gum ingredients SGIy sufficient to form a finished set of gum ingredients are added in a third mixer to the effluent of batch mixer 304 to form a finished gum composition. The third mixer, which performs downstream mixing in Table 4, is in the form of continuous mixer 306. Continuous mixer 306 is a low shear extruder. The set of subsequent gum ingredients SGIy includes the following ingredients. Sweeteners in the form of erythritol added at a rate of 10% by weight of the desired FG, hydrogenated starch hydrolysates at a rate of 5% by weight of the desired FG are added. Fluids in the form of glycerin are added at a rate of 3% by weight of the desired FG. The desired flavor is added at a rate of 1% by weight of the desired FG. Additional emulsifier such as in the form of lecithin is added at a rate of 1% by weight of the FG. Also, high intensity flavors in the form of sucralose is added at a rate of 2% by weight of the FG. An amount of acid that complements the flavor is addedat a rate of 2.8% by weight of the FG. Finally, the desired color is added at a rate of 0.2% by weight of the FG. The subsequent gum ingredients of SGIy are added at low temperatures such as approximately 90° F. to prevent degradation to the ingredients.

As can be seen from Example 7 of Table 3, all of the gum structure ingredients have now been added. Thus, the effluent of continuous mixer 306 (the downstream mixing mixer) is a finished gum structure (FG).

### SPECIFIC EXAMPLE 2

A second contemplated example that will be described will focus on the formation of the finished gum structure of Example 10 of Table 3 using the mixing system of FIG. 5 and Process 26 of Table 4. In this example, mixer 1 takes the form of continuous mixer 502 in the form of an extruder having a high shear section with high shear extruder elements suitable for dispersive mixing followed by a low shear section with lower shear elements suitable for distributive mixing. The high shear elements may be generally provided between feed ports 521 and 523. The lower shear mixing elements may be provided between feed ports 524 and 526. While not illustrated, in this example, the high shear section and low shear section can be separated by a chiller portion, such as between feed port 523 and feed port 524.

In mixer 1 (continuous mixer 502), a set of gum base ingredients GBIx are added that are sufficient to form a finished gum base (FGB). The FGB of the desired FG for this example forms approximately 30% by weight of the FG.

Thus, all of the gum base ingredients of gum base Example 5 are added to mixer 1. These gum base ingredients include a high molecular weight elastomer in the form of butyl rubber added at a rate of 5% by weight of the desired FGB along with a low molecular weight elastomer in the form of polyisobutylene at a rate of 15% by weight of the desired FGB added to mixer 502 at feed port 521. A filler in the form of talc is added at a rate of 15% by weight of the desired FGB also added at feed port 521. Elastomer plasticizers in the form of rosin esters at the rate of 10% by weight of the desired FGB are added at feed port 523. These gum base ingredients of GBIx are used to form a compounded elastomer gum structure and are thus subjected to the high shear mixing at a temperature of approximately 325° F. Further added to the mixture of mixer 1 in one or more of feed ports 524-526 are an additional elastomer in the form of polyvinyl acetate at the rate of 25% by weight of the desired FGB. Also, plasticizers/emulsifiers in the form of lecithin, triacetin, and glycerol monosterate are added at a rate of 5% by weight of the desired FGB. Waxes at a rate of 5% by weight of the desired FGB and oils in the form of vegetable oils at the rate of 20% by weight of the desired FGB are added to mixer 1.

As mixer 1 employs a chiller to cool the mixture, with the temperature reduced, a set of subsequent gum ingredients SGIx is added to mixer 1. Subsequent gum ingredients, which include bulk sweeteners in the form of maltitol at a rate of 30% by weight of the desired FG; xylitol at a rate of 10% by weight of the desired FG, and sorbitol at a rate of 30% by weight of the desired FG can be added to mixer 1 downstream of the chiller. The temperature of the mixture with the bulk sweeteners added is preferably held between 160° F. and 200° F. The combination of the finished gum base (FGB) and subsequent gum ingredients (SGIx) is then expelled from continuous mixer 502 as a FGB+SGIx.

Effluent FGB+SGIx of continuous mixer 502 is then added to mixer 2 in the form of a continuous mixer(s) 504 in the form of a low shear extruder, where more subsequent gum ingredients SGIy are added to complete the gum structure. As the process according Process 26 of Table 4 results in a finished gum structure after mixing by mixer 2, the additional set of subsequent gum ingredients SGIy added to the gum structure is sufficient to form a finished set of gum ingredients. The set of subsequent gum ingredients SGIy includes the following ingredients. Sweeteners in the form of erythritol added at a rate of 5% by weight of the desired FG, hydrogenated starch hydrolysates at a rate of 3% by weight of the desired FG and isomalt added at a rate of 5% by weight of the desired FG are added. Fluids in the form of glycerin are added at a rate of 1% by weight of the desired FG. The desired flavor is added at a rate of 2% by weight of the desired FG. Additional emulsifier such as in the form of lecithin is added at a rate of 2% by weight of the desired FG. Also, high intensity sweetners in the form of Ace-K is added at a rate of 1% by weight of the desired FG in addition to encapsulated sweetner in the form of apsartame encapsulated in PVA at a rate of 0.8% by weight of the desired FG. Finally, the desired color is added at a rate of 0.2% by weight of the desired FG. The subsequent gum ingredients of SGIy are mixed at low temperatures such as approximately 90° F. to prevent degradation to the ingredients.

As can be seen from Example 10 of Table 3, all of the gum structure ingredients have now been added. Therefore, the effluent of continuous mixer 504 (the downstream mixing mixer) includes both a finished gum base (FGB) and a finished set of subsequent gum ingredients (FSGI), which forms a finished gum structure (FG).

### SPECIFIC EXAMPLE 3

A third contemplated example relates to kitting and, particularly, kitting where a significant portion of bulk ingredients are added at a remote location. For reference in describing this example, reference will be made to mixing systems 100 of FIG. 1 and FIG. 13. Further, this example will use the gum structure of Example 6 of Table 3 and will employ a mixing process following Process 4 of Table 4 where the downstream mixing results in a finished gum composition (FG). The FGB of this FG forms approximately 30% by weight of the FG.

In this example, mixer 1 will take the form of continuous mixer 102 that is a high shear high temperature extruder used to compound the elastomeric portion of the gum base ingredients GBIx of the finished gum composition. The set of gum base ingredients GBIx added to mixer 1 will include the following ingredients. A high molecular weight elastomer in the form of butyl rubber is added at a rate of 10% by weight of the desired FGB along with a low molecular weight elastomer in the form of polyisobutylene at a rate of 10% by weight of the desired FGB at feed port 121. A portion of the ultimate weight percent of the filler in the form of calcium carbonate is added at a rate of 10% by weight of the desired FGB at feed port 321 to assist in compounding the elastomer. The portion of filler added to mixer 1 is only a portion of the total weight percent of filler added to the gum structure as the rest of the filler will be added at the remote location 114. In addition, elastomer plasticizers in the form of rosin esters are added at a rate of 5% by weight of the desired FGB at feed port 123. These gum base ingredients of GBIx are used to form a compounded elastomer gum structure and are thus subjected to the high shear mixing at a temperature of approximately 325° F. However, as evident from the listing of ingredients for the gum base of Example 1 of Table 2, the GBIx gum structure effluent of mixer 1 is not yet a finished gum base (it could be a master batch) for the contemplated finished gum composition of Example 6.

The effluent GBIx is added to mixer 2 in the form of continuous mixer 104. Continuous mixer 104 is in the form of a low shear extruder. The partial gum base effluent GBIx is mixed with an additional set of gum base ingredients GBIy and a first set of subsequent gum ingredients SGIx.

The set of gum base ingredients GBIy includes the following gum base ingredients. An additional elastomer in the form of polyvinyl acetate at the rate of 5% by weight of the desired FGB is added. Also, plasticizers/emulsifiers in the form of lecithin, triacetin, and glycerol monosterate are added at a rate of 5% by weight of the desired FGB. Further, waxes at a rate of 5% by weight of the desired FGB are added to the gum structure with mixer 2.

Also added to mixer 2 is a set of subsequent gum ingredients SGIx required for the finished gum composition of Example 6 of Table 3. In this example, the set of subsequent gum ingredients SGIx added to mixer 2 includes the lower weight percent gum ingredients except for formula specific ingredients such as flavors, acids and colors. The higher weight percent subsequent gum ingredients, such as bulk sweeteners, and the formula specific ingredients will be added at the remote location 114. As such, fluids in the form of glycerin are added at a rate of 1% by weight of the desired FG. Additional emulsifier such as in the form of lecithin is added at a rate of 8% by weight of the desired FG.

Preferably the ingredients added to mixer 2 are added at a temperature between about 150-210° F.

In this example, the effluent of mixer 2 includes gum base ingredients GBIxy that are less than a finished gum base and a set of subsequent gum ingredients that is less than a finished set of subsequent gum ingredients SGIx forming an effluent illustrated as GBIxy+SGIx. Because this is an example of kitting, the effluent of mixer 2 will be passed to packaging system 116 for forming a storable gum structure in the forms of bricks or pellets. The storable gum structure effluent is then shipped using shipping system 118 to the second plant 114 where it is used as an ingredient by continuous mixer 106, which performs the downstream mixing of Table 4.

At remote location 114, the effluent GBIxy+SGIx of continuous mixer 104 is mixed with the rest of the ingredients to form a finished gum structure. To mix the effluent GBIxy+SGIx, which is delivered to remote location in a solid form, the effluent GBIxy+SGIx is first melted by preheating to a temperature of approximately 65° C. Once the effluent GBIxy+SGIx is melted, it is added to continuous mixer 106, such as at feed port 161.

To finish the gum structure, an additional set of gum base ingredients GBIz and an additional set of subsequent gum ingredients SGIy is added to effluent GBIxy+SGIx with continuous mixer 106. This final set of gum base ingredients includes the rest of the calcium carbonate filler which is added to the mixture at a rate of 30% by weight of the desired FGB. The gum base ingredient of oil is also added in the form of vegetable oils at a rate of 20% by weight of the desired FGB.

Also added to the gum structure at continuous mixer 106 is the final set of subsequent gum ingredients SGIy. As such, bulk sweeteners in the form of sucrose will be added at a rate of 33% by weight of the desired FG and the form of corn syrup will be added at a rate of 20% by weight of the desired FG using continuous mixer 106.

Adding the bulk sweeteners, vegetable oils and the remainder of the filler at the remote location is believed to provide a beneficial result as these ingredients are contemplated to form a large weight percentage of finished gum and can typically be found in many foreign locations. Thus, potentially significantly reducing shipping costs and additional costs relating to these ingredients.

Further included in the set of subsequent gum ingredients SGIy added to the mixture of continuous mixer 106 is the desired flavors added at a rate of 2.8% by weight of the desired FG, the desired acids at a rate of 1% by weight of the desired FG, and the colors added at a rate of 0.2% by weight of the desired FG. Further, high intensity sweeteners in the form of sucralose, ace-K and aspartame are added at rates of 1% by weight of the desired FG, 1% by weight of the desired FG and 3% by weight of the desired FG, respectively. These additional subsequent gum ingredients finish the gum structure. It is desirable to add these ingredients at the remote location 114 as these ingredients can be very location specific and merely varying the flavors and colors can result in various different finished gums. Further, adding much of any of these ingredients can significantly effect the appearance and taste of a finished gum product.

Now that some specific examples have been described to illustrate the formation of gum structures using processes and mixing systems of the present invention. Several more conceptual examples of potential ingredient sets will be provided.

Table 5 provides a map of potential gum base ingredients that could be included in sets of gum base ingredients such as GBIxs, GBIys, and GBIzs used in the Process 1-30 of Table 4.

TABLE 5

| GBI- | | | | | |
|---|---|---|---|---|---|
| Examples¹ | Elastomer | Filler | Plasticizer | Wax | Fats/Oils |
| 1 | X | | | | |
| 2 | X | X | | | |
| 3 | X | X | X | | |
| 4 | X | X | X | X | |
| 5 | X | X | X | X | X |
| 6 | X | X | | X | |
| 7 | X | X | | X | X |
| 8 | X | X | X | | X |
| 9 | X | X | | | X |
| 10 | X | | X | | |
| 11 | X | | X | X | |
| 12 | X | | X | X | X |
| 13 | X | | X | | X |
| 14 | X | | | X | |
| 15 | X | | | X | X |
| 16 | X | | | | X |
| 17 | | X | | | |
| 18 | | X | X | | |
| 19 | | X | X | X | |
| 20 | | X | X | X | X |
| 21 | | X | | X | |
| 22 | | X | | X | X |
| 23 | | X | X | | X |
| 24 | | X | | | X |
| 25 | | | X | | |
| 26 | | | X | X | |
| 27 | | | X | X | X |
| 28 | | | X | | X |
| 29 | | | | X | |
| 30 | | | | X | X |
| 31 | | | | | X |

¹Anti-oxidant is an optional ingredient that could be added to any one of these GBI options or could be a GBI ingredient itself.

From Table 5, it is clear that it is contemplated that a set of gum base ingredients that could be an effluent or added to a mixer as an ingredient itself is variable and may include one or a plurality of gum base ingredients. For example, a set of gum base ingredients GBI^{x}, GBI^{y}, and/or GBI^{z} used in the Processes 1-30 of Table 4, such as according to option 7 of Table 5, could comprise or consist of for example elastomer in the form of butyl rubber in combination with polyisobutylene; a filler in the form of calcium carbonate; waxes and oils in the form of vegetable oil. In another example, a set of gum base ingredients GBI^{x}, GBI^{y}, and/or GBI^{z} of the Processes 1-30 of Table 4, such as according to option 26 of Table 5, could comprise or consist of for example a plasticizer in the form of lecithin; a wax in the form of caranuba wax; and oils in the form of vegetable oil. In this second example, the set of gum base ingredients does not include any elastomer ingredients, but is still a set of gum base ingredients.

Further, when a single set of gum base ingredients includes more than one ingredient, not all of the ingredients need to be added at a single feed port or at the same time in a mixing cycle. Additionally, a single ingredient added to an individual mixer could be added to a mixer at various locations or at varying times. Further, an individual ingredient such as a filler can form a part of a first set of gum base ingredients GBIx added to a gum structure using a first mixer as well as part of a second set of gum base ingredients GBIy added to a gum structure using a second or third mixer.

Table 6 provides a map of potential gum base ingredients that could be included in sets of gum base ingredients such as SGI^{x}s, SGI^{y}s, and SGT^{z}s used in the Process 1-30 of Table 4.

TABLE 6

| GI - | | | | |
|---|---|---|---|---|
| Examples | Sweeteners¹ | Flavors | Emulsifier | Colors |
| 1 | X | | | |
| 2 | X | X | | |
| 3 | X | X | X | |
| 4 | X | X | X | X |
| 5 | X | | X | |
| 6 | X | | X | X |
| 7 | X | X | | X |
| 8 | X | | X | |
| 9 | X | | | X |
| 10 | | X | | |
| 11 | | X | X | |
| 12 | | X | X | X |
| 13 | | X | | X |
| 14 | | | X | |
| 15 | | | X | X |
| 16 | | | | X |

¹Sweeteners could be bulk sweeteners, high intensity sweeteners or the combination of bulk and high intensity sweeteners and could be in any suitable form

From Table 6, it is clear that it is contemplated that a set of subsequent gum ingredients that could be an effluent or added to a mixer as an ingredient itself is variable and may include one or a plurality of subsequent gum ingredients. For example, a set of subsequent gum ingredients SGI^{x}, SGI^{y}, and/or SGI^{z} used in the Processes 1-30 of Table 4, such as according to option 1 of Table 6, could comprise or consist of for example solely of sweeteners in the form of sorbitol, maltitol and maltitol. In another example, a set of subsequent gum ingredients SGI^{x}, SGI^{y}, and/or SGI^{z} used in the Processes 1-30 of Table 4, also according to option 1 of Table 6, could comprise or consist of for example bulk sweeteners in the form of sucrose and corn syrup. In yet a further example, a set of subsequent gum ingredients SGI^{x}, SGI^{y}, and/or SGI^{z} used in the Processes 1-30 of Table 4, such as according to option 13 of Table 6, could comprise or consist of for example colors and flavors. This option could be beneficial when a master batch has previously been formed and the only remaining processing required it to give the gum structure its final appearance and ultimate flavor.

Further, when a single set of subsequent gum ingredients includes more than one ingredient, not all of the ingredients need to be added at a single feed port or at the same time in a mixing cycle. Additionally, a single subsequent gum ingredient added to an individual mixer could be added to a mixer at various locations or at varying times. Further, an individual ingredient such as a sweetener can form a part of a first set of subsequent gum ingredients SGI^{x} added to a gum structure using a first mixer as well as part of a second set of subsequent gum ingredients SGI^{y} added to a gum structure using a second or third mixer. Further yet, an individual ingredient such as a sweetener can include a combination of a plurality of individual specific ingredients such as for example sorbitol, erithritol, xylitol and maltitol all in combination.

Table 7 provides a further conceptual map of ingredients that may be included in some potential combinations of sets of gum base ingredients (GBI^{x}s, GBI^{y}s, and/or GBI^{z}s) in combination with potential sets of subsequent gum ingredients (SGI^{x}s, SGI^{y}s, and/or SGI^{z}s) used in various ones of the Process 1-30 of Table 4.

TABLE 7

| GBI + SGI | | | | | |
|---|---|---|---|---|---|
| Examples | GBI¹ | Sweeteners² | Flavors | Emulsifier | Colors |
| 1 | X | X | | | |
| 2 | X | X | X | | |
| 3 | X | X | X | X | |
| 4 | X | X | X | X | X |
| 5 | X | X | | X | |
| 6 | X | X | | X | X |
| 7 | X | X | X | | X |
| 8 | X | X | | X | |
| 9 | X | X | | | X |
| 10 | X | | X | | |
| 11 | X | | X | X | |
| 12 | X | | X | X | X |
| 13 | X | | X | | X |
| 14 | X | | | X | |
| 15 | X | | | X | X |
| 16 | X | | | | X |

¹A GBI could be any GBI included in Table 5.
²Sweeteners could be bulk sweeteners, high intensity sweeteners or the combination of bulk and high intensity sweeteners.

From Table 7, it is clear that it is contemplated that a combination of a set of gum base ingredients and a set of subsequent gum ingredients that could be an effluent or added to a mixer as an ingredient itself is variable and may include one or a plurality of subsequent gum ingredients.

For example, a set of subsequent gum ingredients GBIx, GBIy, and/or GBIz in combination with a set of subsequent gum ingredients SGIx, SGIy, and/or SGIz used in various ones of Processes 1-30 of Table 4, such as according to option 17 of Table 5 in combination with option 1 of Table 7, could comprise or consist of for example solely of filler in the form of calcium carbonate and bulk sweeteners in the form of sorbitol, maltitol and maltitol. This may be the case, such as in kitting where the last ingredients added to the gum structure are the large weight percent bulk ingredients.

In another example, a set of subsequent gum ingredients GBIx, GBIy, and/or GBIz a set of subsequent gum ingredients SGIx, SGIy, and/or SGIz used in the Processes 1-30 of Table 4, according to option 3 of Table 5 with option 1 of Table 7, could comprise or consist of for example consist of for example elastomer in the form of butyl rubber in combination with polyisobutylene; a filler in the form of calcium carbonate; and a plasticizer in the form of rosin esters as well bulk sweeteners in the form of sucrose and corn syrup. In this example, the gum base ingredients GBIx, GBIy, and/or GBIz would be added to provide a compounded elastomer portion of the gum structure, while the bulk sweetener would be added as a portion of the subsequent gum ingredients.

Parallel Mixing Systems & Methods

Now that mixing systems with mixers arranged in series have been described, parallel mixing systems with mixers arranged in parallel will now be described. Mixers used in the parallel mixing systems may be the same as those mixers described for the series mixing systems, and thus, may include both continuous mixers, batch mixers, and combinations thereof, as will be described in more detail below with particular examples of the parallel mixing systems.

As used herein, “parallel mixing systems” will refer to either: (a) mixing systems where an effluent of an upstream mixer is fed to two or more downstream mixers (simultaneously or sequentially) or (b) mixing systems where effluents of two or more upstream mixers are fed to a common downstream mixer (simultaneously or sequentially). In parallel mixing systems, mixers and series of mixers are considered to be “in parallel” with one another, when each of the mixers or series of mixers receives effluent from a common upstream mixer as an ingredient or a part of an ingredient, or each of the mixers or series of mixers feeds at least part of its effluent to a common downstream mixer. Additionally, a parallel mixing system can be viewed as a plurality of series mixing systems in which one mixer in the parallel mixing system forms a part of two or more of the series mixing systems. Thus, the principles relating to the series mixing systems described above are generally applicable to the parallel mixing systems that will be more fully described below. It should be noted that contemplated mixers in series may include intermediate devices including temporary storage such as a surge tank or a forming device such as a pelletizer or brick molding system, an ingredient feeder, or another mixer such that an effluent of an upstream mixer is not directly fed into a downstream mixer arranged in series.

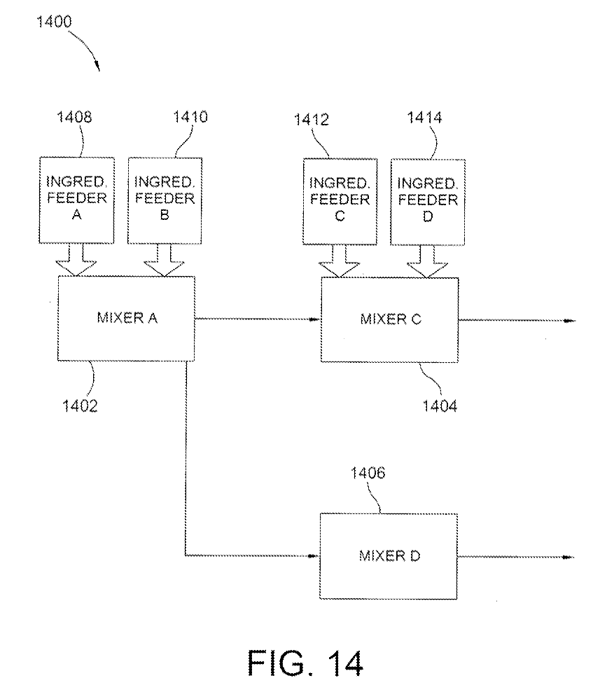

The description of the parallel mixing systems will begin with a high-level overview of contemplated parallel mixing systems according to embodiments of the present invention as represented schematically by mixing systems 1400, 1500, 1600, 1700, 1800, 1900, 2000, 2100, 2200, 2300, 2400, 2500, and 2600 of FIGS. 14-26. As FIGS. 14-26 are schematic representations, they are intended for illustrative purposes and are not intended to limit the scope of the invention.

The first contemplated parallel mixing system 1400, illustrated schematically in FIG. 14, includes mixer 1402 arranged in series and upstream of mixer 1404 and mixer 1406, which are arranged in parallel with each other. Parallel mixing system 1400 can be viewed as a combination of the series mixing systems, as described previously. As such, each of the series can be viewed as individual series mixing systems such as any one of systems 500, 600, 1100 and 1200, described previously, and therefore can have all of the benefits and features of those systems. Mixer 1402 is independently in series with mixer 1404, effectively forming a first series, and mixer 1402 is also independently in series with mixer 1406, effectively forming a second series. While the schematic representation of mixing system 1400 illustrates only two downstream mixers 1404, 1406 arranged in parallel with each other, the invention is not so limited and a contemplated mixing system could include any number of downstream mixers arranged in parallel with mixers 1404 and 1406.

In system 1400, an effluent of mixer 1402 may be fed to mixers 1404 and 1406 sequentially or simultaneously as an ingredient depending on the implementation. Although FIG. 14 shows mixer 1402 as directly feeding mixer 1404 and mixer 1406, intermediate devices such as surge tanks, forming devices, ingredient feeders or additional mixers may be incorporated between mixer 1402 and downstream mixers 1404, 1406 to hold and/or further process the effluent from mixer 1402 prior to being fed to mixers 1404, 1406.

Various types of mixers, mixer configurations and/or mixer operating parameters may be utilized for mixers in system 1400. For example, mixer 1402 may be a continuous mixer or a batch mixer. Similarly, mixer 1404 and mixer 1406 may either be a continuous mixer or a batch mixer. Further, mixer 1404 and mixer 1406, which are arranged in parallel with each other, may be a same type of mixer or different types of mixers. That is, in one implementation, both mixer 1404 and 1406 may be continuous mixers or batch mixers, or, in another implementation, mixer 1404 may be a continuous mixer while mixer 1406 is a batch mixer, or vice versa.

Moreover, even when mixer 1404 and mixer 1406 are the same type of mixers, mixer 1404 may be configured differently than mixer 1406. For example, mixer 1404 and mixer 1406 may both be a continuous mixer, such as an extruder. However, extruder 1404 may be configured with high shear elements for dispersive mixing while extruder 1406 may be configured with low shear elements for distributive mixing.

Alternatively, both mixers 1404 and 1406 may be the same type of mixers which are configured the same, but operated differently. For example, both mixers 1404 and 1406 may be continuous mixers with high shear elements. However, mixers 1404, 1406 may be operated with different operating parameters, i.e. mixer 1404 running at a higher temperature and/or a higher screw speed than 1406.

Further yet, mixer 1404 and mixer 1406 may output the same effluent or different effluents.

Although FIG. 14 illustrates each of mixers 1402 and 1404 with two ingredient feeders 1408, 1410 and 1412, 1414, respectively, and mixer 1406 without any ingredient feeders, each of mixers 1402, 1404, 1406 may be provided with any number of ingredient feeders according to input ingredients.

The ingredient feeders in parallel systems are similar to the ingredient feeders disclosed for series systems, i.e. gravity flow bins or hoppers, liquid holding tanks or canisters, ingredient impermeable sacs, carts, trays or other known applicable ingredient storage devices. As it was with series systems, the ingredient feeders may incorporate appropriate ingredient handling systems such as augers, conveyor belts, side feeders, gravity flow, vacuum conveying systems, liquid pumping, etc. The ingredient feeders may also incorporate optional blending devices, such as blenders or low shear mixers, to pre-blend ingredients from the ingredient feeders prior to feeding the ingredients to mixer. Further, the ingredient feeders typically include metering devices such as load cells for monitoring the weight loss of a specific ingredient from a given ingredient supply. Alternatively, flow metering devices that measure volume per unit of time may also be used.

In some implementations, a single ingredient feeder may feed an ingredient to multiple mixers. For example, in system 1400, mixers 1402, 1404, 1406 may require a common ingredient. In such an implementation, ingredient feeder 1408 containing that common ingredient can be configured to feed the ingredient to all three mixers sequentially. Alternatively, ingredient feeder 1408 may be configured to feed all three mixers 1402, 1404, 1406 simultaneously, such as a gravity flow system that is piped to all three mixers. In some implementations, an ingredient feeder may incorporate a conveyor system running between two batch mixers such that the conveyor belt is feeding its ingredient to a first batch mixer while a second batch mixer is running, and then the conveyor reverses its direction and feeds the second batch mixer while the first batch mixer is running.

Referring back to FIG. 14, an effluent of mixer 1402 may be any number of gum structures, such as, by way of example, a premix, which is also referred to as a pre-blended mix, a compounded elastomer, an elastomer with other gum base ingredients, an elastomer with subsequent gum ingredients, an elastomer with some other gum base ingredients and some subsequent gum ingredients, a gum base, or a gum base with subsequent gum ingredients. As discussed previously, the effluent from mixer 1402 may be fed to mixer 1404 and mixer 1406 simultaneously or sequentially. In some implementations, where mixer 1402 is not fed to mixers 1404, 1406 directly, one or more surge tanks may be incorporated to hold the effluent of mixer 1402 before it is further processed in mixers 1404, 1406.

Each of the mixers 1404, 1406 receives the effluent from mixer 1402 as an ingredient and may process the effluent by itself or process the effluent with one or more gum base ingredients and/or one or more subsequent gum ingredients. Effluents of mixer 1404 and mixer 1406 may vary and may be a compounded elastomer, an elastomer with other gum base ingredients, an elastomer with subsequent gum ingredients, an elastomer with some other gum base ingredients and some subsequent gum ingredients, a gum base, a gum base with subsequent gum ingredients, or a finished gum.

A capacity and design of mixer 1402 is selected according to factors such as ingredients, effluent characteristics and throughput volume. For example, when an effluent of mixer 1402 is a premix, mixer 1402 is typically a batch blender or a continuous mixer with a low shear elements for a low shear mixing. On the other hand, when a desired effluent from mixer 1402 is a compounded elastomer which requires a high shear dispersive mixing of ingredients, mixer 1402 is configured appropriately, such as a batch mixer with high shear mixing blades or an extruder with high shear dispersive mixing elements.

Other formulations may require mixer 1402 to be configured for varying shear mixings of ingredients to produce a desired effluent. For example, effluents such as an elastomer with other gum base ingredients, an elastomer with subsequent gum ingredients, an elastomer with some other gum base ingredients and some subsequent gum ingredients, a gum base, or a gum base with subsequent gum ingredients may require a high shear mixing for masticating and compounding of an elastomer with compounding aids, and lower shear mixing for further mixing of other ingredients. Where a batch mixer is selected as mixer 1402 for such effluents, the mixer parameters, such as type of blades, angle of blades and/or speed of mixing, may be varied to achieve the differing shear mixing requirements.

However, a continuous mixer such as an extruder having various shear mixing elements may process ingredients of such effluents more effectively. For example, an extruder can be configured to include several different elements constituting different shear sections of the extruder, i.e. an extruder including a section of high shear elements, a section of medium shear elements, and a section of low shear elements arranged in that order with the high shear section in the upstream. In such an extruder, ingredients that require high shear mixing, such as an elastomer and compounding aids, are added first to the high shear section, then ingredients that require a medium shear mixing are added to the medium shear section, and ingredients that require low shear mixing are then finally added to the downstream low shear section. Therefore, dispersive mixing, which typically requires high shear and distributive mixing which typically requires lower shear can be accommodated. These varying levels of shear also apply to temperature sensitivity of the various ingredients.

As discussed above, mixer 1404 and mixer 1406 may be the same or different types of mixers, or configured the same or differently, or operated the same or differently according to ingredients to be processed in mixers 1404, 1406. For example, in a contemplated implementation of system 1400, mixer 1402 may be a batch mixer blending a premix consisting of elastomers and compounding aids. In such an implementation, mixers 1404 and 1406 may produce the same effluent or different effluents. That is, mixers 1404 and 1406 may both be batch mixers, configured the same with the same blades, and operated the same using the same mixer parameters, i.e. the same temperature, same batch time, etc., to produce the same effluent, such as a compounded elastomer.

Alternatively, mixers 1404 and 1406 may both be batch mixers which are configured the same but operated differently to produce different effluents. For example, mixer 1404 and mixer 1406 may both be batch mixers configured with same blades. However, mixer 1404 may run its entire batch with one blade angle and one speed for high shear compounding of the premix to produce a compounded elastomer, while mixer 1406 may run its batch changing operating parameters during the batch run such that first part of batch run would compound the premix by high shear mixing and later part of the batch run would operate at lower shear for further mixing of additional ingredients with the compounded elastomer to produce an effluent which is more than a compounded elastomer such as a gum base or a finished gum.

In another contemplated implementation, mixers 1404 and 1406 may both be batch mixers which are configured differently to produce different effluents. For example, mixer 1404 may be configured with a single high shear blade and one ingredient feeder such that the ingredient feeder feeds the premix from mixer 1402 and processes the premix using the single high shear blade to output a compounded elastomer. In parallel with mixer 1404, mixer 1406 may be configured with two blades, one for high shear mixing and the other for low shear mixing, and multiple ingredient feeders. In mixer 1404, the premix may first be input and compounded with the high shear blade. After a set period of time, other ingredient feeders may feed additional gum base ingredients or subsequent gum ingredients which are then processed with the compounded elastomer with the low shear blade to produce an effluent which is more than a compounded elastomer, i.e. any gum structure between a compounded elastomer with additional gum base ingredients to a finished gum.

In yet another contemplated implementation of system 1400, mixer 1402 may be a batch or a continuous mixer configured with high shear blades or elements to output a compounded elastomer in combination with a set of gum base ingredients but is less than a desired finished gum base, which is also referred to as a gum base master batch. In such an implementation, mixer 1404 may be a continuous mixer such as an extruder, and mixer 1406 may be a batch mixer wherein the gum base master batch from mixer 1402 may be transported to a surge tank which holds and continuously feeds the gum base master batch to mixer 1404, while the gum base master batch for mixer 1406 may be transported to mixer 1406 just in time for a batch set up.

Depending on a capacity and design of the extruder, mixer 1404 can process the gum base master batch with any combination of additional ingredients to produce an effluent such as a gum base with subsequent gum ingredients to a finished gum. Similarly, mixer 1406, which is a batch mixer, may be configured to process the gum base ingredients with additional ingredients to produce an effluent being more than a gum base master batch. Thus, mixers 1404 and 1406 may output the same effluent or output different effluents. Where mixer 1404 and/or mixer 1406 produces an effluent less than a finished gum, one or more downstream mixers may be arranged in series with mixers 1404, 1406 for further gum making process to produce a desired finished gum. Further, in some implementations, one or more mixers in system 1400 may be located in different parts of a plant or different plants in different locations. The above discussed implementations of system 1400 are just a few examples of numerous different possible implementations of system 1400, and the invention is not limited to these examples.

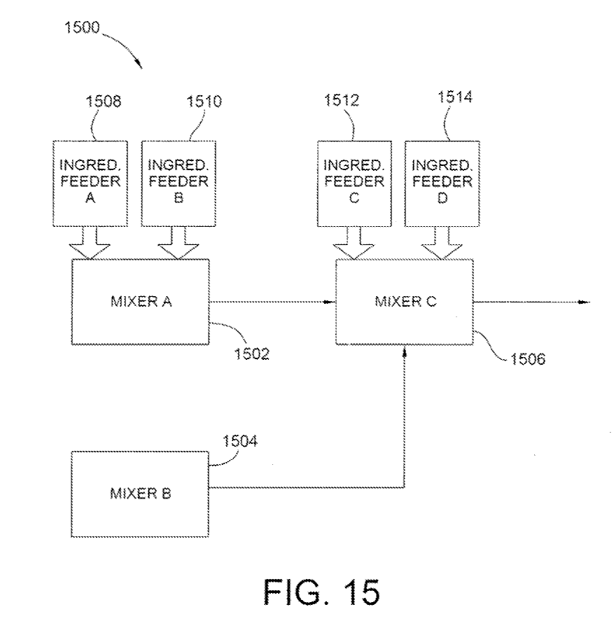

The second contemplated parallel mixing system 1500, illustrated schematically in FIG. 15, includes a pair of mixers 1502, 1504, arranged in parallel with each other and upstream from a single downstream mixer 1506. Parallel mixing system 1500 can be viewed as a combination of the series mixing systems described previously. Again, each of the series can be viewed as individual series mixing systems such as any one of systems 500, 600, 1100 and 1200 described previously, and therefore can have all of the benefits and features of those systems. Mixer 1506 is independently in series with mixer 1502, effectively forming a first series, and mixer 1506 is independently in series with mixer 1504, effectively forming a second series. While the schematic representation of mixing system 1500 illustrates only a pair of upstream mixers 1502, 1504 arranged in parallel, the invention is not so limited and a contemplated mixing system according to this arrangement can include any number of upstream mixers arranged in parallel with mixers 1502 and 1504.

System 1500 is a reverse arrangement of system 1400, wherein mixers arranged in parallel, namely mixers 1502, 1504, are upstream to the single downstream mixer 1502 while mixers arranged in parallel in system 1400, namely mixers 1404, 1406, are downstream from single upstream mixer 1402. As it was with system 1400, mixers of system 1500 may be either a batch mixer or a continuous mixer depending on ingredients to be processed and a desired throughput from each mixer.

FIG. 15 illustrates mixer 1502 with ingredient feeders 1508, 1510, mixer 1506 with ingredient feeders 1512, 1514, and mixer 1504 without any ingredient feeders. However, each mixer may be provided with any number of ingredient feeders depending on ingredients to be processed in each mixer. The details of ingredient feeders and their features in system 1500 are the same as the ingredient feeders described in system 1400.

Effluents of upstream mixers 1502 and 1504, which are arranged in parallel with each other, may be, by way of example, a premix, a compounded elastomer, an elastomer with other gum base ingredients, an elastomer with gum ingredients, an elastomer with some other gum base ingredients and some gum ingredients, a gum base, or a gum base with other gum ingredients. Mixer 1502 and mixer 1504 may produce the same or different effluents. Mixers 1502 and 1504 may output effluents simultaneously or sequentially.

Downstream mixer 1506 can receive the effluents from mixer 1502 and mixer 1504 sequentially or simultaneously as ingredients to produce an effluent such as a compounded elastomer, an elastomer with other gum base ingredients, an elastomer with gum ingredients, an elastomer with some other gum base ingredients and some gum ingredients, a gum base, a gum base with other gum ingredients, or a gum.

When received simultaneously, the effluents of mixers 1502, 1504 are both used as an ingredient of a single effluent of mixer 1506. However, when received sequentially, the effluents of mixers 1502, 1504 may be combined in mixer 1506 to form a single effluent. Alternatively, the two separate effluents can be used to form sequentially separate effluents.

A capacity and design of each mixer is selected according to factors such as ingredients, effluent formulations and throughput volume. As it was with system 1400, mixers arranged in parallel with each other in system 1500, namely mixer 1502 and mixer 1504, may be the same or different types of mixers, the same type of mixers configured differently, or the same type of mixers configured the same but operated differently.

For example, in one contemplated implementation of system 1500, mixer 1502 and mixer 1504 may both be batch mixers which are configured the same and operated with the same process parameters to produce the same effluent such as, for example, a gum base. Mixer 1502 and mixer 1504 may supply the gum base to mixer 1506, sequentially or simultaneously. However, for such an implementation wherein two batch mixers arranged in parallel produce the same gum base, a batch schedule of mixers 1502, 1504 is preferably set up such that mixers 1502, 1504 feed mixer 1506 sequentially to provide a more continuous supply of the gum base to mixer 1506.

In another implementation, mixer 1502 and mixer 1504 may both be continuous mixers, such as extruders which are configured the same with the same screw arrangements for both dispersive and distributive mixings. However, extruders 1502 and 1504 may be operated with different process parameters such as different barrel temperatures and/or screw rotating speeds to process two different sets of gum base ingredients to produce two different gum bases which are received by mixer 1506 simultaneously as ingredients to produce yet a different third gum base or other gum structures which are more than a gum base, such as a finished gum master batch. In such an implementation, mixer 1506 is selected such that its capacity is much larger than, or at least as large as, the capacity of mixers 1502 and 1504 combined, to maximize utilization of mixers 1502, 1504, and 1506.

Alternatively, mixer 1502 and mixer 1504 may feed mixer 1506 sequentially such that the gum base from mixer 1502 is first received by mixer 1506 to process the gum base with a first set of subsequent gum ingredients to produce a finished gum requiring such a gum base. Next, the gum base feed from mixer 1502 would stop and the different gum base from mixer 1504 feeds mixer 1506 wherein the gum base is processed with a second set of subsequent gum ingredients to produce a different finished gum. In such an implementation, the capacity of mixer 1506 is preferably larger than the capacity of mixers 1502 or 1504 because, typically, a finished gum includes less than 50% by weight of a gum base.

In yet another implementation, mixer 1502 may be a continuous mixer and mixer 1504 is a batch mixer. In such an implementation, mixer 1502 may be configured with elements for various shear mixings to produce a gum base with subsequent gum ingredients. Similarly, batch mixer 1504 may also be configured such that it produces the same gum structure or different gum structure than the effluent of mixer 1502. Again, mixer 1502 and mixer 1504 may run simultaneously or sequentially. The above discussed implementations of system 1500 are just a few examples of numerous different possible implementations of system 1500, and the invention is not limited to these examples.

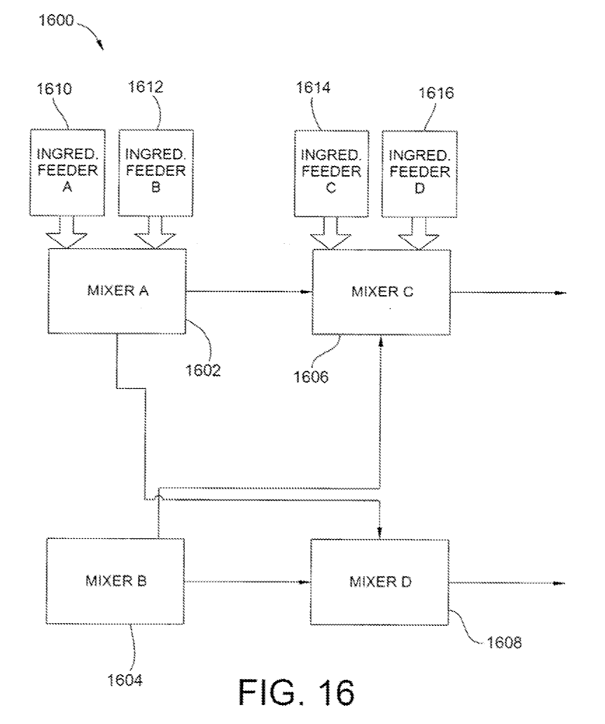

The third contemplated parallel mixing system 1600, illustrated schematically in FIG. 16, builds upon and combines parallel mixing system 1400 and parallel mixing system 1500. Parallel mixing system 1600 includes a pair of mixers 1602, 1604 arranged in parallel with each other and upstream from another pair of mixers 1606, 1608 arranged in parallel with each other. Mixer 1602 is arranged in series, individually, with both downstream mixers 1606, 1608. Similarly, mixer 1604 is arranged in series, individually, with both downstream mixers 1606, 1608.

In system 1600, upstream mixers 1602 and 1604, which are arranged in parallel, are configured to feed downstream mixers 1606 and 1608, which are arranged in parallel, wherein each of upstream mixers are configured to feed both downstream mixers. As it was with the other parallel systems 1400, 1500, each mixer in this system may be either a batch mixer or a continuous mixer. Further, more than two mixers may be included in each parallel arrangement.

FIG. 16 illustrates mixer 1602 with ingredient feeders 1610, 1612, mixer 1606 with ingredient feeders 1614, 1616, and mixers 1604 and 1606 without any ingredient feeders. However, as described with regard to the other parallel systems above, a mixer can be provided with any number of ingredient feeders. The description of ingredient feeders remains the same as the other series and parallel mixing systems.

Effluents of upstream mixers 1602 and 1604 may be a premix, a compounded elastomer, an elastomer with other gum base ingredients, an elastomer with gum ingredients, an elastomer with some other gum base ingredients and some gum ingredients, a gum base, or a gum base with other gum ingredients. Mixers 1602 and 1604 may produce the same effluent or different effluents. Effluents of downstream mixers 1606, 1608 may be a compounded elastomer, an elastomer with other gum base ingredients, an elastomer with gum ingredients, an elastomer with some other gum base ingredients and some gum ingredients, a gum base, a gum base with other gum ingredients, or a gum. Again, mixer 1606 and mixer 1608 may produce the same effluent or different effluents.

As it was with systems 1400 and 1500, mixers arranged in parallel, i.e. mixers 1602, 1604 and mixers 1606, 1608, may be the same or different types of mixers, the same type of mixers configured differently, or the same type of mixers which are configured the same but operated differently to produce the same or different effluents. Further, the mixers arranged in parallel may produce effluents simultaneously or sequentially. Further, downstream mixers may utilize upstream effluents simultaneously or sequentially.

For example, mixer 1602 and mixer 1604 may be outputting effluents simultaneously, wherein mixer 1602 feeds mixer 1606 while mixer 1604 feeds mixer 1608 for a period of time, and switch off such that mixer 1602 feeds mixer 1608 while mixer 1604 feeds mixer 1606 for a subsequent period of time. Alternatively, mixer 1602 and mixer 1604 may simultaneously feed mixer 1606 for a period of time then simultaneously feed mixer 1608 for a subsequent period of time. In another contemplated implementation, mixer 1602 and mixer 1604 may produce effluents sequentially, wherein mixer 1602 feeds both mixer 1606 and mixer 1608, simultaneously or sequentially, then the feed from mixer 1602 stops and mixer 1604 feeds both mixer 1606 and mixer 1608, simultaneously or sequentially. Yet, in a different implementation, effluent of mixer 1606 may be fed to mixer 1608, and effluent of mixer 1608 may be fed to mixer 1606.

Typically, ingredients are added to a mixer such that more viscous ingredients are added first. For example, in continuous mixers such as an extruder, viscous ingredients such as elastomers are added to upstream feed ports. Similarly, in batch mixers, viscous ingredients are added to a mixer during a batch set up, rather than being added later during a batch run. Further, in gum mixing systems where mixers are arranged in series, viscous ingredients are added in the most upstream mixers and are not typically, but not always, added to downstream mixers. Therefore, implementations of mixing systems 1400, 1500, 1600 may also be limited such that downstream mixers are not typically processing more viscous ingredients than upstream mixers.

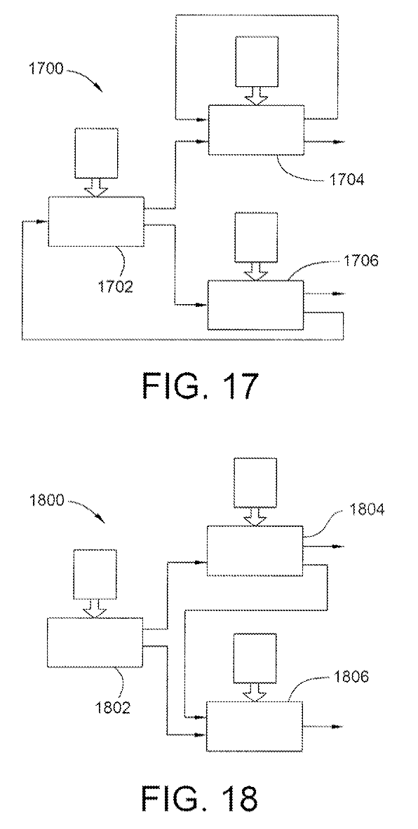

Other variations of mixing systems 1400, 1500 and 1600 are illustrated schematically in FIGS. 17-26 wherein an effluent from a mixer may be recirculated within the system or an effluent of a mixer may be directed to another mixer arranged, at least in part, in parallel with that mixer or an effluent from a mixer may be direct to a downstream mixer of a mixer arranged in parallel with that mixer to extend a mixing time of ingredients or to produce a different output.

Mixing systems 1700 and 1800 are configured similar to system 1400, wherein one upstream mixer is arranged in series with two downstream mixers arranged in parallel with each other. System 1700, illustrated schematically in FIG. 17, includes mixer 1702 arranged in series and upstream of mixer 1704 and mixer 1706, which are arranged in parallel with each other. In system 1700, an effluent of mixer 1702 may be directed to mixers 1704 and 1706 sequentially or simultaneously. System 1700 is configured such that an effluent of mixer 1704 may be further processed by recirculting the effluent back through mixer 1704. Similarly, an effluent for mixer 1706 may be further processed by recirculating the effluent back to mixer 1702, such that the effluent is reprocessed by mixer 1702 and then either reprocessed by mixer 1706 or processed by mixer 1704.

As it was with mixing systems 1400, 1500 and 1600, various types of mixers, mixer configurations and/or mixer operating parameters may be utilized for mixers in mixing systems 1700-2600 of FIGS. 17-26. For example, mixer 1702 may be a continuous mixer or a batch mixer. Similarly, mixer 1704 and mixer 1706 may either be a continuous mixer or a batch mixer. Further, mixer 1704 and mixer 1706, which are arranged in parallel with each other, may be a same type of mixer or different types of mixers. That is, in one implementation, both mixer 1704 and 1706 may be continuous mixers or batch mixers. In another implementation, mixer 1704 may be a continuous mixer while mixer 1706 is a batch mixer, or vice versa.

Moreover, even when mixer 1704 and mixer 1706 are the same type of mixers, mixer 1704 may be configured differently than mixer 1706. For example, mixer 1704 and mixer 1706 may both be a continuous mixer, such as an extruder. However, extruder 1704 may be configured with high shear elements for dispersive mixing while extruder 1706 may be configured with low shear elements for distributive mixing.

Alternatively, both mixers 1704 and 1706 may be the same type of mixers which are configured the same, but operated differently. For example, both mixers 1704 and 1706 may be continuous mixers with high shear elements. However, mixers 1704, 1706 may be operated with different operating parameters, i.e. mixer 1704 running at a higher temperature and/or a higher screw speed than 1706.

In one implementation of system 1700, an effluent of mixer 1704 may require a longer mixing time. In such implementation, the effluent of mixer 1704 may be recirculated as an ingredient of mixer 1704. Similarly, an effluent of mixer 1706 may also require further processing. In such implementation, the effluent of mixer 1706 may be recirculated through system 1700 by feeding the effluent of mixer 1706 back to mixer 1702 as an ingredient and reprocessing through mixers 1702, 1704 and 1706. When an effluent is recirculated, each mixer may or may not add additional ingredients to the effluent.

System 1800, illustrated schematically in FIG. 18, includes mixer 1802 arranged in series and upstream of mixer 1804 and mixer 1806, which are arranged in parallel with each other. In system 1800, an effluent of mixer 1802 may be fed to mixers 1804 and 1806 sequentially or simultaneously, wherein a portion of an effluent of mixer 1804 or its entirety may optionally be directed to mixer 1806 for further processing. Mixers 1804 and 1806 can be viewed as being simultaneously configured, as being in series, and as being in parallel with one another.

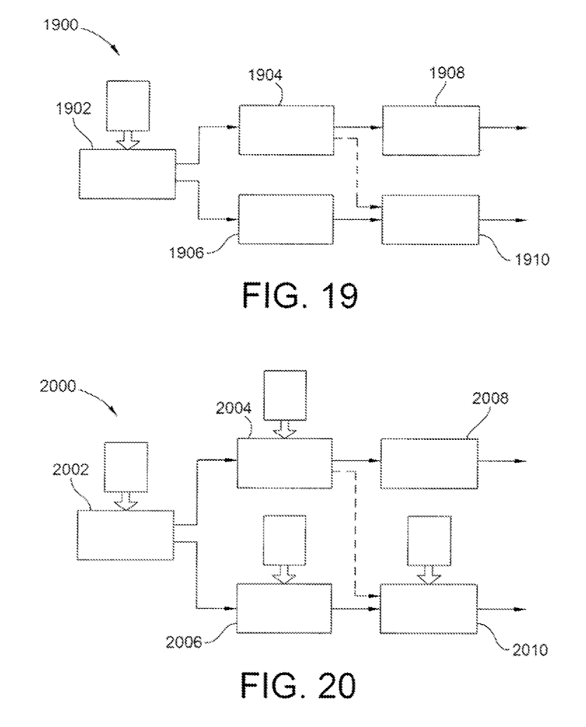

Mixing systems 1900, 2000, 2100, and 2200 are configured similar to system 1400 but include additional downstream mixers. Mixing system 1900, illustrated schematically in FIG. 19, includes mixer 1902 arranged in series and upstream of mixer 1904 and mixer 1906, which are arranged in parallel with each other. Further, mixing system 1900 includes mixer 1908 in series and downstream of mixer 1904 and mixer 1910 in series and downstream of mixer 1906. In system 1900, an effluent of mixer 1902 may be fed to mixers 1904 and 1906 sequentially or simultaneously with effluents of mixers 1904 and 1906 feeding their downstream mixers 1908 and 1910. Further, in system 1900, an effluent of mixer 1904 may be directed to mixer 1910 which is a downstream mixer of mixer 1906 which is arranged in parallel with mixer 1904.

In some implementations, a portion of the effluent of mixer 1904 may be directed to mixer 1908 with the remaining effluent of 1904 feeding mixer 1910. In another implementation, the effluent of mixer 1904 may feed mixer 1908 and mixer 1910 alternatively. That is, the entire effluent of mixer 1904 may first feed mixer 1908 for a set period of time, then the entire effluent of mixer 1904 may feed mixer 1910 for a subsequent period of time. Further, the amounts of effluent that are fed to mixers 1908 and 1910 may be the same or different. Further, the effluent that is fed to mixer 1908 may be different than an effluent fed to mixer 1910, particularly when the mixers 1908 and 1910 are fed at subsequent periods.

Mixing system 2000, illustrated schematically in FIG. 20, is configured similarly to mixing system 1900. Mixing system 2000 is presented to illustrate that mixing systems with similar configurations may produce different outputs with ingredient feeders adding different ingredients to different mixers in the mixing system. For example, as shown in FIG. 19, in one implementation, all ingredients processed through system 1900 are added to mixer 1902 such that no additional ingredient is added to downstream mixers, thus producing outputs from mixer 1908 and mixer 1910 that have the same ingredient composition. As such, if the downstream mixers are configured the same, the output of these mixers will be the same. However, if they are configured differently, different outputs may be produced.

Alternatively, additional ingredients may be added to downstream mixers as shown in mixing system 2000. For example, a set of gum base ingredients may be added and processed in mixer 2002 to produce a finished gum base. The finished gum base from mixer 2002 can feed mixers 2004 and 2006 simultaneously or sequentially as an additional ingredient. In mixer 2004, a set of subsequent gum ingredients may be added and mixed with the gum base from mixer 2002 to output a gum base with a set of subsequent gum ingredients, which is less than a finished gum. A portion of the effluent of mixer 2004 may be further processed in mixer 2008 without additional ingredients to output an effluent less than a finished gum which is ready for further downstream process. The remaining portion of the mixer 2004 effluent may be directed to mixer 2010 and mixed with an additional set of subsequent gum ingredients to output a finished gum.

In parallel with mixer 2004, mixer 2006 can also receive the effluent from mixer 2002, wherein a set of subsequent gum ingredients, which is different than the set of subsequent gum ingredients added to mixer 2004, is added to produce a gum base with a set of subsequent gum ingredients, which is different than the effluent of mixer 2004 and less than a finished gum. The effluent of 2006 and effluent of 2004 may be fed to mixer 2010 simultaneously or sequentially. For example, mixer 2010 may receive the effluent of mixer 2004 and the effluent of mixer 2006 simultaneously and process the effluents with an additional set of subsequent gum ingredients to produce a first finished gum formulation. Alternatively, mixer 2010 may first receive the effluent of mixer 2004 for a set period of time and mixes the effluent with an additional set of subsequent gum ingredients to output a second finished gum formulation. Then, mixer 2010 can receive the effluent from mixer 2006 for a subsequent period of time and mixes the effluent with an additional set of subsequent gum ingredients to produce a third finished gum formulation. Numerous other outputs can be contemplated using such mixing system with ingredient feeders adding different ingredients to different mixers in the system.

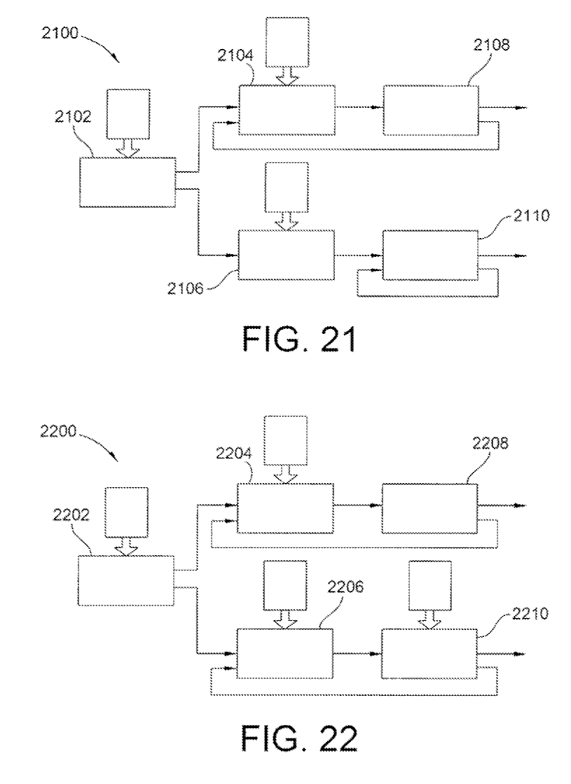

Mixing systems 2100 and 2200, illustrated schematically in FIGS. 21 and 22, are configured similarly to mixing systems 1900 and 2000, but include recirculation of some effluents. In system 2100, mixer 2102 may feed its effluent to mixer 2104 and mixer 2106 simultaneously or sequentially. Mixer 2104 may process the effluent of mixer 2102 together with additional ingredients. Mixer 2108 which is arranged in series and downstream of mixer 2104 can receive an effluent of mixer 2104 and further process the effluent for an additional mixing time. An effluent of mixer 2108 may then be recirculated by feeding the effluent back to mixer 2104 as an ingredient. Mixer 2104 may or may not add additional ingredients with the effluent of mixer 2108. The new effluent of mixer 2104 is again fed to mixer 2108 for further processing.

In parallel with mixer 2104, mixer 2106 may process the effluent of mixer 2102 together with additional ingredients. An effluent of mixer 2106 is fed to mixer 2110 for further mixing. An effluent of mixer 2110 can be processed for an additional mixing time by recirculating the effluent back into mixer 2110 as an ingredient, as shown in FIG. 21. Such recirculation of the effluent can increase mixing time of the ingredients or may produce various gum formulations by adding different ingredients to mixers at different times.

Similarly, mixer 2202 of mixing system 2200, as shown in FIG. 22, can feed its effluent to mixer 2204 and 2206 simultaneously or sequentially. Mixer 2204 may process the effluent of mixer 2202 with additional ingredients. Mixer 2208, which is arranged in series and downstream of mixer 2204, can mix an effluent of mixer 2204 for an additional period of time. An effluent of mixer 2208 is then recirculated through mixer 2204 as an ingredient, wherein the effluent is processed together with additional ingredients. A new effluent of mixer 2204 may be mixed further in mixer 2208.

In parallel with mixer 2204, mixer 2206 can receive the effluent of mixer 2202 and process the effluent with additional ingredients. An effluent of mixer 2206 is further processed with additional ingredients in mixer 2210 which is arranged in series and downstream of mixer 2206. An effluent of mixer 2210 may be further processed by recirculation, wherein the effluent is fed back to mixer 2206 as an ingredient with other additional ingredients. An effluent of mixer 2206 may be further processed in mixer 2210 with additional ingredients to produce a new effluent, which is different than the effluent of mixer 2210, prior to the recirculation. Although not shown, in different implementations, an effluent of mixer 2204 can be processed for an additional mixing time by recirculating the effluent back into mixer 2204 as an ingredient. Similarly, effluents of mixers 2206, 2208 and 2210 may be recirculated for additional mixing time.

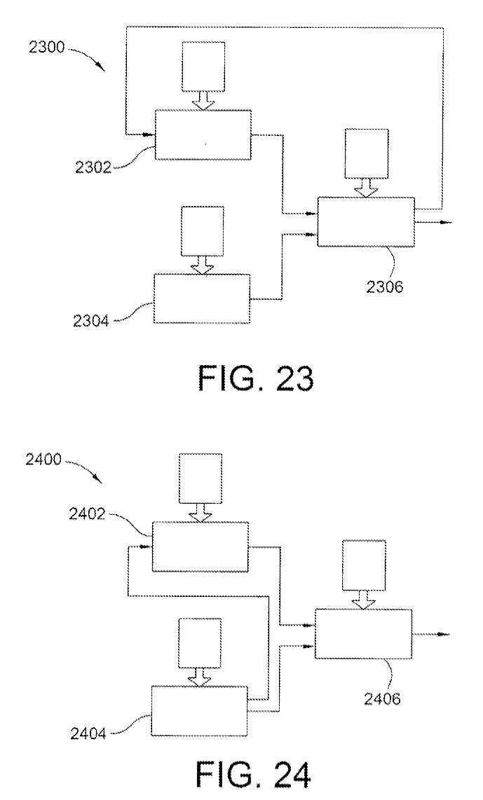

Mixing systems 2300, 2400, 2500 and 2600 are configured similarly to system 1500, wherein two upstream mixers are arranged in parallel with each other and in series with one downstream mixer. System 2300, illustrated schematically in FIG. 23, includes mixer 2302 arranged in parallel with mixer 2304, which are arranged in series and upstream of mixer 2306. In system 2300, an effluent of mixer 2302 and an effluent of mixer 2304 may feed mixer 2306 sequentially or simultaneously, wherein an effluent of mixer 2306 may be further processed by recirculating the effluent back to mixer 2302. A new effluent of mixer 2302 may be further processed in mixer 2306 with additional ingredients and/or the effluent of mixer 2304 to output a new effluent, which is different than the effluent of mixer 2306 prior to the recirculation.

Similarly, mixer 2402 and mixer 2404 of mixing system 2400, illustrated schematically in FIG. 24, can feed mixer 2406 simultaneously or sequentially. In addition to feeding mixer 2406, mixer 2404 also feeds mixer 2402, which is arranged in parallel with mixer 2404. In some implementations, mixer 2404 may feed a portion of its effluent to mixer 2406 simultaneously with remaining portions of the effluent feeding mixer 2402. In other implementations, mixer 2404 may feed mixer 2406 and mixer 2402 sequentially.

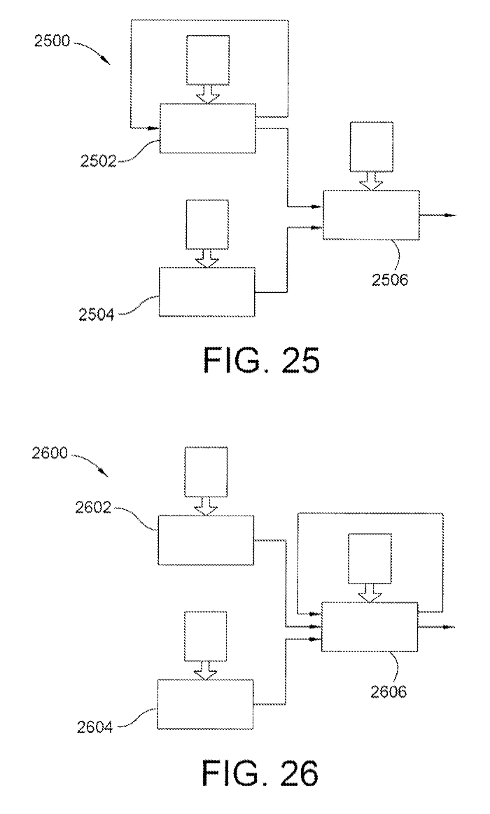

Mixing system 2500, illustrated schematically in FIG. 25, also includes two mixers 2502 and 2504 arranged in parallel with each other, wherein mixers 2502 and 2504 may feed mixer 2506 simultaneously or sequentially, which is arranged in series and downstream of mixers 2502 and 2504. In one implementation, mixer 2502 may process a set of ingredients to produce a compounded elastomer. The compounded elastomer is further processed by recirculating the compounded elastomer back through mixer 2502 as an ingredient, wherein a set of gum base ingredients are mixed with the compounded elastomer during the recirculation path through mixer 2502 to produce a first finished gum base formulation.

In parallel with mixer 2502, mixer 2504 may process a set of gum base ingredients to output a second finished gum base formulation which is different than the first finished gum base formulation. As discussed above, mixer 2502 and mixer 2504 may feed mixer 2506 simultaneously or sequentially. Where effluents of mixer 2502 and 2504 are fed sequentially, mixer 2506 may first receive the first finished gum base from mixer 2502 and process the first finished gum base with a set of subsequent gum ingredients to output a first finished gum formulation. Then, mixer 2506 may receive the second finished gum base from mixer 2504 and process the second finished gum base with a set of subsequent gum ingredients to output a second finished gum formulation.

Alternatively, mixer 2506 may receive the first finished gum base and the second finished gum base from mixers 2502 and 2504 simultaneously and mix them with a set of subsequent gum ingredients to output a third finished gum formulation which is different than the first finished gum and the second finished gum formulations. Numerous other effluents may be produced using such mixing system with the recirculation features.

In mixing system 2600, which is illustrated schematically in FIG. 26, two upstream mixers 2602 and 2604, which are arranged in parallel with each other, may each process a same set of ingredients or different sets of ingredients. As it was with mixing systems 2300, 2400, and 2500, two upstream mixers 2602 and 2604 may feed the downstream mixer 2606 simultaneously or sequentially. Thus, mixer 2606 may process an effluent of mixer 2602 with additional ingredients or may process an effluent of mixer 2604 with additional ingredients, or may process the effluent of mixer 2602 together with the effluent of mixer 2604 and additional ingredients. An effluent of mixer 2606 may then be further processed by recirculating the effluent back through mixer 2606 as an ingredient, wherein additional ingredients may or may not be added during the recirculation path.

These mixing systems 1400, 1500, 1600 and their variation systems 1700-2600 can have numerous structural and operational arrangements that provide numerous benefits and features in addition to those features identified previously for the series systems described above.

It can be contemplated that there may exist breaks in the continuity of input and/or output of mixers in mixing systems 1400-2600, particularly when batch mixers are arranged in parallel with each other. For example, where mixer 1404 and mixer 1406 of system 1400 are both batch mixers arranged in parallel, there may be breaks in the continuity of output. That is, mixer 1404 and 1406 may be on a same batch schedule, outputting effluents at the same time. Thus, no effluent is outputted when mixer 1404 and 1406 are both running their batches. Similarly, where mixer 1502 and 1504 of system 1500 are both batch mixers running their batches on a same schedule, mixers 1502 and 1504 feed mixer 1506 at the same time. Thus, the input to mixer 1506 from mixers 1508 and 1510 may not be continuous. However, such discontinuity of feed may be alleviated with a holding tank storing effluents of mixers 1502 and 1504, ready to feed mixer 1506.

In some implementations, a parallel system may be combined in parallel with another parallel system. Alternatively, a first parallel system may be combined in series with a second parallel system. In yet further implementations, a parallel system may be combined upstream or downstream with a series system. In addition, these mixing systems 1400, 1500, 1600 may be part of larger mixing systems that include more or less upstream or downstream mixers and more or less parallel mixers.

Several benefits and advantages of various implementations of these parallel gum mixing systems will now be discussed.

A first benefit and advantage of implementing some embodiments of parallel mixing systems having multiple downstream mixers arranged in parallel with each other, such as mixing systems 1400, 1600, is that such embodiments enable the mixing system to be simultaneously configured to produce and output multiple different gum structures. While being simultaneously configured to produce multiple gum structures, the multiple gum structures may be formed simultaneously or sequentially.

In a first example, the effluent of mixer 1402 may be a common gum base used in two separate finished gums. The common gum base effluent of mixer 1402 can be fed to parallel downstream mixers 1404, 1406. Mixer 1404 can then process the common gum base with a selected set of subsequent gum ingredients for a first finished gum, while mixer 1406 processes the gum base with a different set of subsequent gum ingredients for a second finished gum, for example, a different flavored gum or different colored gum. While two different finished gums could be formed simultaneously by directing a portion of the effluent of mixer 1402 to both mixers 1404, 1406 and running both mixers 1404, 1406 simultaneously, it is contemplated that other operational implementations may direct all of the effluent from mixer 1402 through mixer 1404 to form the first finished gum, and then subsequently direct all of the effluent from mixer 1402 through mixer 1406 to form the second finished gum.

As will be discussed in more detail later, such an implementation also may improve productivity by maximizing utilization of each mixer in the mixing system. That is, because a gum base typically makes up less than 50% by weight of a finished gum, providing multiple mixers arranged in parallel and downstream of an upstream mixer producing a common gum base may enable the upstream mixer to run at its full capacity by providing multiple downstream mixers which can receive and process the gum base from the upstream mixer.

In a second example, a mixing system such as mixing system 1400 may be a gum base mixing system for producing finished gum bases or be a part of a larger mixing system that forms finished gum. In such an arrangement, mixing system 1400 could be used to simultaneously form two different gum bases having different formulations. Mixer 1402 may be used to compound an elastomer component to form a gum structure that is less than a finished gum base, but that is common to both gum bases. This common elastomer component is then fed to both mixers 1404 and 1406, sequentially or simultaneously, where different sets of gum base ingredients or different ratios of gum base ingredients are added to the common compounded elastomer component to produce two different finished gum bases.

Alternatively, mixers 1404, 1406 can produce two different gum structure types. For example, mixer 1404 may produce a gum base master batch which is less than a gum base, while mixer 1406 produces a gum base with at least one subsequent gum ingredient. Mixer 1404 and mixer 1406 could output effluents simultaneously or sequentially.

The examples discussed above only include a few possible effluents that may be produced by each mixer in mixing systems with multiple downstream mixers which are arranged in parallel with each other. However, there are numerous combinations of effluents that can be produced by each mixer, i.e. a premix to a finished gum. That is, an effluent of an upstream mixer could be any gum structure less than a finished gum, which is received by multiple downstream mixers to produce any gum structure from a compounded elastomer to a finished gum. As discussed previously, each of the multiple downstream mixers may produce the same or different effluents.

Another benefit and advantage of implementing some embodiments of parallel gum mixing systems 1400, 1500 and 1600 is that mixing systems 1400, 1500, 1600 have built in redundancy. The redundancy of the parallel mixers can reduce or eliminate downtime of the entire mixing system, such as for batch set-up, mixer reconfiguration, repair or cleaning. To provide for ideal redundancy, the mixers that are arranged in parallel are preferably similar such that the parallel mixer that takes over for the non-operating mixer can easily be used to replace the output of the non-operating mixer. However, the parallel mixers need not be similar. Mixers arranged in parallel with each other may be the same or different types of mixers, or the same type of mixers configured differently with different number and/or types of ingredient feeders, different shear blades or elements, etc. Alternatively, mixers in parallel may be the same type of mixers which are configured the same, but operated differently with different sets of process parameters such as different mixer temperatures, different mixer speeds, etc.

In a first example of this benefit and advantage, if upstream parallel mixers 1602, 1604 of gum mixing system 1600 produce a same gum structure which feeds both downstream mixers 1606, 1608, which are running separate gum formulations, and mixer 1602 needs to be repaired, production of neither gum formulations need be completely stopped due to the failure of mixer 1602. Upstream mixer 1604 can be used to feed both mixers 1606 and 1608 until mixer 1602 is repaired and back online. While output of mixers 1606, 1608 may be limited because less initial upstream production may be available, the redundancy provides a significant benefit because both gum formulations can be generated, albeit at a potentially reduced rate. Without the redundancy, i.e. if mixers 1602 and 1606 were a separate independent series mixing system from mixers 1604 and 1608, one of the gum formulations may not be able to be formed until mixer 1602 was repaired.

Alternatively, mixer 1604 can run at a higher throughput rate while mixer 1602 is down to compensate for the output from mixer 1602. Because downstream mixers in gum mixing systems are typically required to process a larger volume of ingredients than upstream mixers, the upstream mixers, such as mixers 1602, 1604, may not be running at their full capacity, limited by capacities of downstream mixers 1606, 1608. For example, where mixers 1602, 1604, 1606, 1608 are similar in capacity, upstream mixers 1602, 1604 may not be running at their full capacity in producing a gum base, while downstream mixers 1606, 1608 are running at their full capacity to produce finished gums utilizing the gum base from mixers 1606, 1608 as an ingredient. This is because a gum base typically makes up less than 50% by weight of a finished gum, requiring the downstream mixers to process more than twice the amount of ingredients compared to the upstream mixers. In such case, a downtime of one of the upstream mixers may be fully compensated by running the other upstream mixer at its full capacity, allowing the downstream mixers to maintain their full capacity operations.

In a second example, if downstream mixer 1404 of gum mixing system 1400 is being switched from producing one gum structure to a different gum structure, potentially requiring time consuming cleaning of mixer 1404, the entire gum mixing system 1400 need not be stopped. Rather, a gum structure can still be produced by the mixing system 1400, albeit, only from mixer 1406.

In addition to providing redundancy, parallel gum mixing systems 1400, 1500, 1600 can improve overall flexibility of a mixing system and increase utilization of the mixing system. For example, in gum mixing system 1400 having two parallel batch downstream mixers 1404, 1406 arranged in series with a continuous upstream mixer 1402, the upstream mixer 1402 can be configured to sequentially produce two different gum structures for sequential feeding of mixers 1404 and 1406.

In such implementation, mixer 1404 can process a first set of gum base ingredients to produce a first gum structure to feed batch mixer 1404 wherein the first gum structure is combined with additional ingredients to produce a first finished gum base. Then, while batch mixer 1404 is running its batch, mixer 1402 can process a second set of gum base ingredients to produce a second gum structure to feed batch mixer 1406 wherein the second gum structure is combined with additional ingredients to produce a second finished gum base. Here, the second set of gum base ingredients may include different individual ingredients or the same individual ingredients in different ratios than the first set of gum base ingredients, and the second set of gum base ingredients is comparable with the first set of gum base ingredients such that cleaning of mixer 1402 between processing of the first and second sets of gum base ingredients is not required or minimized.

The sequential production of two gum structures by the upstream mixer 1402 improves the utilization of the mixing system since it allows running mixer 1402 at a larger capacity to supply two downstream mixers 1404, 1406, instead of supplying one downstream mixer 1404, while allowing two downstream mixers 1404, 1406 to run without a downtime waiting for an upstream supply. It also improves flexibility by enabling production of two different finished gum formulations using a single mixing system.

A further benefit and feature of implementing parallel gum mixing systems 1400, 1500, 1600 is that contamination can be reduced by dedicating different ones of the parallel mixers to specific differing sets of ingredients, i.e. sets that have at least one ingredient that is not in common.

For example, it may be desirable to produce a first set of gum structures that use a talc-based filler and a second set of gum structures that uses a calcium carbonate-based filler. By using the parallel mixing systems, such as mixing system 1400, the first set of gum structures using the talc-based filler can be dedicated to being run through mixer 1404 with all of the talc being added in mixer 1404 and the second set of gum structures using calcium carbonate can be dedicated to being run through mixer 1406 with all of the calcium carbonate being added in mixer 1406. In this arrangement, the talc and calcium carbonate will never be run in the same mixer of mixing system 1400, thereby eliminating any risk of contamination.

A further benefit and feature of implementing parallel gum mixing systems 1400, 1500, 1600 is that the parallel mixing systems 1400, 1500, 1600 can be used to optimize the mixing process based on numerous characteristics, such as the preferred mixing process for a given gum structure or maximization of the throughput of processed material.

For example, a first type of mixer, i.e. a batch mixer, may be more preferable for forming a first gum structure over a second type of mixer, i.e. a continuous mixer, while the second type of mixer, i.e. the continuous mixer, may be more preferable for forming a second gum structure over the first type of mixer, i.e. the batch mixer. Mixing system 1400 could be configured with mixer 1404 as a batch mixer while mixer 1406 is a continuous mixer so that both the first and second gum structures could be optimally formed using a single gum mixing system 1400. Thus, the mixing systems 1400, 1500, 1600 improve the mixing process by allowing selection of a mixer in the parallel system according to characteristics of each gum structure to optimize processing of each gum structure.

Additionally, implementing parallel gum mixing systems can be used to maximize final gum process line output by optimizing process throughput. For example, when a line includes an upstream mixer in series with a downstream mixer, the downstream mixer is preferably coordinated to the throughput capacity of the upstream mixer to optimize utilization and/or efficiency of the line. That is, when the upstream mixer has a larger process capacity than can be handled by the downstream mixer, the lower capacity downstream mixer can create a backlog of the upstream mixer effluent or require the upstream mixer to be run at less than full capacity. The excess of the upstream mixer effluent has to be held in a surge tank, and in the event that the surge tank capacity runs out, the upstream mixer will have to be stopped until the downstream mixer can catch up, or the upstream mixer must be run at less than full capacity. However, the production of a parallel mixing system, such as parallel gum mixing system 1400, can alleviate this process inefficiency by adding additional downstream mixers 1406 to utilize the excess capacity provided by the upstream mixer 1402, such that the upstream mixer 1402 can run at full capacity.

An additional benefit of implementing parallel gum mixing systems 1400, 1500, 1600 is that kitting of gum structures can be performed in varying manners.

For example and in reference to mixing system 1400, a masterbatch (either gum base masterbatch or finished gum masterbatch) may be formed at a first location in large quantity using a large capacity mixer 1402. This masterbatch can then be shipped to numerous other remote locations for finalizing the gum product, thereby incorporating the benefits of kitting described previously. This may be particularly beneficial in the event that a new highly efficient large production upstream mixer 1402 is implemented, but the numerous downstream lines at varying remote locations with more limited throughput capacity can still be employed. However, to accommodate the large capacity of upstream mixer 1402, numerous of the downstream mixers 1404 and 1406 are required.

A further potentially beneficial implementation of parallel mixing systems occurs when various desired gum structures are formed by, at least, the mixture of two or more similar gum structures. For example, two gum bases may be blended together to form a third desired gum base. Rather than being required to form a batch of the first gum base and store that batch while the mixing system produces a batch of the second gum base, mixing systems such as mixing system 1500 can be used where mixer 1502 and mixer 1504 produce the first and second gum bases, respectively, and the two gum bases are then blended together in downstream mixer 1506.

### PARTICULAR EXAMPLES OF PARALLEL MIXING SYSTEMS

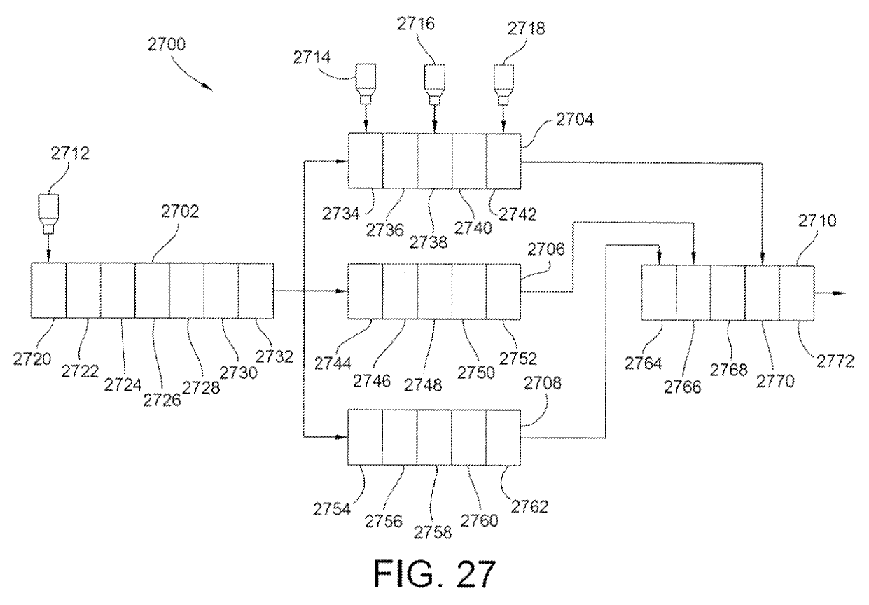

Now that some general contemplated parallel mixing systems have been described, more particular implementations and examples of parallel mixing systems 1400, 1500, 1600 will be described with reference to mixing systems 2700-3300, illustrated in FIGS. 27-33. While the following examples will show the use of particular arrangements of parallel mixing systems incorporating varying combinations and arrangements of continuous or batch mixers, these representative contemplated examples are not intended to be limiting. Other parallel mixing systems in accord with the present invention may include more or less mixers arranged in a parallel arrangement or may have more or less mixers aligned upstream or downstream from the parallel arrangements.

### PARALLEL SYSTEM PARTICULAR EXAMPLE 1

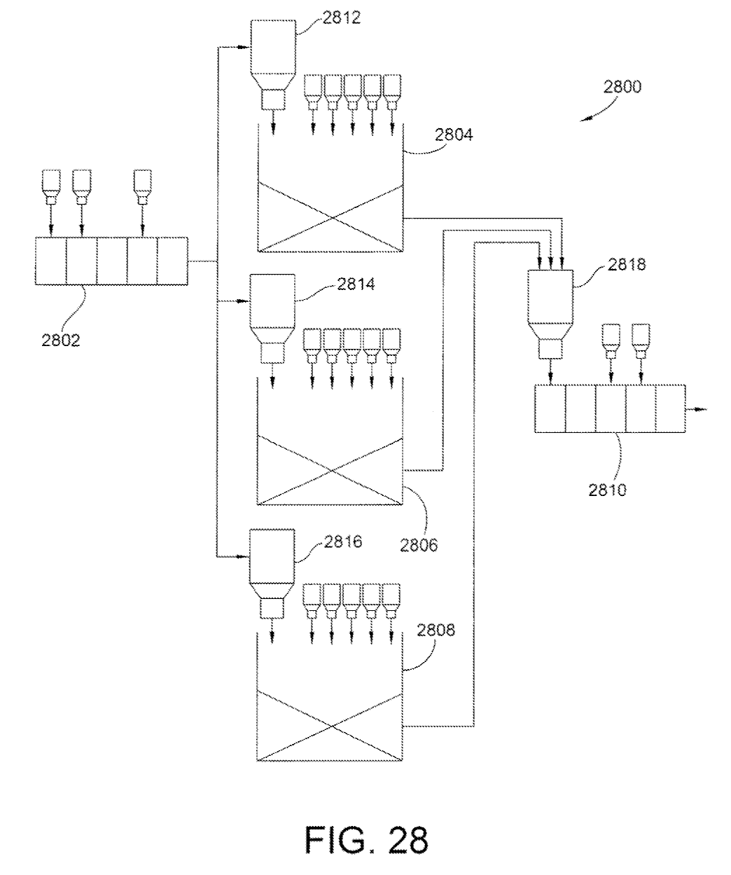

Referring to FIG. 27, a first particular parallel mixing system 2700 is shown. This first system 2700 will be explained in detail, while other embodiments illustrated in FIGS. 28-33 will be discussed and described in more limited detail highlighting differences and similarities relative to system 2700.

Mixing system 2700 is a more particular example of the general mixing system 1400 illustrated schematically in FIG. 14, generically discussed previously. System 2700 includes three continuous mixers 2704, 2706, 2708 arranged in parallel with each other. System 2700 further includes a continuous mixer 2702 arranged in series and upstream of the three parallel mixers 2704, 2706, 2708, and a single continuous mixer 2710 in series with and downstream of each of the three parallel mixers 2704, 2706, 2708. According to this arrangement, effluent of continuous mixer 2702 is used as an ingredient for the gum structures that are formed by parallel mixers 2704, 2706, 2708. Each of the effluents of mixers 2704, 2706, 2708, can be fed as an ingredient to mixer 2710.

In some implementations of system 2700, an effluent from a mixer may be recirculated within the system or an effluent of a mixer may be directed to another mixer arranged in parallel with that mixer to extend a mixing time of ingredients or to produce a different output. For example, effluent of mixer 2704 may be recirculated as an ingredient to mixer 2702 or fed to mixer 2706 and 2708 which are arranged in parallel with mixer 2704.

As it was with other mixers, such as for the series mixing systems described previously, mixers 2702, 2704, 2706, 2708, 2710 are equipped with ingredient feeders 2712, 2714, 2716, 2718. The number, arrangement and type of ingredient feeders are selected according to characteristics of ingredients to be processed in each mixer for continuous delivery of the ingredients to the continuous mixer at desired feed rates.

FIG. 27 depicts mixer 2702 with seven feed ports 2720, 2722, 2724, 2726, 2728, 2730, 2732; mixer 2704 with five feed ports 2734, 2736, 2738, 2740, 2742; mixer 2706 with five feed ports 2744, 2746, 2748, 2750, 2752; mixer 2708 with five feed ports 2754, 2756, 2758, 2760, 2762; and mixer 2710 with five feed ports 2764, 2766, 2768, 2770, 2772. However, each mixer can be configured with any number of feed ports.

In a particular contemplated implementation of gum mixing system 2700, mixing system 2700 is used to form a desired finished gum base FGB4, which can then be processed using a different mixing system to form a finished gum. Mixer 2702 forms a gum structure that is less than a gum base. Mixers 2704, 2706, 2708 each produce a gum structure in the form of differing finished gum bases FGB1, FGB2, FGB3. Mixer 2710 combines the different finished gum bases FGB1, FGB2, FGB3 of mixers 2704, 2706, 2708 to produce a desired finished gum base FGB4 which is different than the finished gum bases FGB1, FGB2, FGB3 produced by mixers 2704, 2706, 2708, respectively.

In carrying out this implementation, mixer 2702 is configured as a high shear, high temperature extruder to compound the elastomeric portion of a set of gum base ingredients GBIx. The set of gum base ingredients GBIx added to mixer 2702 may consist of various molecular weight elastomers including butyl rubber, polyvinyl acetate, polyisobutylene, and elastomer plasticizer in the form of rosin ester and waxes as listed in Table 2.

In such an implementation, each ingredient of the set of gum base ingredients GBIx is added to mixer 2702 using an ingredient feeder such as one depicted with reference number 2712. Although, FIG. 27 only shows one ingredient feeder 2712 for mixer 2702, it is contemplated that any number of ingredient feeders, such as five ingredient feeders in this case, for each ingredient of GBIx, may be used for continuous delivery of ingredients to mixer 2702. The ingredients of GBIx may be added all at one location or at different locations of mixer 2702. However, typically, higher molecular weight elastomer requiring longer residence time will be added first. That is, high molecular weight elastomer, such as butyl rubber, may be added to feed port 2720, followed by the other elastomers, such as polyvinyl acetate and polyisobutylene, to feed port 2722, then rosin ester and waxes to feed port 2724 or other subsequent feed ports 2726, 2728, 2730, 2732.

For continuous operation of mixer 2702, ingredient feeders 2712 continuously feed GBIx to mixer 2702. For example, where the system 2700 is designed such that a target output of mixer 2710 is 1000 kg of gum base FGB4 per hour, feed rate of each ingredient of GBIx to mixer 2702 may be 80 kg/hr butyl rubber, 46.7 kg/hr polyvinyl acetate, 93.3 kg/hr polyisobutylene, 48 kg/hr rosin ester and 92 kg/hr waxes. In such an implementation, mixer 2702 outputs 360 kg/hr of a compounded elastomer consisting of the set of gum base ingredients GBIx.

Separate portions of the effluent of mixer 2702 formed by the set of gum base ingredients GBIx are then fed to downstream continuous mixers 2704, 2706, 2708 as an ingredient of each mixer. In this example, continuous mixers 2704, 2706, 2708 are similarly configured. A first portion of the effluent of mixer 2702, more particularly 25% of the effluent of mixer 2702, is directed to mixer 2704, and two other portions of the effluent of mixer 2702, and more particularly the rest equally, are fed to mixers 2706 and 2708.

Three more sets of gum base ingredients GBIy1, GBIy2, GBIy3 are also fed to mixers 2704, 2706, 2708, respectively. In continuous mixer 2704, a set of gum base ingredients GBIy1 is added with a portion of the effluent of mixer 2702 consisting of GBIx to produce a finished gum base FGB1 consisting of GBIxy1. The set of gum base ingredients GBIy1 includes additional gum base ingredients of GBIx and other gum base ingredients to form a gum base formulation within the ranges specified for Representative Gum Base 2 of Table 2. GBIy1 does not include additional high molecular weight elastomer, thus, mixer 2704 may be configured with lesser shear elements than mixer 2702, but still equipped with elements sufficient for dispersive mixing of additional low molecular weight elastomers with the effluent of mixer 2702 and other gum base ingredients.

Specifically, a feed rate of each ingredient of the set of gum base ingredients GBIy1 in this example is 48.3 kg/hr polyvinyl acetate, 6.7 kg/hr polyisobutylene, 12 kg/hr rosin esters, 8 kg/hr waxes, 75 kg/hr vegetable oils, 30 kg/hr emulsifier in the form of triacetin, and 30 kg/hr calcium carbonate filler. Thus, with 25% of the effluent of mixer 2702 consisting of 20 kg/hr butyl rubber, 16.7 kg/hr polyvinyl acetate, 23.3 kg/hr polyisobutylene, 12 kg/hr rosin esters, and 23 kg/hr waxes, mixer 2704 forms 305 kg/hr of finished gum base FGB1 consisting of GBIxy1.

The sets of ingredients processed in mixers 2702, 2704, 2706, 2708, 2710 of this implementation are for illustrative purpose only. Ingredients to be processed in each mixer of a gum mixing system such as system 2700 are selected according to many factors such as viscosity and other characteristics of ingredient including a form in which the ingredient is inputted into a mixer, i.e. liquid, solid blocks, powder, etc. Generally, ingredients with higher viscosity are added in upstream mixers of a mixing systems or upstream feed ports of a mixer. Therefore, any high viscosity ingredients fed to downstream mixers such as mixer 2704 may be fed in a liquid form.

Similar to mixer 2704, mixers 2706 and 2708 are each fed continuously with 37.5% of the effluent of mixer 2702 and an additional set of gum base ingredients GBIy2 or GBIy3 consisting of vegetable oil, emulsifier in the form of lecithin or glycerol monostearate, and calcium carbonate, thereby forming a finished gum base FGB2 consisting of GBIxy2 and a different finished gum base FGB3 consisting of GBIxy3. Finished gum bases FGB2 and FGB3 are both different formulations of Representative Gum Base 1 in Table 2. Because GBIy2 and GBIy3 do not include additional elastomers, mixers 2706 and 2708 may be operated at a higher speed than the other parallel mixer 2704. Therefore, mixers 2706 and 2708 have a higher throughput rate than mixer 2704 as will be explained below.

Feed rates of ingredients to mixer 2706 include a portion of the effluent from mixer 2702 consisting of 30 kg/hr butyl rubber, 17.5 kg/hr polyvinyl acetate, 35 kg/hr polyisobutylene, 18 kg/hr rosin ester and 34.5 kg/hr waxes and GBIy2 consisting of 57.5 kg/hr vegetable oil, 25 kg/hr emulsifier in the form of lecithin, and 130 kg/hr calcium carbonate as a filler. Similarly, feed rates of ingredients to mixer 2708 include a portion of the effluent from mixer 2702 consisting of 30 kg/hr butyl rubber, 17.5 kg/hr polyvinyl acetate, 35 kg/hr polyisobutylene, 18 kg/hr rosin esters and 34.5 kg/hr waxes and GBIy3 consisting of 57.5 kg/hr vegetable oil, 25 kg/hr emulsifier in the form of glycerol monostearate, and 130 kg/hr calcium carbonate filler. Therefore, mixer 2706 processes 347.5 kg/hr of GBIxy2 to form FGB2, and mixer 2708 processes 347.5 kg/hr of GBIxy3 to form FGB3.

The effluent of mixer 2704 consisting of GBIxy1, the effluent of mixer 2706 consisting of GBIxy2, and the effluent of mixer 2708 consisting of GBIxy3 are then continuously fed to the downstream mixer 2710 to form yet another finished gum base FGB4 which is a formulation of Representative Gum Base 1 in Table 2. Feed rates of ingredients correspond with throughput rates of mixers 2704, 2706, 2708, and no other gum base ingredients are added to mixer 2710 in this implementation. Thus, mixer 2710 may be a forming extruder. Feed rate of the effluent consisting of GBIxy1 is equivalent to output rate of mixer 2704, namely 305 kg/hr. Similarly, feed rates of the effluents consisting of GBIxy2 and GBIxy3 are both 347.5 kg/hr corresponding to the throughput rates of mixers 2706 and 2708. As such, mixer 2710 forms 1000 kg/hr of the finished gum base FGB4 consisting of GBIxy1y2y3.

The ingredients and their quantities constituting the effluents of mixers 2702, 2704, 2706, 2708 are summarized in Table 8. More particularly, the quantity of each ingredient in Table 8 is represented in terms of weight percentage of each ingredient based on the corresponding set of input ingredients. For example, a set of gum base ingredients GBIx, which forms less than a gum base in mixer 2702, is comprised of 22% butyl rubber, 13% polyvinyl acetate, 26% polyisobutylene, 13% rosin esters and 26% waxes by weight. As discussed previously and as can be seen from comparing Table 8 with Table 2, finished gum bases FGB1, FGB2, FGB3, FGB4 are gum base formulations of Representative Gum Bases listed in Table 2; FGB1 is a Representative Gum Base 2 formulation, and FGB2, FGB3, FGB4 are Representative Gum Base 1 formulations.

TABLE 8
Ingredients of Effluents of System 2700

| | | 2704 | 2706 | 2708 | 2710 |
|---|---|---|---|---|---|
| | 2702 | FGB1 | FGB2 | FGB3 | FGB4 |
| Ingredient/Mixers | GBI^{x} | (GBI^{xy1}) | (GBI^{xy2}) | (GBI^{xy3}) | GBI^{xy1y2y3}) |
| Elastomers | | | | | |
| Butyl Rubber | 22 | 6.6 | 8.6 | 8.6 | 8 |
| Polyvinyl Acetate (PVA) | 13 | 21.3 | 5.0 | 5.0 | 10 |
| Polyisobutylene | 26 | 9.8 | 10.0 | 10.0 | 10 |
| Softeners/Plasticizers/Oils/Waxes | | | | | |
| Rosin esters | 13 | 7.9 | 5.2 | 5.2 | 6 |
| Waxes | 26 | 10.2 | 9.9 | 9.9 | 10 |
| Vegetable oils (hydrogenated) | 0 | 24.6 | 16.6 | 16.6 | 19 |
| Emulsifiers | | | | | |
| Triacetin | 0 | 9.8 | 0 | 0 | 3 |
| Glycerol Monostearate | 0 | 0 | 0 | 7.2 | 2.5 |
| Lecithin | 0 | 0 | 7.2 | 0 | 2.5 |
| Fillers | | | | | |
| Calcium Carbonate | 0 | 9.8 | 37.4 | 37.4 | 29 |
| Totals: | 100 | 100 | 100 | 100 | 100 |

In the example described above, system 2700 is designed such that all of the effluent of mixer 2702 consisting of GBIx is processed simultaneously in three parallel downstream mixers 2704, 2706, 2708. However, it is also contemplated that mixer 2702 may be configured to have a larger production capacity, producing excess effluent consisting of GBIx. Such excess effluent may be processed in additional downstream mixers to produce different gum bases than FGB2, FGB3, FGB4, for example, gum base formulations listed as Representative Gum Bases 4 and 5 which include talc as a filler instead of calcium carbonate. This is possible since the effluent of mixer 2702 consisting of the set of ingredients GBIx do not include any calcium carbonate which may be incomparable with gum base formulations including talc as a filler.

Moreover, mixers 2704, 2706, 2708 can also be configured to produce excess effluents FGB1, FGB2, FGB3 such that each effluent may be used to form a different finished gum including a different gum base having a set of gum base ingredients GBIxy1, GBIxy2, or GBIxy3. Therefore, parallel systems, such as system 2700, enable production of numerous different gum formulations using a single gum mixing system to better respond to fluctuating market demands.

Although system 2700 may be assembled as a process line with mixers 2702, 2704, 2706, 2708, 2710 in a single section of a manufacturing plant, it is also contemplated that all or some of the mixers may be located remotely from one another, either in different sections of the same manufacturing plant or in different manufacturing plants in different cities or even different countries. For example, mixers 2702, 2704, 2706, 2708 may be located in Plant 1 and mixer 2710 may be located in Plant 2. In such implementation, transportation of the effluents from mixers 2704, 2706, 2708 in Plant 1 to mixer 2710 in Plant 2 has to be coordinated as described in the discussions relating to kitting of series mixing systems above. As such, the mixers of Plant 1 may manufacture large quantities of FGB1, FGB2 and FGB3, which can be processed with sets of subsequent gum ingredients to produce finished gums. Alternatively, as illustrated in this example, FGB1, FGB2 and FGB3 may be combined as desired by a downstream user, such as at local Plant 2, to form a separate gum base FGB4.

As it was described with series mixing systems, mixers of parallel systems can process numerous different combinations of ingredients to produce various effluents. For example, mixer 2702 is not limited to producing a gum structure less than a gum base such as GBIx in the example discussed above, but may produce a premix, a compounded elastomer, an elastomer with other gum base ingredients, an elastomer with subsequent gum ingredients, an elastomer with some other gum base ingredients and some subsequent gum ingredients, a gum base, or a gum base with subsequent gum ingredients. Similarly, mixers 2704, 2706, 2708, can also produce any gum structures less than a gum base including a compounded elastomer, an elastomer with other gum base ingredients, an elastomer with subsequent gum ingredients, an elastomer with some other gum base ingredients and some subsequent gum ingredients, a gum base, or a gum base with subsequent gum ingredients. Mixer 2710 can also process different combinations of ingredients to output different effluents including a finished gum.

Further, while the discussed implementation illustrates mixers 2704, 2706, 2708 as running simultaneously and feeding their effluents simultaneously to mixer 2710 as ingredients for the gum structure FGB4, other implementations may have mixers 2704, 2706, 2708 sequentially feeding mixer 2710. As such, the gum structure effluent of mixer 2710 need not be formed by utilizing effluents of all of mixers 2704, 2706, 2708. For example, mixer 2710 may sequentially produce different finished gum formulations by sequentially receiving different gum bases from mixers 2704, 2706, 2708, and processing each gum base with a set of subsequent gum ingredients.

Alternatively, two of three mixers 2704, 2706, 2708 may run simultaneously while the other mixer runs sequentially with the two simultaneously running mixers. For example, mixer 2704 and mixer 2706 may run simultaneously producing two different gum structures, which may feed mixer 2710 simultaneously or sequentially. Mixer 2708 may not run while mixers 2704, 2706 are in operation, and may only run while mixers 2704, 2706 are down for configuration changes, cleaning or other reasons.

Similarly, mixer 2702 may feed mixers 2704, 2706, 2708, sequentially. That is, mixer 2702 may feed a surge tank (not shown), for a set period of time, which holds the effluent of mixer 2702 and continuously feeds mixer 2704. For the next set period of time, mixer 2702 feeds a second surge tank (not shown) which holds the effluent of mixer 2702 and continuously feeds mixer 2706. Finally, mixer 2702 feeds a third surge tank (not shown) which holds the effluent of mixer 2702 and continuously feeds mixer 2708. Alternatively, mixer 2702 may feed two mixers simultaneously and one mixer sequentially to the feeding of the other two mixers.

Further, it is also contemplated that mixers 2704, 2706, 2708 are all identical and form a same gum structure. For example, mixer 2702 may be producing a gum base master batch which is fed to mixers 2704, 2706, 2708, sequentially or simultaneously. Mixers 2704, 2706, 2708 receive the gum base master batch from mixer 2702 and may process it with the same set of gum base ingredients to produce the same gum base.

Alternatively, mixers 2704, 2706, 2708 may produce different gum bases as described above, or may produce different gum structures. For example, mixer 2704 may output a gum base, mixer 2706 may output, a compounded elastomer with at least one subsequent gum ingredient, and mixer 2708 may produce a gum base with at least one subsequent gum base.

### PARALLEL SYSTEM PARTICULAR EXAMPLE 2

A second particular parallel mixing system 2800 is illustrated in FIG. 28. System 2800 is similar to system 2700 in that both systems include three mixers arranged in parallel with each other and series with an upstream mixer and a downstream mixer. However, the parallel mixers 2804, 2806, 2808 of system 2800 are batch mixers rather than continuous mixers 2704, 2706, 2708 of system 2700. The upstream series mixer 2802 and downstream series mixer 2810 remain as continuous mixers. Each mixer 2802, 2804, 2806, 2808, 2810 can be provided with any number of ingredient feeders, and the continuous mixers 2802, 2810 can be configured with any number of feed ports as discussed previously for system 2700 and the series mixing systems.

In some implementations of system 2800, an effluent from a mixer may be recirculated within the system or an effluent of a mixer may be directed to another mixer arranged in parallel with that mixer to extend a mixing time of ingredients or to produce a different output. For example, effluent of mixer 2810 may be recirculated as an ingredient of mixer 2804 or effluent of mixer 2808 may be fed as an ingredient to mixer 2804 and/or mixer 2806.

Mixers of system 2800 may produce the same effluents produced by mixers of system 2700. That is, system 2800 can be configured so that mixer 2802 outputs an effluent consisting of GBIx, and mixers 2804, 2806, 2808, 2810 produce effluents consisting of FGB1, FGB2, FGB3, FGB4, respectively. However, mixers of system 2800 can also produce different effluents. For example, mixer 2802 may produce a gum structure less than a gum base, each one of mixers 2804, 2806, 2808 may output a same finished gum base FGB5, and mixer 2810 may produce a finished gum FG.

In the following particular contemplated implementation of system 2800, mixer 2802 is an extruder configured for high shear dispersive mixing for compounding elastomers with at least one compounding aid. Mixer 2802 processes a set of gum base ingredients GBIx which includes some gum base ingredients, but not all of the gum base ingredients necessary to produce a desired finished gum base. For example, GBIx may consist of butyl rubber, polyvinyl acetate, polyisobutylene, rosin esters, waxes and vegetable oils.

The effluent of mixer 2802 produced by mixing the set of gum base ingredients GBIx is, thus, a gum structure less than a finished gum base as it is void of any fillers. The effluent of mixer 2802 is further processed in batch mixers 2804, 2806, 2808 in separate portions as an ingredient, wherein the effluent including the set of gum base ingredients GBIx is combined with another set of gum base ingredients GBIy to output a finished gum base, FGB5. The effluents of mixers 2804, 2806, 2808, namely FGB5, are then fed to mixer 2810 as ingredients with a set of subsequent gum ingredients SGIz producing a finished gum FG.

Such an implementation may be advantageous where upstream mixer 2802 and downstream mixer 2810 are mixers having large enough capacities to supply multiple midstream mixers and process effluents from those multiple midstream mixers. For example, mixer 2802 may process 1000 kg/hr of GBIx consisting of 89.7 kg/hr butyl rubber, 256.4 kg/hr polyvinyl acetate, 76.9 kg/hr polyisobutylene, 384.6 kg/hr rosin esters, 128.2 kg/hr waxes, and 64.2 kg/hr vegetable oil.

The effluent of mixer 2802 consisting of GBIx is then fed to three parallel downstream batch mixers 2804, 2806, 2808 sequentially according to the capacity of each mixer. For example, when mixer 2804, 2806, 2808 are each equal in its capacity, the effluent of mixer 2802 consisting of GBIx can be first directed to mixer 2804 for 15 minutes to feed 250 kg of the effluent consisting of GBIx. The set of gum base ingredients GBIy including 6 kg of triacetin and 64 kg of talc filler is also added to mixer 2804, then mixer 2804 runs for a batch run time of 20 minutes.

After the effluent of mixer 2802 consisting of GBIx is fed to mixer 2804 for 15 minutes, the effluent including GBIx is directed to mixer 2806 for the next 15 minutes. Again, the same set of additional gum base ingredients GBIy is also added to mixer 2806, in the same amounts as they were added to mixer 2804, which then runs for 20 minutes. The effluent of mixer 2802 including GBIx is then directed to mixer 2808 for the next 15 minutes to prepare batch mixer 2808 in the same manner.

While batch mixer 2806 is running, mixer 2804 finishes its batch, producing 320 kg of FGB5 from a set of gum base ingredients GBIxy including 250 kg of GBIx and 70 kg of GBIy. The effluent FGB5 is then transported to surge tank 2818 which holds FGB5 as an ingredient to be continuously fed to mixer 2810. Once the effluent of mixer 2804 is emptied, mixer 2804 is ready to receive GBIx from mixer 2802 again. The process cycle repeats. A cycle of the contemplated process schedule of system 2800 is summarized in Table 9.

TABLE 9
Process Schedule of System 2800

| Time | Event |
|---|---|
| 00:00 | Mixer 2802 effluent (GBI^{x}) starts to feed mixer 2804; |
| | GBI^{y} also added to mixer 2804. |
| 00:15 | Mixer 2804 starts batch run. |
| | Mixer 2802 effluent (GBI^{x}) starts to feed mixer 2806; |
| | GBI^{y} also added to mixer 2806. |
| 00:30 | Mixer 2806 starts batch run. |
| | Mixer 2802 effluent (GBI^{x}) starts to feed mixer 2808; |
| | GBI^{y} also added to mixer 2808. |
| 00:35 | Mixer 2804 batch finished; the effluent FGB5 |
| | transported to mixer 2810. |
| | Mixer 2804 cleaned (if necessary) for next batch set-up. |
| 00:45 | Mixer 2808 starts batch run. |
| | Mixer 2802 effluent (GBI^{x}) starts to feed mixer 2804; |
| | GBI^{y} also added to mixer 2804. |
| 00:50 | Mixer 2806 batch finished; the effluent FGB5 transported |
| | to mixer 2810. |
| | Mixer 2806 cleaned (if necessary) for next batch set-up. |
| 00:60 | Mixer 2804 starts batch run. |
| | Mixer 2802 effluent (GBI^{x}) starts to feed mixer 2806; |
| | GBI^{y} also added to mixer 2806. |
| 00:65 | Mixer 2808 batch finished; the effluent FGB5 transported |
| | to mixer 2810. |
| | Mixer 2808 cleaned (if necessary) for next batch set-up. |

A batch set-up or batch run may be delayed for many reasons, i.e. mixer clean up, mixer maintenance, etc. For such delays, each of batch mixer 2804, 2806, 2808 are provided with surge tank 2812, 2814, 2816 which can hold the effluent of mixer 2802 including GBIx until the mixer is ready for a batch set-up.

The above discussed schedule provides for a sequential feeding of mixer 2810 from mixers 2804, 2806, 2808 with a rate of 320 kg of FGB5 per every 15 minutes or 1280 kg/hr. A set of subsequent gum ingredients SGIz including 646 kg/hr of sucrose, 216 kg/hr of corn syrup, 22 kg/hr of glycerin, 22 kg/hr of lecithin, 22 kg/hr of flavor, 22 kg/hr of acid, and 22 kg/hr of color is also fed to mixer 2810, wherein 2,152 kg/hr of FG is produced.

The ingredients and their quantities constituting the effluents of mixers 2802, 2804, 2806, 2808, 2810 are summarized in Table 10. More particularly, the quantity of each ingredient in Table 10 is represented in terms of weight percentage of each ingredient relative to the corresponding set of input ingredients. For example, the set of gum base ingredients GBIx is comprised of 9% butyl rubber, 25.6% polyvinyl acetate, 7.7% polyisobutylene, 38.5% rosin esters, 12.8% waxes and 6.4% vegetable oils. As can be seen from comparing Table 10 with Table 2 and Table 3, finished gum base FGB5 is a formulation of Representative Gum Base 4 listed in Table 2, and finished gum FG is a formulation of Finished Gum 9 listed in Table 3.

TABLE 10
Ingredients of Effluents of System 2800

| | | | | | 2810 |
|---|---|---|---|---|---|
| | | 2804 | 2806 | 2808 | FG |
| | 2802 | FGB5 | FGB5 | FGB5 | (GBI^{xy} + |
| Ingredient/Mixers | GBI^{x} | (GBI^{xy}) | (GBI^{xy}) | (GBI^{xy}) | SGI^{x}) |
| Elastomers | | | | | |
| Butyl Rubber | 9.0 | 7.0 | 7.0 | 7.0 | 4.2 |
| Polyvinyl Acetate (PVA) | 25.6 | 20.0 | 20.0 | 20.0 | 11.9 |
| Polyisobutylene | 7.7 | 6.0 | 6.0 | 6.0 | 3.6 |
| Softeners/Plasticizers/ | | | | | |
| Oils/Waxes | | | | | |
| Rosin esters | 38.5 | 30.0 | 30.0 | 30.0 | 17.8 |
| Waxes | 12.8 | 10.0 | 10.0 | 10.0 | 5.9 |
| Vegetable oils | 6.4 | 5.0 | 5.0 | 5.0 | 3.0 |
| (hydrogenated) | | | | | |
| Emulsifiers | | | | | |
| Triacetin | 0 | 2 | 2 | 2 | 1.2 |
| Lecithin | 0 | 0 | 0 | 0 | 0.1 |
| Fillers | | | | | |
| Talc | 0 | 20 | 20 | 20 | 11.9 |
| Bulk Sweeteners | | | | | |
| Sucrose | 0 | 0 | 0 | 0 | 30 |
| Corn Syrup | 0 | 0 | 0 | 0 | 10 |
| Fluids | | | | | |
| Glycerin | 0 | 0 | 0 | 0 | 0.1 |
| Flavor | 0 | 0 | 0 | 0 | 0.1 |
| Acid(s) | 0 | 0 | 0 | 0 | 0.1 |
| Color(s) | 0 | 0 | 0 | 0 | 0.1 |
| Totals: | 100 | 100 | 100 | 100 | 100 |

As it was with other systems described previously, mixers of system 2800 can process various combinations of ingredients to produce many different effluents. That is, each mixer in system 2800 may produce a gum structure other than what is described in the above example. For example mixer 2802 may produce a finished gum base which is supplied to mixers 2804, 2806, 2808, sequentially or simultaneously. Mixers 2804, 2806, 2808 may process the gum base from mixer 2802 with the same or a different set of subsequent gum ingredients to produce the same or different gum structures such as a gum base with some subsequent gum ingredients or a finished gum.

Mixers arranged in parallel 2804, 2806, 2808 of above described implementation are all producing the same finished gum base, FGB5. However, these mixers can produce different finished gum bases, or produce a gum structure other than a finished gum, i.e. mixer 2804 can produce a compounded elastomer with at least one subsequent gum ingredient, while mixers 2806, 2808 may produce some other gum structure such as a gum base with at least one subsequent gum ingredient.

When mixers 2804, 2806, 2808 are producing different finished gum bases and feeding mixer 2810 sequentially, mixer 2810 may produce different finished gums sequentially, each using a different finished gum base as an ingredient. Further, even when mixers 2804, 2806, 2808 produce the same gum structure less than a finished gum, such as the above described implementation, mixer 2810 may sequentially process a different set of subsequent gum ingredients with the effluents of mixers 2804, 2806, 2808 to produce different finished gum formulations sequentially, for example, finished gum formulations including different functional ingredients, different flavors, etc.

Moreover, mixers 2804, 2806, 2808 may simultaneously run to produce a same effluent or different effluents, or two of the three mixers may run simultaneously with the other one running sequentially. For example, mixer 2804 and mixer 2806 may run simultaneously and mixer 2808 may run sequentially with mixers 2804, 2806.

Further, some of the mixers in system 2800 may be remotely located. For example, mixers 2804, 2806, 2808, 2810 may be in a different plant than where the plant mixer 2802 is located. Allowing fillers to be added where finished gums are manufactured may be advantageous since the weight of a gum base master batch such as GBIx is minimized, reducing transportation costs.

### PARALLEL SYSTEM PARTICULAR EXAMPLE 3

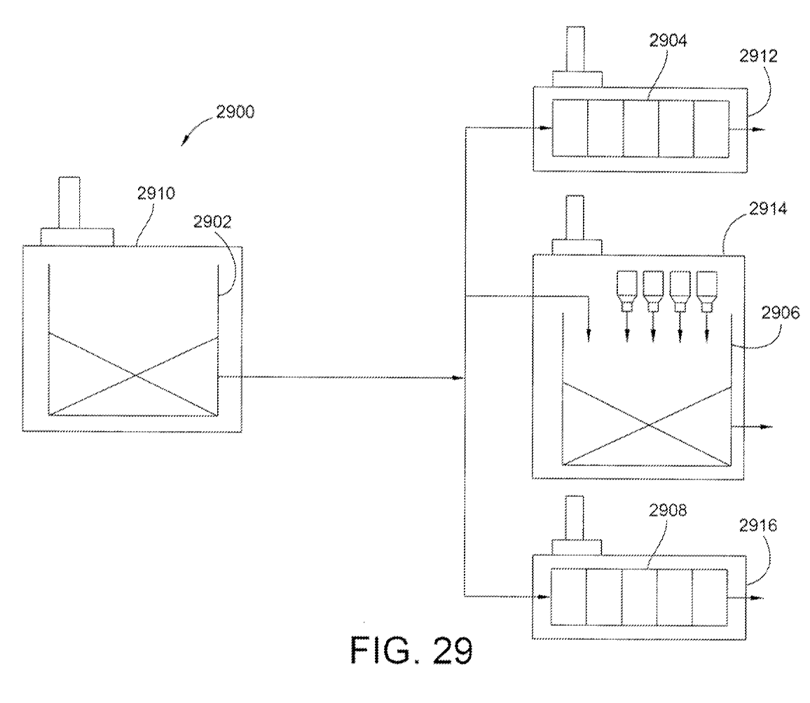

A third contemplated particular parallel mixing system 2900 is illustrated in FIG. 29. System 2900 includes two continuous mixers 2904, 2908 and one batch mixer 2906 arranged in parallel to each other. System 2900 further includes a batch mixer 2902 arranged in series with and upstream of each of the three parallel mixers 2904, 2906, 2908. According to this arrangement, effluent of batch mixer 2902 is used as an ingredient for gum structures that are formed by parallel mixers 2904, 2906, 2908.

In some implementations of system 2900, an effluent from a mixer may be recirculated within the system or an effluent of a mixer may be directed to another mixer arranged in parallel with that mixer to extend a mixing time of ingredients or to produce a different output. For example, effluent of mixer 2906 may be recirculated back into mixer 2906 as an ingredient, or may be fed to mixer 2904 and/or mixer 2908.

A contemplated example of such an implementation is where mixer 2902 produces a large quantity of a gum base master batch, which is then transported in separate portions to downstream mixers in plants in different locations. In this implementation, batch mixer 2902 may process a set of gum base ingredients GBIx to produce a desired gum base master batch including 12.5% styrene-butadiene rubber, 31.25% polyvinyl acetate, 25% rosin esters, 12.5% waxes, 12.5% vegetable oils, and 6.25% of triacetin (all in weight percentage of the desired gum base master batch produced by mixer 2902). This gum base master batch is a gum structure less than a gum base, more particularly, a gum base formulation of Representative Gum Base 3 of Table 3, less calcium carbonate filler. The gum base master batch is made such that it is storable and transportable as described above for a kitting operation.

As shown in FIG. 29, mixer 2902, which produces the gum base master batch, is located in plant 2910. In this implementation, the gum base master batch is transported from plant 2910 to plants 2912, 2914, 2916 in equal portions to be processed in mixer 2904, 2906, 2908, respectively, with additional ingredients to form finished gums. For each of mixers 2904, 2906, 2908, the gum base master batch will constitute 24% by weight of total ingredients processed in the mixer. The other 76% by weight of ingredients include 6% calcium carbonate filler (constituting a set of gum base ingredients GBIy), 25% sucrose, 12% corn syrup, 2% hydrogenated starch hydrolysates, 18% sorbitol, 5% erythritol, 2% glycerin, 5% lecithin, 0.9% flavor, and 0.1% color (constituting a set of subsequent gum ingredients SGIy). As such, 30% by weight of the effluent of each mixer 2904, 2906, 2908 is a gum base including the gum base master batch consisting of GBIx, and the set of gum base ingredients GBIy consisting of calcium carbonate. It is noted that the effluents of mixers 2904, 2906, 2908, which are finished gum FG, are a gum formulation of Finished Gum Composition 8 of Table 3.

Such an implementation is advantageous where a gum base master batch is produced in large quantities at a central plant and transported to different locations for producing finished gums according to local market demand. Producing a gum base master batch rather than a gum base and adding a filler at local plants is also advantageous as it reduces bulk weight of transportation and may be cost effective as the bulk filler ingredients may be acquired locally at a lower cost.

The ingredients and their quantities in weight percent constituting the effluent of mixer 2902, which is gum base master batch GBMB, and the effluents of mixers 2904, 2906, 2908, which are finished gum, are summarized in Table 11.

TABLE 11
Ingredients of Effluents of System 2900

| | | 2904 | 2906 | 2908 |
|---|---|---|---|---|
| | 2902 | FG | FG | FG |
| | GBMB | (GBI^{xy} + | (GBI^{xy} + | (GBI^{xy} + |
| Ingredient/Mixers | GBI^{x} | SGI^{y}) | SGI^{y}) | SGI^{y}) |
| Elastomers | | | | |
| Styrene-Butadiene Rubber | 12.5 | 3 | 3 | 3 |
| Polyvinyl Acetate (PVA) | 31.25 | 7.5 | 7.5 | 7.5 |
| Softeners/Plasticizers/ | | | | |
| Oils/Waxes | | | | |
| Rosin esters | 25 | 6 | 6 | 6 |
| Waxes | 12.5 | 3 | 3 | 3 |
| Vegetable oils | 12.5 | 3 | 3 | 3 |
| (hydrogenated) | | | | |
| Emulsifiers | | | | |
| Triacetin | 6.25 | 1.5 | 1.5 | 1.5 |
| Lacithin | 0 | 5 | 5 | 5 |
| Fillers | | | | |
| Calcium Carbonate | 0 | 6 | 6 | 6 |
| Bulk Sweeteners | | | | |
| Sucrose | 0 | 25 | 25 | 25 |
| Corn Syrup | 0 | 12 | 12 | 12 |
| Hydrogenated Starch | 0 | 2 | 2 | 2 |
| Hydrolysates | | | | |
| Sorbitol | 0 | 18 | 18 | 18 |
| Erythritol | 0 | 5 | 5 | 5 |
| Fluids | | | | |
| Glycerin | 0 | 2 | 2 | 2 |
| Flavor | 0 | 0.9 | 0.9 | 0.9 |
| Color(s) | 0 | 0.1 | 0.1 | 0.1 |
| Totals: | 100 | 100 | 100 | 100 |

While the above-described implementation of system 2900 is configured such that all three downstream parallel mixers produce the same finished gum formulation, it is also contemplated that each of downstream parallel mixers produce different finished gum formulations. For example, mixer 2904 may produce a sugarless finished gum formulation only including polyol bulk sweeteners such as sorbitol, xylitol, isomalt, etc., while mixer 2906 is outputting a finished gum including a sugar, and mixer 2908 is producing a yet different sugarless finished gum formulation including polyols and some functional ingredients such as menthol. In another implementation, mixers 2904, 2906, 2908 may produce finished gum formulations which may include the same ingredients except that they may include different flavors, colors or sensate ingredients such as cooling agents, warming agents, tingling agents, etc.

Moreover, other implementations of system 2900 may be designed to produce other gum structures, for example, one of the downstream parallel mixer may produce a gum base while other two mixers produce a gum base including some subsequent gum ingredients. Further, the upstream mixer 2902 may produce a different gum structure such as a finished gum base which feeds mixers 2904, 2906, 2908, sequentially or simultaneously to produce the same gum structure such as the finished gum in the above described implementation, or different gum structures, i.e. mixer 2904 may produce a gum base with a set of subsequent gum ingredients, mixer 2906 may produce a finished gum base which is different than the gum base from 2902, and mixer 2908 may produce a finished gum.

When one or more downstream mixers 2904, 2906, 2908 produce a gum structure less than a finished gum, one or more mixers arranged in series and downstream from mixers 2904, 2906, 2908 may be added to system 2900 to produce one or more finished gums. Of course, all or some of mixers in system 2900 may be located in the same plant. Mixer 2902 may feed mixers 2904, 2906, 2908 simultaneously or sequentially. Similarly, mixers 2904, 2906, 2908 may output effluents simultaneously or sequentially.

### PARALLEL SYSTEM PARTICULAR EXAMPLE 4

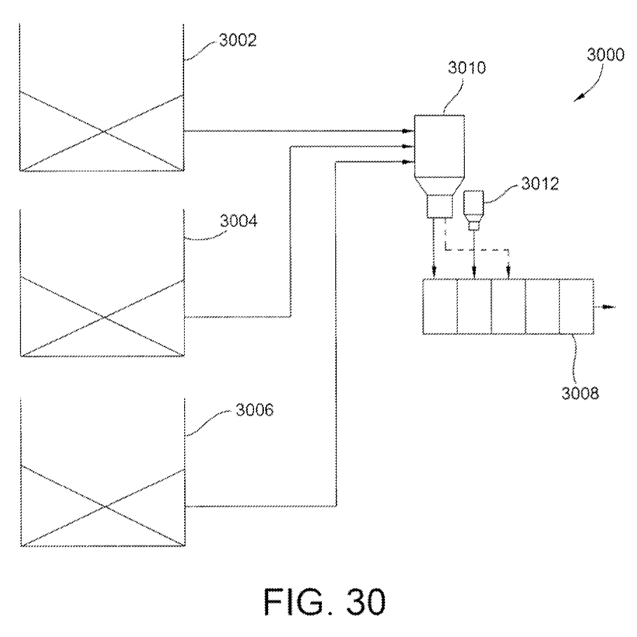

A fourth particular parallel mixing system 3000 is illustrated in FIG. 30. System 3000 includes three batch mixers 3002, 3004, 3006 arranged in parallel with each other. System 3000 further includes a continuous mixer 3008 in series with and downstream of each of the three parallel mixers 3002, 3004, 3006. In system 3000, effluents of the parallel mixers 3002, 3004, 3006 are used as ingredients for a gum structure formed in mixer 3008.

In some implementations of system 3000, an effluent from a mixer may be recirculated within the system or an effluent of a mixer may be directed to another mixer arranged in parallel with that mixer to extend a mixing time of ingredients or to produce a different output. For example, effluent of mixer 3008 may be recirculated as an ingredient of mixer 3002, 3004, and/or 3006, or effluent of mixer 3002 may be fed as an ingredient to mixer 3004 and/or mixer 3006.

In a contemplated implementation of gum mixing system 3000, batch mixers 3002, 3004, 3006 form a gum structure which is less than a gum base including a subsequent gum ingredient from a set of gum base ingredients GBIx and a set of subsequent gum ingredients SGIx. The effluents from mixers 3002, 3004, 3006 are then transported to surge tank 3010 to be continuously fed to mixer 3008. Mixer 3008 receives the effluents from mixers 3002, 3004, 3006 along with a set of gum base ingredients GBIy and a set of subsequent gum ingredients SGIy to produce a finished gum FG.

Such implementation may be advantageous because existing batch mixers can be combined as parallel mixers to sequentially feed a downstream, high capacity, continuous mixer, such as mixer 3008 in system 3000.

In the illustrated example, mixers 3002 and 3004 are smaller capacity batch mixers than mixer 3006. The smaller capacity mixers 3002, 3004 are paired and then the combination acts in parallel with mixer 3006. In this case, batches can be scheduled so that mixers 3002, 3004 are running sequentially with mixer 3006. That is, mixers 3002, 3004 can start their batches first, and while those batches are in progress, mixer 3006 is prepared for its batch run. When mixers 3002, 3004 are completed with their batches, mixer 3006 can start its batch, and while mixer 3006 batch is running, effluents of mixers 3002, 3004 are emptied and transported to mixer 3008. Then mixers 3002, 3004 are cleaned, if necessary, and prepared for the next batchand the process cycle repeats. A cycle of the contemplated process schedule for such implementation of system 3000 is summarized in Table 12.

TABLE 12
Process Schedule of System 3000

| Time | Event |
|---|---|
| 00:00 | Mixers 3002, 3004 start batches. |
| | Mixer 3006 batch set-up. |
| 00:30 | Mixers 3002, 3004 complete batches. |
| | Mixer 3006 starts batch. |
| | Mixers 3002, 3004 emptied; effluents transported to |
| | mixer 3008; mixers 3002, 3004 batch set-up. |
| 00:60 | Mixer 3006 completes batch. |
| | Mixers 3002, 3004 start batches. |
| | Mixer 3006 emptied; effluent transported to mixer |
| | 3008; mixer 3006 batch set-up. |
| 00:90 | Mixers 3002, 3004 complete batches. |
| | Mixer 3006 starts batch. |
| | Mixers 3002, 3004 emptied; effluents transported to |
| | mixer 3008; mixers 3002, 3004 batch set-up. |

The process schedule of Table 12 provides a sequential feed of mixer 3008 from mixers 3002, 3004 and mixer 3006 in 30 minute intervals. In one such implementation, each of mixers 3002, 3004 is 50% capacity of mixer 3006. In other words, mixers 3002, 3004 combined supply the same amount of effluent as mixer 3006.

For example, each of mixers 3002, 3004 may process, per batch, a set of gum base ingredients GBIx including 7 kg butyl rubber, 20 kg polyvinyl acetate, 13 kg polyisobutylene, 5 kg rosin esters, 5 kg waxes, 25 kg vegetable oil, and a set of subsequent gum ingredients SGIx consisting of 196.7 kg sorbitol. In such an example, each of mixers 3002, 3004 produces 271.7 kg of a gum structure which is less than a gum base including a subsequent gum ingredient consisting of GBIx+SGIx. Therefore, mixers 3002 and 3004 combined provide 543.4 kg of effluent consisting of GBIx+SGIx to mixer 3008 every 30 minutes (i.e. each batch) according to the process schedule of Table 12.

Similarly, mixer 3006 may process the same set of gum base ingredients GBIx and the same set of subsequent gum ingredients SGIx, but in double quantities, i.e. 14 kg of butyl rubber, 40 kg of polyvinyl acetate, 26 kg of polyisobutylene, 10 kg of rosin esters, 10 kg of waxes, 50 kg of vegetable oil, and 393.4 kg of sorbitol, producing 543.4 kg of a gum structure, which is less than a gum base including a subsequent gum ingredient consisting of GBIx+SGIx. As such, mixer 3006 also provides 543.4 kg of effluent consisting of GBIx+SGIx to mixer 3008 every 30 minutes according to the process schedule of Table 12.

The effluents from mixers 3002, 3004, 3006 are then transported to surge tank 3010 for continuous feed to mixer 3008. Surge tank 3010 receives 543.4 kg of effluent consisting of GBIx+SGIx from mixers 3002, 3004, and mixer 3006, sequentially, every 30 minutes. Surge tank 3010 holds the effluent for continuous feeding of the effluent along with the set of gum base ingredients GBIy and the set of subsequent gum ingredients SGIy to mixer 3008. In this example, surge tank 3010 continuously feeds 1086.8 kg/hr of GBIx+SGIx to mixer 3008, as other ingredient feeders, such as ingredient feeder 3012, feed the set of gum base ingredients GBIy consisting of 20 kg/hr of lecithin, 80 kg/hr of talc, and the set of subsequent gum ingredients SGIy including 13.4 kg/hr of hydrogenated starch hydrolysates, 13.4 kg/hr of glycerin, 66.6 kg/hr of lecithin, 50.6 kg/hr of flavor, 2.6 kg/hr of color, producing 1333.4 kg/hr of finished gum FG, which is a formulation of Finished Gum Composition 10 in Table 3.

The ingredients and their quantities constituting the effluents of mixers 3002, 3004, 3006, 3008 are summarized in Table 13. More particularly, the quantity of each ingredient of the gum base in Table 13 is represented in terms of weight percentage of each ingredient relative to the corresponding set of input ingredients. As can be seen from comparing Table 13 with Table 2 and Table 3, finished gum FG is a formulation of Finished Gum Composition 10 of Table 3, which includes 30% of gum base which is a formulation of Representative Gum Base 5 of Table 2.

TABLE 13
Ingredients of Effluents of System 3000

| | 3002 | 3004 | 3006 | 3008 (FG) |
|---|---|---|---|---|
| | GBI^{x} + | GBI^{x} + | GBI^{x} + | GBI^{xy} + |
| Ingredient/Mixers | SGI^{x} | SGI^{x} | SGI^{x} | SGI^{xy} |
| Elastomers | | | | |
| Butyl Rubber | 2.6 | 2.6 | 2.6 | 2.1 |
| Polyvinyl Acetate (PVA) | 7.4 | 7.4 | 7.4 | 6.0 |
| Polyisobutylene | 4.8 | 4.8 | 4.8 | 3.9 |
| Softeners/Plasticizers/ | | | | |
| Oils/Waxes | | | | |
| Rosin esters | 1.8 | 1.8 | 1.8 | 1.5 |
| Waxes | 1.8 | 1.8 | 1.8 | 1.5 |
| Vegetable oils (hydrogenated) | 9.2 | 9.2 | 9.2 | 7.5 |
| Emulsifiers | | | | |
| Lacithin | 0 | 0 | 0 | 6.5 |
| Fillers | | | | |
| Talc | 0 | 0 | 0 | 6.0 |
| Bulk Sweeteners | | | | |
| Hydrogenated Starch | 0 | 0 | 0 | 1.0 |
| Hydrolysates | | | | |
| Sorbitol | 72.4 | 72.4 | 72.4 | 59.0 |
| Fluids | | | | |
| Glycerin | 0 | 0 | 0 | 1.0 |
| Flavor | 0 | 0 | 0 | 3.8 |
| Color(s) | 0 | 0 | 0 | .2 |
| Totals: | 100 | 100 | 100 | 100 |

As it was with systems 2700, 2800, 2900, each of mixers in system 3000 can process numerous different combinations of gum ingredients to output different effluents. For example, in one implementation, mixer 3002 may produce a compounded elastomer, mixer 3004 may produce a finished gum base, and mixer 3006 may produce a gum base master batch which includes compounded elastomer with some additional gum base ingredients. Mixers 3002, 3004, 3006 may all run simultaneously or sequentially, or two of three mixers may run simultaneously at a give time.

Mixer 3008 may be fed with effluents of mixers 3002, 3004, 3006 simultaneously or sequentially via a combination of surge tanks and/or ingredient feeders. For example, mixer 3008 may process the compounded elastomer from mixer 3002 with a set of gum base ingredients for a period of time to produce a finished gum base. Next, mixer 3008 may process the finished gum base with a set of subsequent gum ingredients to produce a finished gum for a period of time. Finally, mixer 3008 may process the gum base master batch from mixer 3006 with a set of subsequent gum ingredients to produce a gum base master batch with some subsequent gum ingredients for a period of time, and the sequential process cycles.

Alternatively, some or all of effluents from mixers 3002, 3004, 3006 may be fed to mixer 3008 simultaneously. For example, the compounded elastomer from mixer 3002 and the gum base master batch from mixer 3006 may be simultaneously fed to mixer 3008 as ingredients wherein other gum ingredients are added and processed to produce a gum structure such as a finished gum base or a finished gum.

Similar to other systems, some or all of mixers in system 3002 may be located in different parts of a plant or different plants.

### PARALLEL SYSTEM PARTICULAR EXAMPLE 5

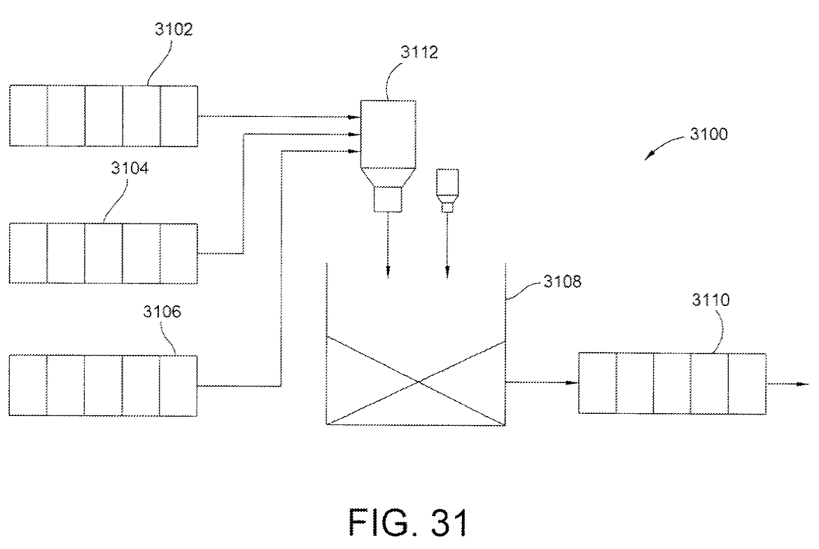

A fifth particular parallel mixing system is illustrated in FIG. 31. System 3100 is different from system 3000 in that it includes three parallel mixers 3102, 3104, 3106 that are continuous mixers rather than batch mixers, such as mixers 3002, 3004, 3006 of system 3000. System 3100 further includes a batch mixer 3108 in series with and downstream of each of the three parallel mixers 3102, 3104, 3106, and a continuous mixer 3110 in series with and downstream of mixer 3108. In system 3100, effluents of the parallel mixers 3102, 3104, 3106 are used as ingredients for a gum structure formed in mixer 3108, which then is used as an ingredient of mixer 3110.

In some implementations of system 3100, an effluent from a mixer may be recirculated within the system or an effluent of a mixer may be directed to another mixer arranged in parallel with that mixer to extend a mixing time of ingredients or to produce a different output. For example, effluent of mixer 3110 may be recirculated as an ingredient of mixer 3108 or effluent of mixer 3102 may be fed as an ingredient to mixer 3104 and/or mixer 3106.

In a particular contemplated implementation of gum mixing system 3100, mixers 3102, 3104, 3106 may form a gum structure which is less than a gum base from a set of gum base ingredients GBIx. Effluents from mixers 3102, 3104, 3106 are then transported to surge tank 3121 to be held until mixer 3108 is ready for a batch set-up, such as while mixer 3108 is mixing a previously loaded set of ingredients. Mixer 3108 combines the effluent consisting of GBIx with an additional set of gum base ingredients GBIy to produce a desired finished gum base FGB. The effluent of 3108 FGB is then transported to surge tank 3114 for continuous feed to mixer 3110, wherein FGB is processed with a set of subsequent gum ingredients SGIx, producing a finished gum FG.

Such an implementation may be advantageous where the elastomer compounding portion of the gum making process, which may be the most time consuming step of a batch gum making process, is performed by multiple continuous mixers to reduce the time required for the overall gum making process. For example, an elastomer compounding process may require 30 minutes of batch run time to produce 100 kg of a compounded elastomer in a batch mixer. Such process time can be reduced by using continuous parallel mixers, such as mixers 3102, 3104, 3106, which may process 100 kg of the compounded elastomer in 10 minutes when combined.

In one such implementation, each of mixers 3102, 3104, 3106 may continuously compound 200 kg/hr of elastomer by processing the set of gum base ingredients GBIx consisting of 36.4 kg/hr butyl rubber, 18.2 kg/hr polyvinyl acetate, 36.4 kg/hr polyisobutylene, 18.2 kg/hr rosin esters, 36.4 kg/hr wax, and 54.4 kg/hr vegetable oil. Thus, surge tank 3112 is supplied with 600 kg/hr of effluents consisting of GBIx from mixers 3102, 3104, 3106. Surge tank 3112 holds the effluents until mixer 3108 is ready for a batch set-up and delivers the effluents, which is then further processed with an additional set of gum base ingredients GBIy in mixer 3108 to produce a finished gum base FGB.

In this implementation, mixer 3108 may start a new batch every 20 minutes. A batch of mixer 3108 can include 200 kg of GBIx and 163.7 kg of GBIy consisting of 18.2 kg triacetin and 145.5 kg calcium carbonate. The batch of mixer 3108 runs for 18 minutes producing finished gum base FGB which is a formulation of Representative Gum Base 1 in Table 2. Once the batch is completed, effluent FGB is delivered to surge tank 3114 for continuous feed of FGB to mixer 3110, and mixer 3108 is prepared for the next batch. In this example, the batch cycle is scheduled every 20 minutes.

Surge tank 3114 thus receives 363.7 kg of FGB every 20 minutes from mixer 3108, or 1091.1 kg/hr of FGB. Therefore, mixer 3110 can receive 1091.1 kg/hr of FGB and 727.5 kg/hr of the set of subsequent gum ingredients SGIz consisting of 545.6 kg/hr sucrose, 90.9 kg/hr corn syrup, 18.2 kg/hr glycerin, 18.2 kg/hr lecithin, 36.4 kg/hr flavor, 16.4 kg/hr acid, and 1.8 kg/hr color to produce 1818.6 kg/hr of finished gum FG.

The ingredients and their quantities constituting the effluents of mixers 3102, 3104, 3106, 3108, 3110 are summarized in Table 14. More particularly, the quantity of each ingredient in Table 14 is represented in terms of weight percentage of each ingredient relative to the corresponding set of input ingredients. For example, a set of gum base ingredients GBIx is comprised of 18.2% butyl rubber, 9.1% polyvinyl acetate, 18.2% polyisobutylene, 9.1% rosin esters, 18.2% waxes and 27.2% vegetable oils. As can be seen from comparing Table 14 with Table 2 and Table 3, finished gum base FGB is a formulation of Representative Gum Base 1 listed in Table 2, and finished gum FG is a formulation of Finished Gum 6 listed in Table 3.

TABLE 14
Ingredients of Effluents of System 3100

| | | | | 3108 | 3110 |
|---|---|---|---|---|---|
| | 3102 | 3104 | 3106 | FGB | FG |
| Ingredient/Mixers | GBI^{x} | GBI^{x} | GBI^{x} | (GBI^{xy}) | (GBI^{xy} + SGI^{z}) |
| Elastomers | | | | | |
| Butyl Rubber | 18.2 | 18.2 | 18.2 | 10 | 6 |
| Polyvinyl Acetate (PVA) | 9.1 | 9.1 | 9.1 | 5 | 3 |
| Polyisobutylene | 18.2 | 18.2 | 18.2 | 10 | 6 |
| Softeners/Plasticizers/ | | | | | |
| Oils/Waxes | | | | | |
| Rosin esters | 9.1 | 9.1 | 9.1 | 5 | 3 |
| Waxes | 18.2 | 18.2 | 18.2 | 10 | 6 |
| Vegetable oils | 27.2 | 27.2 | 27.2 | 15 | 9 |
| (hydrogenated) | | | | | |
| Emulsifiers | | | | | |
| Triacetin | 0 | 0 | 0 | 5 | 3 |
| Lecithin | 0 | 0 | 0 | 0 | 1 |
| Fillers | | | | | |
| Calcium Carbonate | 0 | 0 | 0 | 40 | 24 |
| Bulk Sweeteners | | | | | |
| Sucrose | 0 | 0 | 0 | 0 | 30 |
| Corn Syrup | 0 | 0 | 0 | 0 | 5 |
| Fluids | | | | | |
| Glycerin | 0 | 0 | 0 | 0 | 1 |
| Flavor | 0 | 0 | 0 | 0 | 2 |
| Acid(s) | 0 | 0 | 0 | 0 | 0.9 |
| Color(s) | 0 | 0 | 0 | 0 | 0.1 |
| Totals: | 100 | 100 | 100 | 100 | 100 |

As it was with systems 2700, 2800, 2900, 3000, each of mixers in system 3100 can process numerous different combinations of gum ingredients to output different effluents, simultaneously or sequentially. For example, in one implementation, mixer 3102 may produce a compounded elastomer, mixer 3104 may produce a finished gum base, and mixer 3106 may produce a gum base master batch which includes compounded elastomer with some additional gum base ingredients. Mixers 3102, 3104, 3106 may run all simultaneously or sequentially or two of three mixers may run simultaneously at a give time.

Mixer 3108 may process effluents from mixers 3102, 3104, 3106 simultaneously or sequentially. For example, mixer 3108 may process each effluent of mixers 3102, 3104, 3106 sequentially with additional gum ingredients to sequentially output different gum structures which are less than a finished gum, or mixer 3108 may simultaneously process two of effluents of mixers 3102, 3104, 3106 with or without additional gum ingredients to produce gum structures less than a finished gum. Finally, mixer 3108 may simultaneously process all three effluents from mixers 3102, 3104, 3106 with or without additional gum ingredients to produce a gum structure less than a finished gum. According to the effluent supplied by mixer 3108 and additional gum ingredients, mixer 3110 may produce many different gum structures.

As it was with systems previously discussed, mixers of system 3100 may be located in one or more different plants.

### PARALLEL SYSTEM PARTICULAR EXAMPLE 6

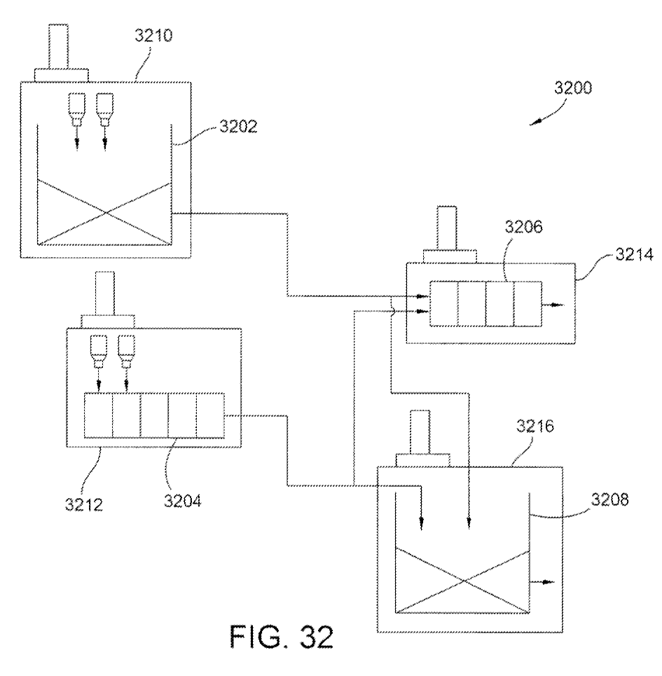

A sixth particular parallel mixing system is illustrated in FIG. 32. System 3200 includes a batch mixer 3202 and a continuous mixer 3204 arranged in parallel with each other. System 3200 further includes a continuous mixer 3206 and a batch mixer 3208 arranged in parallel with each other and in series with and downstream of each of the parallel mixers 3202, 3204. In system 3200, effluents of the parallel mixers 3202, 3204 can be used, together or sequentially, as ingredients for gum structures formed in downstream mixers 3206, 3208. As indicated previously, this type of mixing system can provide significant redundancy advantages should one mixer need cleaning or maintenance, and alternatively provide the best mixing process for mixing different sets of gum ingredients.

In some implementations of system 3200, an effluent from a mixer may be recirculated within the system or an effluent of a mixer may be directed to another mixer arranged in parallel with that mixer or an effluent from a mixer may be direct to a downstream mixer of a mixer arranged in parallel with that mixer to extend a mixing time of ingredients or to produce a different output. For example, effluent of mixer 3206 may be recirculated as an ingredient of mixer 3202 and/or mixer 3204. Further, effluent of mixer 3202 may be fed as an ingredient to mixer 3208 which is arranged in series and downstream of mixer 3204 arranged in parallel with mixer 3202.

In a particular contemplated implementation of gum mixing system 3200, mixers 3202, 3204, 3206, 3208 may be located in different plants 3210, 3212, 3214, 3216. Plant 3210 may have a batch mixer 3202 which may produce a gum base master batch, GBMB1, and plant 3212 may have a continuous mixer 3204 which may produce a different gum base master batch, GBMB2. A mixer is selected to maximize process efficiency and product quality. For example, ingredients of GBMB 1 may process better in a batch mixer to produce a more consistent gum base master batch, while ingredients of GBMB2 may compound better in a continuous mixer. Alternatively, the location of plant 3210 may be closer to plant 3214 which utilizes a larger quantity of GBMB1 than the plant 3216. In such a case, mixer 3202 of plant 3210 is scheduled to produce GBMB 1 so that transportation costs may be reduced.

In one example of a contemplated implementation, mixer 3202 produces a 600 kg batch of gum base master batch GBMB1 from a set of gum base ingredients GBIx1 consisting of 80 kg butyl rubber, 100 kg polyvinyl acetate, 100 kg polyisobutylene, 200 kg rosin esters, 50 kg wax, 50 kg vegetable oil and 20 kg triacetin. A batch cycle may be scheduled such that mixer 3202 produces 600 kg/hr of GBMB1, for example, 45 minutes of batch run coupled with 15 minutes of batch preparation time. Similarly, mixer 3204 may produce 880 kg/hr of gum base master batch GBMB2 from continuous feed of a set of gum base ingredients GBIx2 consisting of 80 kg/hr butyl rubber, 200 kg/hr polyvinyl acetate, 100 kg/hr polyisobutylene, 100 kg/hr rosin esters, 100 kg/hr wax, 250 kg/hr vegetable oil and 50 kg/hr triacetin.

In this contemplated implementation, the downstream mixers 3206, 3208 receive effluents of mixers 3202, 3204, sequentially, to produce different finished gum bases. Furthermore, each of mixers 3206, 3208 may be dedicated such that mixer 3206 never processes a particular ingredient which is processed in mixer 3208, and mixer 3208 never processes a different particular ingredient which is processed in mixer 3206. For example, mixer 3206 may only produce finished gum bases which include calcium carbonate as a filler, and mixer 3208 may only produce finished gum bases which include talc as a filler. Such implementation is advantageous since a risk of contamination by processing incompatible ingredients in a same mixer can be eliminated.

Mixers 3206, 3208 can be scheduled according to a local market demand to produce different formulations of finished gum bases. For example, if the local demand of plant 3214 is with a finished gum utilizing a formulation of Representative Gum Base 1 of Table 2, GBMB1 is delivered to plant 3214 from plant 3210. Then, mixer 3206 processes GBMB1 with another a set of gum base ingredients GBIy1 to produce finished gum base FGB1. Feed rates of ingredients are adjusted according to a desired output rate. For example, to produce 1000 kg/hr of finished gum base FGB1, mixer 3206 may process 600 kg/hr GBMB1 with 50 kg/hr vegetable oil, 10 kg/hr triacetin, and 340 kg/hr calcium carbonate.

However, the local market demand may fluctuate for many reasons. For example, it may fluctuate seasonally. Thus, when the local demand of plant 3214 is with a different finished gum base, such as a formulation of Representative Gum Base 2 of Table 2, GBMB2 is delivered to plant 3214 from plant 3212. Then, mixer 3206 processes GBMB2 with another set of gum base ingredients GBIy2 to produce finished gum base FGB2. Feed rates of ingredients are adjusted according to a desired output rate. For example, to produce 1000 kg/hr of finished gum base FGB2, mixer 3206 may process 880 kg/hr GBMB2 with 20 kg/hr triacetin and 100 kg/hr calcium carbonate.

Similarly, mixer 3208 in plant 3216 can be scheduled to produce different finished gum bases for various reasons. Mixer 3208 may produce a formulation of Representative Gum Base 4 with gum base master batch GBMB1 from mixer 3202. In one such implementation, a batch of mixer 3208 may include 600 kg GBMB1, 150 kg rosin esters, 50 kg waxes and 20 kg talc to produce 1000 kg of finished gum base FGB3. Alternatively, mixer 3008 may produce 1000 kg batch of finished gum base FGB4, which is a formulation of Representative Gum Base 5, with 880 kg of GBMB2 from mixer 3204 and 120 kg of talc.

The ingredients and their quantities constituting the effluents of mixers 3202, 3204, 3206, 3208 are summarized in Table 15. More particularly, the quantity of each ingredient in Table 15 is represented in terms of weight percentage of each ingredient relative to the corresponding set of input ingredients. As can be seen from comparing Table 15 with Table 2, finished gum base FGB1 is a formulation of Representative Gum Base 1, finished gum base FGB2 is a formulation of Representative Gum Base 2, finished gum base FGB3 is a formulation of Representative Gum Base 4, and finished gum base FGB4 is a formulation of Representative Gum Base 5 listed in Table 2.

TABLE 15
Ingredients of Effluents of System 3200

| | 3202 | 3204 | 3206 | 3206 | 3208 | 3208 |
|---|---|---|---|---|---|---|
| Ingredient/Mixers | GBMB1 | GBMB2 | FGB1 | FGB2 | FGB3 | FGB4 |
| Elastomers | | | | | | |
| Butyl Rubber | 13.3 | 9.1 | 8 | 8 | 8 | 8 |
| Polyvinyl Acetate (PVA) | 16.7 | 22.7 | 10 | 20 | 10 | 20 |
| Polyisobutylene | 16.7 | 11.4 | 10 | 10 | 10 | 10 |
| Softener/Plasticizer/Oil/Wax | | | | | | |
| Rosin esters | 33.3 | 11.4 | 20 | 10 | 35 | 10 |
| Waxes | 8.3 | 11.4 | 5 | 10 | 10 | 10 |
| Vegetable oils (hydrogenated) | 8.3 | 28.4 | 10 | 25 | 5 | 25 |
| Emulsifiers | | | | | | |
| Triacetin | 3.4 | 5.6 | 3 | 7 | 2 | 5 |
| Fillers | | | | | | |
| Calcium Carbonate | 0 | 0 | 34 | 10 | 0 | 0 |
| Talc | 0 | 0 | 0 | | 20 | 12 |
| Totals: | 100 | 100 | 100 | 100 | 100 | 100 |

As it was with systems 2700, 2800, 2900, 3000, 3100, each of mixers in system 3200 can process numerous different combinations of gum ingredients to output different effluents, simultaneously or sequentially. For example, in one implementation, mixer 3202 may produce a finished gum base and mixer 3204 may run simultaneously with mixer 3202 to produce a different finished gum base. Both finished gum bases from mixers 3202, 3204 may simultaneously feed mixer 3206, for a set period of time, wherein a set of subsequent gum ingredients is processed with the finished gum bases to produce a finished gum. Next, the finished gum bases from mixers 3202, 3204 are directed to mixer 3208 for a set period of time wherein a set of subsequent gum ingredients different than the set added to mixer 3206 is processed with the gum bases to produce a yet different finished gum.

Alternatively, mixer 3202 may produce a compounded elastomer which feeds mixers 3206 and 3208 simultaneously wherein mixer 3206 and mixer 3208 may produce the same or different gum structures. In parallel with mixer 3202, mixer 3204 may produce a finished gum base with a set of subsequent gum ingredients, which is fed to mixer 3206 and mixer 3208 simultaneously in sequence with the effluent of mixer 3202, wherein mixers 3206, 3208 may produce the same or different gum structures.

Although the above-discussed implementation illustrated each mixer as being located in different plants, one or more or all mixers of system 3200 may be located in the same plant.

### PARALLEL SYSTEM PARTICULAR EXAMPLE 7

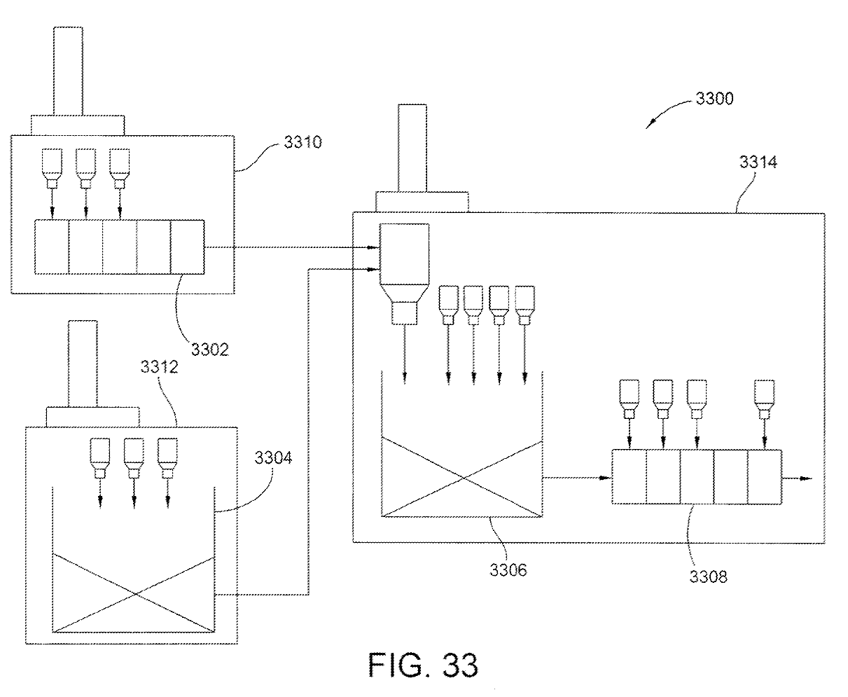

A further particular parallel mixing system 3300 is illustrated in FIG. 33. System 3300 includes a continuous mixer 3302 and a batch mixer 3304 arranged in parallel with each other. System 3300 further includes a batch mixer 3306 arranged in series with and downstream of each of the parallel mixers 3302, 3304, and a continuous mixer 3308 arranged in series with and downstream of mixer 3306. In system 3300, effluents of the parallel mixers 3302, 3304 can be used, together or sequentially, as ingredients for a gum structure formed in mixer 3306, which is then used as an ingredient in mixer 3308.

In some implementations of system 3300, an effluent from a mixer may be recirculated within the system or an effluent of a mixer may be directed to another mixer arranged in parallel with that mixer to extend a mixing time of ingredients or to produce a different output. For example, effluent of mixer 3308 may be recirculated as an ingredient of mixer 3306 or effluent of mixer 3302 may be fed as an ingredient to mixer 3304.

In a particular contemplated implementation of gum mixing system 3300, mixer 3302 may be located in plant 3310, mixer 3304 may be located in plant 3312, and mixers 3306 and 3308 may be located in plant 3314. Mixer 3302 of plant 3310 and mixer 3304 of plant 3312 may produce a same gum base master batch GBMB. Such implementation may be advantageous, where plants 3310 and 3312 supply gum base master batch GBMB to multiple plants, plant 3314 being one of them, and plant 3314 can receive delivery from either plant 3310 or 3312, depending on the availability of supply in plants 3310, 3312.

In such implementation, each of mixers 3302, 3304 can produce the same gum base master batch GBMB from a set of gum base ingredients GBIx consisting of 9.1% butyl rubber, 22.7% polyvinyl acetate, 11.4% polyisobutylene, 11.4% rosin esters, 11.4% waxes, 28.4% vegetable oils and 5.6% triacetin, all by weight percent relative to total weight of GBIx. Production of GBMB in plants 3310 and 3312 can fluctuate for many different reasons such as raw ingredient availability in the area. Alternatively, operation of one of mixers 3302, 3304 may be shut down for maintenance or periodically according to market demand. Therefore, mixer 3306 may receive shipments from both plants 3310, 3312, or from one of the plants 3310, 3312, at any given time.

In plant 3314, mixer 3306 may process gum base master batch GBMB from mixers 3302 and/or 3304 with an additional set of gum base ingredients GBIy consisting of talc. A batch of mixer 3306 may include 88% by weight of GBMB and 12% by weight of talc, producing finished gum base FGB which is a formulation of Representative Gum Base 5 in Table 2.

Finally, effluent of mixer 3306, namely FGB, is fed to mixer 3308 wherein FGB is mixed with a set of subsequent gum ingredient SGIz to produce finished gum FG. To produce a formulation of Finished Gum Composition 10 of Table 3, mixer 3308 can process 30% FGB with 1% hydrogenated starch hydrolysates, 59% sorbitol, 1% glycerin, 5% lecithin, 3.8% flavor and 0.2% color, all by weight percentage. Feed rates of ingredients can be adjusted according to a desired output rate as described above for continuous mixers in other parallel mixing systems.

The ingredients and their quantities constituting the effluents of mixers 3302, 3304, 3306, 3308 are summarized in Table 16. More particularly, the quantity of each ingredient in Table 16 is represented in terms of weight percentage of each ingredient relative to the corresponding set of input ingredients. As can be seen from comparing Table 16 with Table 2 and Table 3, finished gum FG is a formulation of Finished Gum Composition 10 of Table 3, and finished gum base FGB is a formulation of Representative Gum Base 5 of Table 2.

TABLE 16
Ingredients of Effluents of System 3300

| | 3302 | 3304 | 3306 | 3308 |
|---|---|---|---|---|
| | GBMB | GBMB | FGB | FG |
| Ingredient/Mixers | (GBI^{x}) | (GBI^{x}) | (GBI^{xy}) | (GBI^{xy} + SGI^{z}) |
| Elastomers | | | | |
| Butyl Rubber | 9.1 | 9.1 | 8 | 2.4 |
| Polyvinyl Acetate (PVA) | 22.7 | 22.7 | 20 | 6 |
| Polyisobutylene | 11.4 | 11.4 | 10 | 3 |
| Softeners/Plasticizers/ | | | | |
| Oils/Waxes | | | | |
| Rosin esters | 11.4 | 11.4 | 10 | 3 |
| Waxes | 11.4 | 11.4 | 10 | 3 |
| Vegetable oils | 28.4 | 28.4 | 25 | 7.5 |
| (hydrogenated) | | | | |
| Emulsifiers | | | | |
| Triacetin | 5.6 | 5.6 | 5 | 1.5 |
| Lacithin | 0 | 0 | 0 | 5 |
| Fillers | | | | |
| Talc | 0 | 0 | 12 | 3.6 |
| Bulk Sweeteners | | | | |
| Hydrogenated Starch | 0 | 0 | 0 | 1.0 |
| Hydrolysates | | | | |
| Sorbitol | 0 | 0 | 0 | 59.0 |
| Fluids | | | | |
| Glycerin | 0 | 0 | 0 | 1.0 |
| Flavor | 0 | 0 | 0 | 3.8 |
| Color(s) | 0 | 0 | 0 | .2 |
| Totals: | 100 | 100 | 100 | 100 |

As it was with systems 2700, 2800, 2900, 3000, 3100, 3200, each of mixers in system 3300 can process numerous different combinations of gum ingredients to output different effluents, simultaneously or sequentially. For example, in one implementation, mixers 3302 and 3304 may output two different gum base master batches which are either simultaneously or sequentially fed to mixer 3306. That is, mixer 3306 may process each gum base master batch sequentially with different sets of additional gum base ingredients to sequentially produce two different finished gums, or mixer 3306 may process both gum base master batches simultaneously with or without a set of additional gum base ingredients to produce a finished gum.

Mixers 3302 and 3304 may produce different gum structures than a gum base master batch, such as the same finished gum or two different finished gums, or the same gum base with a set of subsequent gum ingredients or two different gum bases with a set of subsequent gum ingredients, etc. According to effluents supplied by mixers 3302, 3304 and other gum ingredients added, effluent of mixer 3306 will vary. Similarly, effluent of 3308 will vary with the effluent supplied by mixer 3306 and other ingredients added.

As it was with other systems, all of mixers of system 3300 may be located in one plant, or one or more mixers may be located in different plants.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated to the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

1-142. (canceled)

143. A mixing system for making a chewing gum structure, comprising:
a first mixer adapted to mix ingredients to form a first gum structure;
a second mixer adapted to mix ingredients to form a second gum structure,
a third mixer adapted to mix ingredients to form a third gum structure, the third mixer arranged in parallel with the second mixer; and
wherein the first and second mixers are arranged in a first series and the first and third mixers are arranged in a second series.

144. The mixing system of claim 143, wherein the second mixer and the third mixer are a same type of mixer.

145. The mixing system of claim 144, wherein the first mixer is a batch mixer.

146. The mixing system of claim 144, wherein the second mixer and the third mixer are batch mixers.

147. The mixing system of claim 146, wherein the first mixer is a continuous mixer.

148. The mixing system of claim 144, wherein the second mixer and the third mixer are configured the same.

149. The mixing system of claim 148, wherein the second mixer and the third mixer are extruders, wherein the second mixer is configured with a set of screw elements adapted for a dispersive mixing, and the third mixer is also configured with the set of screw elements adapted for a dispersive mixing.

150. The mixing system of claim 148, wherein the second mixer and the third mixer are operated the same with a same set of operating parameters.

151. The mixing system of claim 148, wherein the second mixer and the third mixer are operated differently with different sets of operating parameters.

152. The mixing system of claim 144, wherein the second mixer and the third mixer are configured differently.

153. The mixing system of claim 143, wherein the second mixer and the third mixer are configured to run sequentially.

154. The mixing system of claim 143, wherein the second mixer is a batch mixer and the third mixer is a continuous mixer.

155. The mixing system of claim 154, wherein the first mixer is a batch mixer.

156. The mixing system of claim 143, further including a fourth mixer arranged in parallel with the first mixer wherein the fourth mixer is one of a batch mixer or a continuous mixer.

157. The mixing system of claim 143, wherein the first mixer is arranged upstream of the second mixer and the third mixer such that an output of the first mixer is an input to the second mixer and the third mixer.

158. The mixing system of claim 143, wherein the first mixer is arranged downstream of the second mixer and the third mixer such that an output of the second mixer and an output of third mixer are inputs to the first mixer.

159. The mixing system of claim 156, further including a fifth mixer arranged in series with and downstream of the first mixer, the second mixer, the third mixer, and the fourth mixer, wherein the fifth mixer is configured to form a finished gum.

160. The mixing system of claim 143, wherein the first mixer is located in a first manufacturing plant and the second mixer and the third mixer are located in a second manufacturing plant, the second manufacturing plant being remote from the first manufacturing plant.

161. The mixing system of claim 143, wherein at least one of the first and second series is configured to form at least one gum structure being less than a finished gum.

162. The mixing system of claim 143, wherein at least one of the first and second series is configured to form at least one gum structure being less than a finished gum base that includes at least one subsequent gum ingredient.

163. The mixing system of claim 143, wherein the first mixer forms a gum structure that is less than a finished gum base, the less than a finished gum base from the first mixer is further processed in the second mixer and the third mixer, wherein at least one of the second mixer and the third mixer forms a finished gum base.

164. The mixing system of claim 163, wherein at least one subsequent gum ingredient is added to at least one of the mixers, wherein at least one of the second mixer and the third mixer forms a finished gum base with at least one subsequent gum ingredient.

165. A mixing system for making a chewing gum structure, comprising:
a first mixer and a second mixer arranged in parallel with each other;
the first mixer configured to produce a first gum structure and the second mixer configured to produce a second gum structure;
a third mixer arranged in series with each of the first mixer and the second mixer; and
the third mixer adapted to receive at least part of the first and second gum structures produced by the first mixer and the second mixer, the third mixer configured to produce a third gum structure.

166. The mixing system of claim 165, wherein the first and second mixers are configured such that the first and second gum structures are different and less than a gum base.

167. The mixing system of claim 166, wherein the third mixer is configured to process at least part of the first and second gum structures to form a finished gum base.

168. The mixing system of claim 165, wherein the first mixer and the second mixer are configured such that the first and second gum structures are less than a gum base and include at least one subsequent gum ingredient.

169. A method for making a gum structure, comprising:
mixing a first set of ingredients to form a first gum structure;
mixing a second set of ingredients to form a second gum structure, in parallel to mixing of the first set of ingredients; and
mixing a third set of ingredients in series with mixing of the first and second sets of ingredients to form a third gum structure; and
wherein the output of the series mixing of the first and second sets of ingredients and the third set of ingredients includes at least one gum structure being less than a finished gum.

170. The method of making a gum structure of claim 169, wherein the third set of ingredients includes the first gum structure and the second gum structure.

171. The method of making a gum structure of claim 170, wherein the third set of ingredients further includes at least one subsequent gum ingredient and the third gum structure is less than a finished gum.

172. The method of making a gum structure of claim 170, wherein the third set of ingredients further includes at least one subsequent gum ingredient and the third gum structure is a finished gum master batch.

173. The method of making a gum structure of claim 170, further including mixing in series and downstream from the series mixing of the third set of ingredients and the first and second sets of ingredients, a fourth set of ingredients to form a fourth gum structure, the fourth gum structure being a finished gum.

174. The method of making a gum structure of claim 169, wherein the third set of ingredients includes the first gum structure and the second gum structure, wherein the first and second gum structures are both finished gum bases and the third gum structure is a third gum base, different than the first and second gum bases.

175. The method of making a gum structure of claim 169, wherein the third set of ingredients is the combination of the first and second gum structures in addition to at least one more gum base ingredient, wherein the first and second gum structures are both finished gum bases and the third gum structure is a third gum base, different than the first and second gum bases.

176. The method of making a gum structure of claim 175, wherein the third set of ingredients further includes at least one subsequent gum ingredient.

177. The method of making a gum structure of claim 169, wherein mixing the third set of ingredients is upstream from mixing the first and second sets of ingredients, such that the first and second sets of ingredients each include at least a portion of the third set of ingredients.

178. The method of making a gum structure of claim 177, wherein mixing of the first and second sets of ingredients occurs simultaneously.

179. The method of making a gum structure of claim 177, wherein mixing of the first and second sets of ingredients occurs sequentially.

180. The method of making a gum structure of claim 179, wherein mixing of the second sets of ingredients begins after start of mixing of the first sets of the ingredients but prior to end of mixing of the first sets of ingredients.

181. The method of making a gum structure of claim 179, wherein mixing of the second sets of ingredients begins after the end of the mixing of the first sets of the ingredients.

182. The method of making a gum structure of claim 177, wherein mixing of the first set of ingredients occurs in a first mixer, mixing of the second set of ingredients occurs in a second mixer and mixing of the third set of ingredients occurs in a third mixer, the method further including sequentially feeding the third gum structure to the first and second mixers.

183. The method of making a gum structure of claim 177, wherein mixing of the first set of ingredients occurs in a first mixer, mixing of the second set of ingredients occurs in a second mixer and mixing of the third set of ingredients occurs in a third mixer, the method further including simultaneously feeding a portion of the third gum structure to each of the first and second mixers.

184. The method of making a gum structure of claim 182, wherein the third gum structure is less than a finished gum base and the first and second gum structures are a finished gum base.

185. The method of making a gum structure of claim 177, wherein the third gum structure is less than a finished gum base and at least one of the first and second gum structures are a finished gum base.

186. The method of making a gum structure of claim 177, further including mixing, in series and downstream from the series mixing of the third set of ingredients and the first and second sets of ingredients, a fourth set of ingredients to form a fourth gum structure, the fourth gum structure being a finished gum.

187. The method of making a gum structure of claim 169, wherein the third set of ingredients includes the first gum structure, the second gum structure and at least one subsequent gum ingredient, wherein the first and second gum structures are both less than a finished gum base and the third gum structure is less than a finished gum.
